(19) United States
(12) Patent Application Publication
(10) Pub. No.: US 2026/0128861 A1
(43) Pub. Date: May 7, 2026

(54) ADAPTIVELY SECURE RANDOMIZED MULTI-INPUT FUNCTIONAL ENCRYPTION SYSTEM AND METHOD

(71) Applicant: NTT Research, Inc., Sunnyvale, CA (US)

(72) Inventors: Pratish Datta, Sunnyvale, CA (US); Jiaxin Guan, New York, NY (US); Alexis Korb, Los Angeles, CA (US); Amit Sahai, Los Angeles, CA (US)

(73) Assignee: NTT Research, Inc., Sunnyvale, CA (US)

(21) Appl. No.: 19/383,466

(22) Filed: Nov. 7, 2025

Related U.S. Application Data
(60) Provisional application No. 63/717,827, filed on Nov. 7, 2024.

(51) Int. Cl. H04L 9/08; H04L 9/32

(52) U.S. Cl. CPC H04L 9/0819; H04L 9/3218

(57) ABSTRACT

The present disclosure provides a method for randomized multi-input functional encryption. A setup processor generates, for each input, a component for generating a proof, public-private key pairs, an obfuscated program for verifying ciphertexts and outputting a proof, and an encryption key. The setup processor generates a master secret key and transmits encryption keys to an encryption processor and the master secret key to a key generation processor. The encryption processor computes ciphertexts, generates proofs, and produces final ciphertexts. The key generation processor receives the master secret key and a randomized function, samples a PRF key, generates an obfuscated program, and transmits a function key to a decryption processor. The decryption processor receives the function key and ciphertexts, calculates a decryption result, and electronically stores the result.

### CROSS-REFERENCE TO RELATED APPLICATIONS

This application claims the benefit of U.S. Provisional Application No. 63/717,827, filed Nov. 7, 2024, the entire contents of which are incorporated herein by reference for all purposes.

### FIELD OF THE INVENTION

The present disclosure relates to functional encryption schemes, and more particularly to an adaptively secure randomized multi-input functional encryption scheme with unbounded-message security.

### BACKGROUND OF THE INVENTION

Functional encryption (FE) has emerged as a powerful cryptographic primitive that enables fine-grained access control over encrypted data. In traditional public-key encryption schemes, decryption provides an all-or-nothing approach—either the entire plaintext is revealed or nothing at all. FE, on the other hand, allows for more nuanced control, where specific functions of the encrypted data can be computed without revealing the entire plaintext.

As research in FE has progressed, there has been increasing interest in extending its capabilities to handle randomized functionalities. Randomized functional encryption (rFE) allows for the evaluation of randomized functions on encrypted data, opening up new possibilities for privacy-preserving computations and secure data analysis. This extension to randomized functionalities introduces additional complexities and security considerations that must be carefully addressed.

Multi-input functional encryption (MIFE) further expands the scope of FE by allowing computations on multiple encrypted inputs. This capability is particularly valuable in scenarios involving distributed data sources or multi-party computations. The combination of randomized functionalities with multi-input settings gives rise to randomized multi-input functional encryption (rMIFE), a powerful tool with potential applications in areas such as privacy-preserving data mining, secure multi-party computation, and distributed machine learning.

As with any cryptographic primitive, the security of rFE and rMIFE schemes is of paramount importance. Rigorous security definitions and proofs are essential to ensure that these schemes provide the intended level of protection against various types of attacks. Indistinguishability-based (IND) security definitions have been widely used in the context of functional encryption, as they provide a strong and intuitive notion of security.

However, as the complexity of functional encryption schemes increases, particularly with the introduction of randomized functionalities and multi-input settings, it becomes crucial to carefully examine and refine existing security definitions. This ongoing process of refinement is necessary to ensure that security definitions accurately capture all relevant threat models and provide comprehensive protection against potential attacks.

One area of particular concern in the context of rFE and rMIFE is the threat posed by malicious encryptors. Unlike traditional functional encryption schemes where the focus is primarily on protecting against malicious decryptors, rFE/rMIFE must also consider scenarios where the party generating the ciphertexts may attempt to subvert the system. This additional security requirement introduces new challenges in formulating robust and comprehensive security definitions.

As research in this field continues to advance, there is a growing need for security definitions that not only address the capabilities of malicious decryptors but also provide strong guarantees against potential attacks by malicious encryptors. Such comprehensive security definitions are essential for building trust in rFE and rMIFE systems and enabling their widespread adoption in real-world applications.

### BRIEF SUMMARY OF THE INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for randomized multi-input functional encryption is provided. The method includes, at a setup processor: generating, for each input i in [n] where n is a number of inputs to the multi-input functionalities: a component Kᵢ for use in generating a proof, wherein Kᵢ could be a pseudorandom function (PRF) key; public-private key pairs

$$( {pk}_{i}^{0} , {sk}_{i}^{0} ) and ( {pk}_{i}^{1} , {sk}_{i}^{1} ) ;$$

an obfuscated program \tilde{E}ᵢ using

$${pk}_{i}^{0} , {pk}_{i}^{1}$$

and Kᵢ, which program is configured for taking as input two different ciphertexts, verifying that the two ciphertexts are encryptions of an identical message, and outputting a proof πᵢ that the two ciphertexts are encryptions of an identical message; and an encryption key

$$E {K}_{i} = ( {pk}_{i}^{0} , {pk}_{i}^{1} , {\tilde{E}}_{i} ) .$$

The method further includes generating a master secret key

$$MSK = {\{ s {k}_{i}^{0} , {sk}_{i}^{1} , {K}_{i} \}}_{i ∈ [ n ]} ;$$

transmitting at least one of the encryption keys {EKᵢ}_{i∈[n]} to at least one encryption processor, and transmitting the master secret key MSK to a key generation processor. At the at least one encryption processor for each input xᵢ, the method includes: computing a ciphertext

$${c}_{i}^{0}$$

of xᵢ using

$${pk}_{i}^{0}$$

and a ciphertext

$${c}_{i}^{1}$$

of xᵢ using

$${pk}_{i}^{1} ;$$

using \tilde{E}ᵢ to compute a proof πᵢ that

$${c}_{i}^{0} and {c}_{i}^{1}$$

encrypt the same message; and generating a ciphertext

$${CT}_{i} = ( {c}_{i}^{0} , {c}_{i}^{1} , {π}_{i} ) .$$

At a key generation processor; the method includes: receiving the master secret key MSK from the setup processor, and a randomized function ƒ from a decryption processor; sampling a PRF key K_{ƒ} used for generating randomness for evaluating the randomized functionalities ƒ on inputs x₁, . . . , xₙ; generating an obfuscated program \tilde{G}_{ƒ} using MSK and K_{ƒ}, which is configured for taking as input ciphertexts

$$\{ {CT}_{i} \} = {\{ ( {c}_{i}^{0} , {c}_{i}^{1} , {π}_{i} ) \}}_{i ∈ [ n ]} ,$$

verifying the proof πᵢ for each ciphertext CTᵢ, and outputting ƒ(xᵢ, . . . , xₙ) computed using randomness generated from K_{ƒ}; and transmitting a function key \tilde{G}_{ƒ} as SK_{ƒ} to the decryption processor. At the decryption processor, the method includes: receiving the function key SK_{ƒ} from the key generation processor; receiving ciphertexts {CTᵢ}_{i∈[n]} from the encryption processor; calculating a decryption result as SK_{ƒ}({CTᵢ}_{i∈[n]}) which is

$${\tilde{G}}_{f} ( {\{ {c}_{i}^{0} , {c}_{i}^{1} , {π}_{i} \}}_{i ∈ [ n ]} ) ;$$

and electronically storing the decryption result.

According to other aspects of the present disclosure, the method may include one or more of the following features. The method may include

$${pk}_{i}^{0} = {sk}_{i}^{0} and {pk}_{i}^{1} = {sk}_{i}^{1}$$

for all i∈[n]. The setup processor, encryption processor, key generation processor, and decryption processor may be in electronic communication with each other through a secure network. The method may further include: at the setup processor, generating and transmitting multiple sets of encryption keys {EKᵢ}_{i∈[n]} to multiple encryption entities; at each encryption processor, generating ciphertexts for different inputs using the received encryption keys. The method may further include: at the key generation processor, generating multiple function keys SK_{ƒ} for different functions ƒ; transmitting the generated function keys to one or more decryption entities. The obfuscated program may be obtained by an indistinguishability obfuscation scheme i [symbol] which satisfies the property that for any two equivalent circuits C₀ and C₁, the distributions i [symbol] (λ,C₀) and i [symbol] (λ,C₁) are computationally indistinguishable, where λ is a security parameter. The proof πᵢ may be computed as

$$PRF ( {K}_{i} , ( {c}_{i}^{0} , {c}_{i}^{1} ) ) ,$$

and the randomness for computing the function ƒ may be computed as

$$PRF ( {K}_{f} , {( {c}_{i}^{0} , {c}_{i}^{1} )}_{i ∈ [ n ]} ) .$$

According to another aspect of the present disclosure, a system for randomized multi-input functional encryption is provided. The system includes a setup processor, at least one encryption processor, a key generation processor, and a decryption processor. The setup processor is configured to: generate, for each input i in [n] where n is a number of inputs: a component Kᵢ for use in generating a proof, wherein Kᵢ could be a pseudorandom function (PRF) key; public-private key pairs

$$( {pk}_{i}^{0} , {sk}_{i}^{0} ) and ( {pk}_{i}^{1} , {sk}_{i}^{1} ) ;$$

an obfuscated program \tilde{E}ᵢ using

$${pk}_{i}^{0} , {pk}_{i}^{1}$$

and Kᵢ, which program is configured for taking as input two different ciphertexts, verifying that the two ciphertexts are encryptions of an identical message, and outputting a proof πᵢ that the two ciphertexts are encryptions of an identical message; and an encryption key

$${EK}_{i} = ( {pk}_{i}^{0} , {pk}_{i}^{1} , {\tilde{E}}_{i} ) .$$

The setup processor is further configured to generate a master secret key

$$MSK = {\{ {sk}_{i}^{0} , {sk}_{i}^{1} , {K}_{i} \}}_{i ∈ [ n ]} ;$$

transmit at least one of the encryption keys {EKᵢ}_{i∈[n]} to at least one encryption processor; and transmit the master secret key MSK to a key generation processor. The at least one encryption processor is configured to, for each input xᵢ: compute a ciphertext

$${c}_{i}^{0}$$

xᵢ using

$${pk}_{i}^{0}$$

and a ciphertext

$${c}_{i}^{1}$$

of xᵢ using

$${pk}_{i}^{1} ;$$

use \tilde{E}ᵢ to compute a proof πᵢ that

$${c}_{i}^{0} and {c}_{i}^{1}$$

encrypt the same message; and generate a ciphertext

$${CT}_{i} = ( {c}_{i}^{0} , {c}_{i}^{1} , {π}_{i} ) .$$

The key generation processor is configured to: receive the master secret key MSK from the setup processor, and a randomized function ƒ from a decryption processor; sample a PRF key K_{ƒ} used for generating randomness for evaluating the functionality ƒ on inputs x₁, . . . , xₙ; generate an obfuscated program \tilde{G}_{ƒ} using MSK and K_{ƒ}, which is configured for taking as input ciphertexts

$$\{ {CT}_{i} \} = {\{ ( {c}_{i}^{0} , {c}_{i}^{1} , {π}_{i} ) \}}_{i ∈ [ n ]} ,$$

verifying the proof πᵢ for each ciphertext CTᵢ, and outputting ƒ(xᵢ, . . . , xₙ) computed using randomness generated from K_{ƒ}; and transmit a function key \tilde{G}_{ƒ} as SK_{ƒ} to the decryption processor. The decryption processor is configured to: receive the function key SK_{ƒ} from the key generation processor; receive ciphertexts {CTᵢ}_{i∈[n]} from the encryption processor; calculate a decryption result as SK_{ƒ}({CTᵢ}_{i∈[n]}) which is

$${\tilde{G}}_{f} ( {\{ {c}_{i}^{0} , {c}_{i}^{1} , {π}_{i} \}}_{i ∈ [ n ]} ) ;$$

and electronically store the decryption result.

According to other aspects of the present disclosure, the system may include one or more of the following features. The system may include

$${pk}_{i}^{0} = {sk}_{i}^{0} and {pk}_{i}^{1} = {sk}_{i}^{1}$$

for all i∈[n]. The setup processor, encryption processor, key generation processor, and decryption processor may be in electronic communication with each other through a secure network. The setup processor may be further configured to generate and transmit multiple sets of encryption keys {EKᵢ}_{i∈[n]} to multiple encryption entities; and each encryption processor may be configured to generate ciphertexts for different inputs using the received encryption keys. The key generation processor may be further configured to generate multiple function keys SK_{ƒ} for different functions ƒ; and the key generation processor may be further configured to transmit the generated function keys to one or more decryption entities. The obfuscated program may be obtained by an indistinguishability obfuscation scheme i [symbol] which satisfies the property that for any two equivalent circuits C₀ and C₁, the distributions i [symbol] (λ,C₀) and i [symbol] (λ,C₁) are computationally indistinguishable, where λ is a security parameter. The proof πᵢ may be computed as

$$PRF ( {K}_{i} , ( {c}_{i}^{0} , {c}_{i}^{1} ) ) ,$$

and the randomness for computing the function ƒ may be computed as

$$PRF ( {K}_{f} , {( {c}_{i}^{0} , {c}_{i}^{1} )}_{i ∈ [ n ]} ) .$$

According to another aspect of the present disclosure, a non-transitory computer-readable medium storing instructions that, when executed by one or more processors, cause the one or more processors to perform a method for randomized multi-input functional encryption is provided. The method includes the steps performed by the setup processor, the at least one encryption processor, the key generation processor, and the decryption processor as described in the method aspect above.

According to other aspects of the present disclosure, the non-transitory computer-readable medium may include instructions for performing one or more of the following features. The method may include

$${pk}_{i}^{0} = {sk}_{i}^{0} and {pk}_{i}^{1} = {sk}_{i}^{1}$$

for all i∈[n]. The setup processor, encryption processor, key generation processor, and decryption processor may be in electronic communication with each other through a secure network. The method may further include: at the setup processor, generating and transmitting multiple sets of encryption keys {EKᵢ}_{i∈[n]} to multiple encryption entities; at each encryption processor, generating ciphertexts for different inputs using the received encryption keys. The method may further include: at the key generation processor, generating multiple function keys SK_{ƒ} for different functions ƒ; transmitting the generated function keys to one or more decryption entities. The obfuscated program may be obtained by an indistinguishability obfuscation scheme i [symbol] which satisfies the property that for any two equivalent circuits C₀ and C₁, the distributions i [symbol] (λ,C₀) and i [symbol] (λ,C₁) are computationally indistinguishable, where λ is a security parameter. The proof πᵢ may be computed as

$$PRF ( {K}_{i} , ( {c}_{i}^{0} , {c}_{i}^{1} ) ) ,$$

and the randomness for computing the function ƒ may be computed as

$$P R F ( {K}_{f} , {( {c}_{i}^{0} , {c}_{i}^{1} )}_{i ∈ [ n ]} ) .$$

The present disclosure identifies a critical gap in the existing indistinguishability-based (IND) security definition for rFE/rMIFE. Notably, the current definition fails to adequately address security against malicious encryptors a crucial requirement for rFE/rMIFE since their introduction. The present disclosure proposes a novel, robust IND security definition that not only addresses threats from malicious decryptors but also quantifies the security against malicious encryptors effectively.

The foregoing general description of the illustrative embodiments and the following detailed description thereof are merely exemplary aspects of the teachings of this disclosure and are not restrictive.

### BRIEF DESCRIPTION OF THE DRAWINGS

Non-limiting and non-exhaustive examples are described with reference to the following figures.

FIG. 1 illustrates a flowchart for a randomized multi-input functional encryption process, according to aspects of the present disclosure.

FIG. 2 illustrates a block diagram of a randomized multi-input functional encryption system, according to aspects of the present disclosure.

FIG. 3 illustrates a block diagram of a randomized multi-input functional encryption system with interconnected components, according to aspects of the present disclosure.

FIG. 4 illustrates a block diagram of a client computing architecture, according to aspects of the present disclosure.

FIG. 5 illustrates a block diagram of a server-client network architecture, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

A detailed description of systems, devices, and methods consistent with embodiments of the present disclosure is provided below. While several embodiments are described, it should be understood that disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

Functional Encryption. Functional Encryption (FE) as introduced in the literature enhances the traditional public-key encryption paradigm by enabling fine-grained access control over encrypted data. In an FE scheme, a central authority holds a master secret key and issues a corresponding master public key. This authority uses the master secret key to generate secret keys for various legitimate functions, while any party can encrypt data using the master public key. When provided with a secret key for a function ƒ and a ciphertext of a message x, decryption reveals ƒ(x) without disclosing any additional information about x.

Since its introduction, a key focus of FE research has been to explore the functionalities that can be supported and the underlying cryptographic assumptions. A significant body of exciting work has investigated these questions in the context of deterministic functionalities. This culminated in the work of Jain, Lin, and Sahai, who constructed FE schemes for general polynomial-size deterministic circuits based on well-established cryptographic assumptions. However, many real-world applications naturally involve randomized functionalities, posing challenges since existing FE schemes for deterministic functionalities cannot be directly extended to accommodate them.

FE for randomized functionalities. To address these challenges, Alwen et al. and Goyal et al. initiated the study of FE for randomized functionalities (rFE). In an rFE scheme, secret keys correspond to randomized functions ƒ, allowing decryption of a ciphertext containing message x to reveal only a single sample from the output distribution of ƒ(x). Additionally, for a collection of secret keys for functions ƒ₁, . . . , ƒ_{q} and ciphertexts for messages x₁, . . . , xₙ, each secret key-ciphertext pair should yield independent samples from the distribution of ƒᵢ(xⱼ) without revealing further information.

rFE shows considerable promise in both practical and theoretical applications, including privacy-aware auditing, differentially-private data release, delegation of encrypted contents, fully homomorphic encryption, controlled homomorphic encryption, and even FE for deterministic functionalities. Acknowledging the vast potential of rFE, numerous studies have explored rFE from both definitional and construction perspectives.

Security against both Malicious Decryptors and Encryptors for rFE. Unlike deterministic FE, the notion of rFE must not only ensure that decryptors cannot gain any additional information about the encrypted data beyond the intended output, but also it is essential for rFE to prevent malicious encryptors from generating “bad” ciphertexts for a message x, which, when decrypted using secret keys from certain functions ƒ, result in distributions that significantly diverge from those of ƒ(x).

To illustrate this, consider the scenario of privacy-aware auditing as described in prior work. A government agency is tasked with overseeing financial institutions to ensure compliance with federal regulations. However, these institutions are hesitant to grant full access to their confidential data to external auditors. Partial access poses its own risks, as institutions could selectively disclose information, potentially compromising the integrity of the audit process.

rFE offers an effective solution. Financial institutions can encrypt their databases using rFE, while the government agency provides auditors with an rFE secret key, allowing them to randomly sample a small, unbiased subset of records from each database. It is crucial that when an auditor receives two distinct keys for the same encrypted database, each key generates independent samples. Similarly, if the same key is applied to two different databases, the auditor should still obtain independent samples from each. Additionally, if malicious institutions can craft faulty ciphertexts that lead to biased or correlated samples, they could undermine the entire audit process and jeopardize its integrity.

For a more in-depth discussion on the importance of addressing both malicious decryptors and encryptors in rFE, please refer to the existing literature.

Simulation-based (SIM) Security Definition for rFE. The above two intuitive security requirements for rFE have been formalized through a unified simulation-based approach, first introduced and later refined in subsequent work. (Notably, not all prior works on rFE have considered security against malicious encryptors, as this is not necessary for certain applications of rFE.) Similar to functional encryption (FE) for deterministic functionalities as studied in the literature, the SIM security experiment for rFE defines an adversary that attempts to distinguish between interactions in the real world (where ciphertexts and secret keys are generated according to the rFE scheme) and an ideal world (where these elements are produced by a simulator with only minimal information). To address security against malicious encryptors, previous work introduced a decryption oracle into the security game, akin to the framework for IND-CCA2 security. This oracle takes a ciphertext et and a function ƒ as input. In the real world, the challenger extracts the secret key for ƒ and decrypts ct using it. In contrast, in the ideal world, the challenger uses a simulator that outputs either a value x or a special symbol ⊥. The challenger then responds with a random value drawn from the distribution of ƒ(x) or with ⊥, based on the simulator's output.

Further enhancements to the decryption oracle have been made by allowing it to handle a set of polynomially many ciphertexts at the time along with a function ƒ. In the real world, the challenger generates a single secret key for ƒ and decrypts each ciphertext using this key. In the ideal world, the simulator is given the set of ciphertexts and can query an evaluation oracle once per ciphertext. For each query x, the oracle provides a fresh evaluation of ƒ(x). This refinement addresses the limitation of earlier definitions, which, while preventing the adversary from creating individual ciphertexts that decrypt incorrectly, allowed malicious encryptors to produce sets of ciphertexts that yield correlated outputs when decrypted with the same key.

Indistinguishability-based (IND) security for rFE. While simulation-based (SIM) security represents the strongest form of security for rFE as established in the literature, it has a significant limitation: it can only handle a bounded number of ciphertext and secret key queries before the ciphertext queries. To address this, previous work introduced an indistinguishability-based (IND) security formulation for rFE, generalizing the counterpart framework for deterministic FE. The goal, as with SIM security, is to protect against both malicious decryptors and encryptors.

More specifically, the IND security experiment for rFE involves an adversary attempting to distinguish between the encryptions of two messages, given access to secret keys for randomized functions whose output distributions, when evaluated on those messages, are statistically close. (Computationally close output distributions can also be supported, but only if all function queries occur before the master public key is issued. Otherwise, the IND security definition becomes vacuous (for more details, see Remark 2.8 in the existing literature).)

To account for malicious encryptors, the IND security framework as previously proposed again provides the adversary with a decryption oracle. This oracle accepts a ciphertext ct and a function ƒ as input, generates a secret key for ƒ, and decrypts ct using this key much like in the real-world setting of the SIM security definition.

One of the key distinctions of IND security is that it imposes no inherent bounds on the number of ciphertext or secret key queries—whether they occur before or after the ciphertext queries. Furthermore, while SIM security for a bounded number of ciphertext queries implies IND security for arbitrarily many queries, this does not extend to the number of supported key queries. In fact, the transformation from IND security to SIM security as shown in prior work preserves the bound on the number of secret key queries.

Thus, for applications of rFE that require support for arbitrarily many ciphertext and secret key queries, (possibly) both before and after ciphertext queries, the best security one can achieve is IND security. Additionally, as has been observed in case of FE for deterministic functionalities, IND security can often be realized under weaker cryptographic assumptions compared to those needed for SIM security.

Limitations of existing IND security definition for rFE. The purpose of providing a decryption oracle to the adversary is to capture security against malicious encryptors. In the case of the SIM security definition, as established in previous work, the use of a decryption oracle effectively achieves this goal. This is because, in the ideal world, the decryption oracle is honestly simulated by producing uniform samples from the output distribution of the queried function applied to the message encrypted within the queried ciphertext. Thus, the indistinguishability of the decryption oracle's output in the real world from that in the ideal world ensures that the adversary cannot manipulate decryption results in the real-world to be non-uniform or correlated.

However, this ideal functionality does not exist in the context of IND security. As a result, there is no guarantee that an adversary cannot submit maliciously crafted ciphertexts to the decryption oracle and influence its output. Therefore, simply providing a decryption oracle in the IND security experiment—otherwise designed to target malicious decryptors—fails to effectively capture security against malicious encryptors.

This leads us to ask the following critical questions:

Open Problem 1. Can we formulate an IND-based security definition for rFE that properly captures security against both malicious decryptors and encryptors? Moreover, is it possible to construct an rFE scheme that achieves this enhanced IND security notion?

Multi-Input Functional Encryption. Multi-Input Functional Encryption (MIFE), introduced by Goldwasser et al., extends the concept of FE to accommodate multi-input functionalities. In this framework, a secret key corresponding to an n-input function (where n>1 and can be polynomial in the security parameter) allows a user with n ciphertexts—each encrypting a message x₁, . . . , xₙ—to compute the output ƒ(xᵢ, . . . , xₙ) by jointly decrypting the ciphertexts using the secret key, without revealing any additional information about the individual messages xᵢ.

MIFE is highly relevant due to its wide range of applications that involve extracting aggregate information from multiple data sources. These applications include executing SQL queries on encrypted databases, performing computations over encrypted data streams, non-interactive differentially-private data release, order-revealing encryption, and multi-client delegation of computation.

Given the strong potential of MIFE, there has been significant effort within the cryptographic community to construct MIFE schemes and their variants, both for general multi-input functionalities and for specific, practically important classes of functionalities. However, all existing constructions have been limited to handling deterministic functionalities only.

MIFE for randomized functionalities. Similar to single-input FE, many of the application scenarios for MIFE mentioned above often require the ability to handle randomized functionalities. Examples include privacy-preserving joint audits across multiple organizations, salary surveys of citizens within a country, randomized SQL queries, and so on. For addressing these applications, it is possible to extend the syntax and security definitions of deterministic MIFE to randomized MIFE (rMIFE), in the same way as in the single-input case. In fact, Goldwasser et al. introduced a SIM-based security definition for rMIFE by generalizing the SIM security definition for single-input rFE. This definition can be naturally enhanced to encompass decryption of correlated ciphertexts along the line of prior work. On the other hand, while the original work did not specifically address an IND-based security definition for rMIFE, one can similarly extend the IND security definition from previous literature to the context of rMIFE. However, as in the single-input case, such an IND security definition would fail to adequately capture security against malicious encryptors. Therefore, a robust IND security definition that effectively addresses security against malicious encryptors is necessary for rMIFE as well.

Importance of IND security for rMIFE. IND security is even more significant in the context of MIFE/rMIFE. This is because Goldwasser et al. demonstrated that achieving SIM security for MIFE is impossible for general deterministic functionalities, even in the secret key setting, with constant arity and at most two ciphertext queries per encryption slot. They showed that such an MIFE scheme would imply virtual black-box (VBB) obfuscation, which is known to be impossible for general functionalities. Since every deterministic functionality can be viewed as a randomized functionality with a singleton output distribution, the impossibility result of Goldwasser et al. extends directly to SIM security for rMIFE. Consequently, it is clear that the only achievable security in any meaningful general scenario for rMIFE is IND security.

Existing rMIFE scheme and its limitations. The only known rMIFE construction is the one briefly outlined by Goldwasser et al. as an extension of their deterministic MIFE scheme, based on differing-inputs obfuscation (di [symbol] ). However, di [symbol] is widely regarded as implausible in general, rendering their proposed MIFE and rMIFE constructions generally infeasible. Moreover, Goldwasser et al. did not provide any formal security proof or even a proof sketch for their proposed rMIFE construction.

In the same work, Goldwasser et al. also suggested that their deterministic MIFE construction based on indistinguishability obfuscation (i [symbol] ) could be generalized to an rMIFE scheme as well in a manner similar to their di [symbol] -based construction, though no concrete construction or proof sketch was provided. The original i [symbol] -based deterministic MIFE construction was proven to achieve IND security, and thus, the rMIFE construction extended from it is expected to achieve IND security according to the multi-input extension of the definition in the existing literature. However, since this definition does not fully capture security against malicious encryptors, it is unclear whether that generalized rMIFE construction would provide such guarantees.

Additionally, the rMIFE construction inherits other significant limitations from the original deterministic MIFE scheme. These include security guarantees only against a bounded number of ciphertext queries per encryption slot and selective adversaries, who must declare all challenge ciphertext queries and the encryption keys they wish to corrupt at the beginning of the security experiment. These challenges lead to the following natural question.

Open Problem 2. Can we construct a viable rMIFE scheme that achieves the following security properties:
ND security under an enhanced definition that effectively captures security against both malicious decryptors and encryptors.
Protection against fully adaptive adversaries, who are allowed to make ciphertext, secret key, and corruption queries in any arbitrary order, at any point during the security experiment.
Support for an unbounded polynomial number of secret key and ciphertext queries per encryption slot.

### 0.1 Our Results

We address the above open problems in affirmative. More precisely, our contribution is threefold.
1. New Robust IND Security Definition for rFE/rMIFE:
   We introduce an enhanced IND security definition for rFE, capturing security against both malicious decryptors and encryptors effectively. Instead of using a unified security experiment as in previous work, we separate the two security requirements into distinct experiments. The first experiment, capturing security against malicious decryptors, resembles the existing IND security game for deterministic FE/MIFE. Here, the adversary must distinguish between encryptions of two messages, given secret keys for randomized functions, where the output distributions of the functions applied to the messages are close to each other.
   The second IND-based security experiment addresses malicious encryptors. In this experiment, the adversary is given access to a KeyStore oracle, which stores the functions, the adversary wishes to request decryption under, together with their corresponding secret keys one for each function. The adversary also interacts with a decryption oracle that operates in two modes. In the first mode, the oracle decrypts the submitted ciphertext using the secret keys stored in KeyStore. In the second mode, the oracle extracts the plaintext by querying a message extraction oracle and returns random samples from the output distributions of the functions in KeyStore, applied to that message.
   The adversary's goal is to distinguish between these two modes. Indistinguishability ensures that the decryption result of the rFE scheme is close to an independent random sample from the randomized function's output distribution, guaranteeing strong security. For more details, refer to 1.1.
   This IND security definition naturally extends to the multi-input setting. In fact, we formally define our IND security notion for rMIFE, with the single-input rFE definitions as a special case.
   By the way, we also observe a relatively minor gap in the existing SIM security definitions for rFE/rMIFE. Roughly speaking, existing SIM security definitions guarantee security only in situation where even if the adversary repeatedly requests the decryption of the same or correlated ciphertexts under the same function, it receives independent random samples from the function's output distribution, applied to the underlying plaintexts each time.
   However, in practical scenarios, a single secret key for a function is often used repeatedly to decrypt ciphertexts over time. For example, in the privacy-aware auditing application described earlier, an auditor may use the same secret key to decrypt encrypted databases from multiple financial institutions during a single audit. In this case, one institution could observe the audit results of others and exploit that information by manipulating its own database encryption to influence the audit outcome.
   Existing SIM security definitions do not account for this type of attack, where malicious encryptors could exploit repeated use of the same decryption key. We address this issue by proposing a more advanced SIM security framework that ensures resistance against such attacks. For more details, see section 1.1.2.
2. Counterexample Demonstrating the Gap Between New and Existing IND Security Definitions: We present a counterexample to highlight the significance of the gap between our IND security definition and the existing definition. Specifically, we construct an insecure rFE scheme that satisfies IND security criteria of the previous definition but fails to do so in our new definition. The counterexample relies solely on standard cryptographic primitives, including functional encryption (FE) for deterministic functionalities, pseudorandom function (PRF),standard public key encryption (PKE), and simulation-sound non-interactive zero-knowledge (NIZK) proof systems as introduced in prior work. Our construction is non-trivial, and its security analysis requires careful consideration. We elaborate more on this in the 1.2 section below.
3. Adaptively IND secure rMIFE scheme with unbounded message security: Our final contribution is an adaptively IND secure rMIFE scheme for general randomized functionalities, based on sub-exponentially secure i [symbol] . As demonstrated by Goldwasser et al., i [symbol] is already implied by MIFE for general deterministic functionalities, even in the secret key setting, only supporting selective IND security with a single secret key query and at most two ciphertext queries per encryption slot.
   We analyze the IND security of our construction within the new robust security model introduced in this work. Moreover, our scheme is the first plausible construction that supports an unbounded polynomial number of secret key and challenge ciphertext queries per encryption slot. The construction relies on three key components: (a) sub-exponentially secure i [symbol] , (b) sub-exponentially secure injective one-way functions, and (c) standard public-key encryption (PKE). Here, “sub-exponential security” means that the advantage of any efficient adversary is sub-exponentially small. For the injective one-way functions, this security should additionally hold against adversaries operating in sub-exponential time.
   A few clarifications are necessary regarding these primitives. First, the required level of security varies based on the function's arity, but it does not depend on the number of challenge messages. As Goldwasser et al. noted, the selective security of their deterministic MIFE scheme based on i [symbol] (though not bounded-message security, which pertains to their use of statistically sound non-interactive proofs) can be overcome via standard complexity leveraging. This should similarly apply to their rMIFE construction generalized from it. However, in their case, the required security level depends on the number of challenge messages, which leads to significantly larger parameters than our scheme, especially since the number of challenge messages is typically much larger than the function's arity in practical applications.
   Secondly, although our security proof utilizes a sub-exponentially secure injective one-way function (primitive (b)), this function is not needed in the scheme itself. Therefore, the existence of such an injective one-way function is sufficient for the security of our rMIFE scheme, even without the knowledge of an explicit candidate. At a technical level, we build on the methods developed by Goyal et al., achieving similar results for deterministic MIFE. We give an overview of our construction in 1.3
   One caveat in our adaptive rMIFE construction is that we require the statistical distance between the output distributions of the queried functions on the queried sets of inputs to be sub-exponentially small. Overcoming this barrier remains an interesting open problem.

### 1 Technical Overview

This section provides a high-level overview of our three key technical contributions as outlined in Section.

### 1.1 New Security Definitions for rFE/rMIFE

We introduce a novel IND security definition of rFE/rMIFE. We also present a robust SIM security formulation for rFE/rMIFE. In this technical overview, we focus on single-input functionality for the ease of exposition. However, the formal definition in Section 3 extends to multi-input functionalities. Unlike prior works, our definitions are designed for adaptive adversaries, who are not required to submit their challenge ciphertext queries upfront.

### 1.1.1 New IND Security Definition for rFE.

As highlighted earlier, we address the IND security of rFE through two distinct indistinguishability-based security experiments, which are formalized below.

IND Security Against Malicious Decryptors. This security experiment extends the IND security framework for deterministic FE as established in the literature to randomized functionalities, closely following the definition in prior work (Definition 2.6), with one key distinction: we omit providing the adversary with a decryption oracle, as this experiment is not concerned with malicious encryptors.
Setup: The challenger runs the Setup algorithm to generate the master public/secret key pair (mpk,msk) and provides mpk to the adversary.
Query Phase 1: The adversary can adaptively request any polynomial number of secret keys for randomized functions within the function space. For each query function ƒ, the challenger runs KeyGen with the master secret key to generate a secret key sk_{ƒ} and hands it to the adversary.
Challenge: The adversary submits two challenge messages x₀ and x₁. The challenger selects a random bit b←{0,1} and encrypts x_{b} under mpk to generate the ciphertext ct, which is then sent to the adversary.
Query Phase 2: The adversary can continue to adaptively request additional secret keys as in Query Phase 1, and the challenger responds accordingly.
Guess: The adversary outputs its guess b′∈{0,1} and wins if b′=b.

The adversary must satisfy an admissibility condition: for any queried function ƒ and any pair of challenge messages x₀, x₁, the output distributions ƒ(x₀) and ƒ(xᵢ) must be indistinguishable. This definition can readily be generalized to handle multiple challenge ciphertexts. In fact, it can be shown that security against single and multiple ciphertexts are essentially equivalent as demonstrated in prior work.

IND Security Against Malicious Encryptors. This security experiment models the behavior of malicious encryptors attempting to influence functional outputs by generating faulty ciphertexts. The experiment proceeds as follows:
Setup: The challenger runs the Setup algorithm to generate the master public/secret key pair (mpk,msk) and provides mpk to the adversary. A random bit b←{0,1} is also sampled.
Query Phase 1: The adversary can adaptively make the following queries:
   Secret Key Query: The adversary requests secret keys for any number of randomized functions from the underlying function family. For each function ƒ, the challenger generates the secret key sk_{ƒ} by running the KeyGen algorithm and provides it to the adversary.
   Secret Key Store Query: The adversary requests the challenger to store secret keys for certain randomized functions. For each function g, the challenger generates sk_{g} using KeyGen algorithm and stores (g,sk_{g}) in a register KeyReg.
   Decryption Query: The adversary submits ciphertexts for decryption. If b=0, the challenger decrypts the ciphertext using all stored keys in KeyReg. If b=1, the challenger extracts the plaintext using msk, applies all stored functions g to it, and returns independently sampled random outputs from the resulting distributions to the adversary. Each additionally stores these outputs along with the queried ciphertext in an output register OutReg, and if the adversary requests decryption for the same ciphertext once again, it simply outputs the store values.
Guess: The adversary outputs a guess b′∈{0,1} and wins if b′=b.

The admissibility condition on the adversary requires that it can submit any ciphertext for decryption at most once.

Old vs. New IND Definition. The IND security definition in previous work closely resembles our first definition, which addresses malicious decryptors, but with a key difference: their model includes a decryption oracle, similar to IND-CCA2 security. This oracle decrypts ciphertexts using honestly generated secret keys for the functions under which decryption is sought. While the earlier definition claims this approach ensures security against malicious encryptors, it actually falls short. Observe that, unlike the SIM security model, the IND setting lacks an ideal functionality. The decryption oracle merely runs the decryption algorithm of the underlying rFE scheme, allowing adversaries to submit malicious ciphertexts and obtain biased or correlated outputs.

Our new IND security definition, specifically designed for malicious encryptors, addresses this issue by introducing two decryption modes for the decryption oracle: one for the real decryption algorithm and the other for an ideal decryption functionality, similar to the SIM security model. Indistinguishability between these modes ensures that adversaries cannot craft ciphertexts to influence the decryption oracle's outputs in ways that deviate from the intended functionality. Additionally, note that this is true even when the same secret keys are used by the decryption oracle repeatedly for decrypting the queried ciphertext over time.

### 1.1.2 New SIM Security Definition for rFE.

In the existing SIM security definitions, the decryption oracle generates a fresh secret key for a randomized function whenever decryption is requested under that function in the real world. In the ideal world, the oracle draws fresh uniform samples from the function's output distribution each time it is queried with that function. This means that existing SIM security definitions guarantee security only in situation where even if the adversary repeatedly requests the decryption of the same or correlated ciphertexts under the same function, it receives independent random samples from the function's output distribution, applied to the underlying plaintexts each time.

To address this shortcoming, we also propose an advanced SIM security definition for rFE/rMIFE that not only addresses malicious encryptors' behavior, as covered by previous definitions, but also protects against the attack scenario involving repeated usage of secret keys. Roughly, this is achieved by modifying the decryption oracle in the SIM security model as follows. We introduce a new KeyStore oracle that stores all functions the adversary wishes to query to the decryption oracle. In the real world, the KeyStore oracle generates and stores a single secret key for each submitted function. When the adversary requests decryption, the decryption oracle uses the secret keys currently stored in KeyStore to decrypt the ciphertext and return the result.

In the ideal world, the decryption oracle maintains an output register for decryption results. When the adversary queries the decryption oracle with a ciphertext, it extracts the underlying plaintext and draws random samples from the output distribution of the functions currently stored in KeyStore, applied to that plaintext. The oracle then returns these samples to the adversary and stores them, along with the ciphertext, in the output register. If the adversary later queries the same ciphertext, the oracle returns the stored samples instead of drawing fresh ones. This effectively prevents the adversary from influencing future decryption outcomes by adaptively crafting ciphertexts based on previously observed decryption results, even when the same secret keys are repeatedly used.

### 1.2 Counterexample

To highlight the shortcomings of the IND security definition in previous work, we present a counterexample. Specifically, we construct an rFE scheme that satisfies the IND security requirements of the earlier definition but is, in fact, insecure. We demonstrate that this scheme fails to meet the criteria of our proposed IND security definition. An overview of the rFE scheme is provided below.

The rFE Scheme. Our counterexample rFE scheme leverages the following cryptographic tools: (a) an FE scheme for general deterministic functionalities, (b) a pseudorandom function (PRF), (c) a public key encryption (PKE) scheme, (d) a symmetric key encryption (SKE) scheme, and (e) a simulation-sound non-interactive zero-knowledge (NIZK) proof system. The scheme operates as follows:
Setup: The Setup algorithm runs the Setup for the FE, PKE, and NIZK systems, generating keys: (FE.mpk, FE.msk) for FE, (PKE.pk, PKE.sk) for PKE, SKE.sk for SKE and a common reference string crs for NIZK. The master public key is mpk (FE.mpk, PKE.pk, crs), and the master secret key is msk FE.msk. The algorithm outputs mpk and retains msk.
Enc: Given the message x, the encryption algorithm proceeds as follows:
   It samples a PRF key K and generates an FE ciphertext FE.ct encrypting (x,K,0,⊥) under FE.mpk where ⊥ is special string of appropriate length.
   It then creates a PKE ciphertext PKE.ct encrypting (x,K,0,⊥) along with FE.ct under PKE.pk.
   Next, it computes an NIZK proof π attesting that both ciphertexts encrypt the same values (x,K,α, [symbol] ), and additionally PKE.ct also encrypts the FE ciphertext. Here, α∈{0,1}, [symbol] is a string of size equal to the key length of the SKE.
   Finally, the encryption outputs the ciphertext CT (FE.ct,PKE.ct,π).
KeyGen: The algorithm takes the master secret key msk and a randomized function ƒ and proceeds as follows.
   1. It samples a seed s and a SKE ciphertext SKE.ct encrypting a random message with the same length as the output of ƒ to construct a function G[ƒ,s,SKE.ct].
   2. The function G takes as input (x,K,α, [symbol] ) and operates in two modes depending on a:
      If α=0, it computes randomness PRF.Eval(K,s) and uses it to compute ƒ on x;
      If α=1, it decrypts the SKE ciphertext using [symbol] and output the corresponding message.
   3. The algorithm generates an FE secret key FE.sk_{G}_{_{ƒ}} for G[ƒ,s,SKE.ct] using FE.msk and outputs SK_{ƒ}.
Dec: The Dec algorithm takes as input the NIZK common reference string crs, a secret key SK_{ƒ}=FE.sk_{G}_{_{ƒ}} for the randomized function ƒ and a ciphertext CT (FE.ct,PKE.ct,π). It verifies the NIZK proof gr. If valid, it decrypts FE.ct using the secret key FE.sk_{G}_{_{ƒ}} and outputs the result; otherwise, it aborts and outputs ⊥.
It is easy to verify that the above rFE scheme is correct.

Insecurity of the constructed rFE scheme We demonstrate that the rFE scheme described above is insecure against malicious encryptors. Specifically, consider a pseudorandom function (PRF) with a key of the form K (K′,0,⊥), where K′ is the key for another pseudorandom function PRF′, and L is a special symbol. Given an input seed s, this PRF outputs PRF′(K′,s). It is easy to verify that this PRF behaves as a valid pseudorandom function. However, suppose the evaluation algorithm of this PRF includes a trojan branch. For keys of the form K (K′,1,r), where K′ is the key for PRF′ and r is a fixed string (matching the length of the output of PRF′), the evaluation algorithm bypasses PRF′ entirely and directly outputs the string r.

Now, consider instantiating the above rFE scheme with this specially crafted PRF and its evaluation algorithm. If the encryptor generates two ciphertexts ct₁ and ct₂ for the same message x, using PRF keys

$${K}_{1} = ( {K}_{1}^{′} , 1 , r ) and {K}_{2} = ( {K}_{2}^{′} , 1 , r )$$

with freshly sampled

$${K}_{1}^{′} and {K}_{2}^{′}$$

but using the same string r, the decryption using a secret key FE.sk_{G}_{_{ƒ}} for a randomized function ƒ will yield the same output ƒ(x;r) in both cases. This occurs because the trojan evaluation branch outputs the fixed string r, regardless of the seed.

In a secure rFE scheme, we expect the decryption results to be independent, uniformly sampled outputs from the distribution of ƒ(x). However, by carefully selecting PRF keys, a malicious encryptor can introduce arbitrary correlations between the decryption outputs of different ciphertexts for the same message. This attack can be further extended to enforce correlations among ciphertexts encrypting different messages, breaking the intended security guarantees of the rFE scheme.

Proving that our rFE scheme achieves the prior IND security definition. We provide an intuitive outline of why the rFE scheme constructed above satisfies the IND security definition from previous work. Observe that, this security definition is similar to the one against malicious decryptors but with an additional decryption oracle, akin to IND-CCA2 security. For simplicity in this overview, let's ignore the decryption oracle and focus on the case where the ciphertext consists solely of the underlying FE ciphertext. The other two components of the ciphertext are mostly designed to handle the decryption oracle. More precisely, those components are used to make the decryption oracle not used any secret key for FE while answering the decryption queries of the adversary during the hybrid proof.

At a high level, our goal is to reduce the IND security of the rFE scheme to the security of the underlying FE scheme, the SKE scheme, and the pseudorandom function (PRF). We outline the key steps in the proof through a series of hybrid arguments:
1. Initial Setup: We start with the security game where the FE ciphertext encrypts (x₀,K,0,⊥).
2. Hardcoding the Output: We now change the SKE ciphertext in the KeyGen queries from encrypting a random message to encrypting the output of ƒ(x₀;r), where r is the PRF output used as the randomness.
3. Modifying the Ciphertext: We update the FE ciphertext to encrypt (⊥,⊥,1,SKE.sk). Since α=1, the function G[ƒ,s,SKE.ct] will output the result of decrypting SKE.ct using SKE.sk, which yields exactly ƒ(x₀;r). So the output of G[ƒ,s,SKE.ct] remains unchanged, and thus this transition is indistinguishable by the security of FE scheme.
4. Switching PRF Output: Next, we use the security of the PRF to replace r with a uniform random string, instead of the output of the PRF. This transition is indistinguishable due to the security of the pseudorandom function PRF, as the PRF key K is hidden and unused.
5. Switching to ƒ(x₁): In the next hybrid, we switch ƒ(x₀;r) to ƒ(x₁;r), which is a uniform sample from the output distribution of ƒ(x₁). This change is indistinguishable due to the indinstinguishability of ƒ(x₀) and ƒ(x₁), as required by the IND security game restriction for rFE.
6. Final Reversion: Once this transition is made, we can reverse the previous steps, ultimately encrypting (x₁,K,0,⊥), completing the proof.

### 1.3 the Sketch of Proposed rMIFE Scheme

We now outline the main technical ideas behind our adaptively secure rMIFE scheme, which supports an unbounded number of challenge ciphertext queries per encryption slot. Inspired by prior work, we build upon the adaptively secure deterministic MIFE construction of Goldwasser et al., based on di [symbol] .

In their construction, the encryption key for each index i∈[n] (where n is the function's arity) consists of a pair of public keys

$$( p {k}_{i}^{0} , p {k}_{i}^{1} )$$

from an underlying public key encryption (PKE) scheme. The ciphertext for index i includes encryptions of the plaintext under both

$$p {k}_{i}^{0} and {pk}_{i}^{1} ,$$

along with a simulation-sound NIZK proof ensuring that both ciphertexts encrypt the same message. Additionally, the ciphertext contains a one-time signature on the two PKE ciphertexts and the NIZK proof, using a fresh one-time verification key generated at encryption time.

The secret key for a function ƒ is an obfuscated program that processes n ciphertext pairs, each with associated proofs, one-time signatures, and verification keys. This program has the function ƒ and a key K for a puncturable pseudorandom function (PRF) hardwired. The program takes as input cipher pairs

$$( {c}_{1}^{0} , {c}_{1}^{1} , {π}_{1} , {vk}_{1} , {σ}_{1} ) , … , ( {c}_{n}^{0} , {c}_{n}^{1} , {π}_{n} , v {k}_{n} , {σ}_{n} )$$

and first verifies the one-time signatures and proofs. If all checks pass, the program decrypts each ciphertext using the corresponding secret key. It then evaluates the puncturable PRF with key K on the entire ciphertext tuple to generate randomness r, which is finally used to apply ƒ to the decrypted plaintexts.

Goldwasser et al. showed that security against dishonest decryptors follows similarly to their deterministic MIFE scheme based on di [symbol] . They further mention that, security against malicious encryptors is ensured by the use of one-time signatures, which guarantee the uniqueness of each ciphertext, preventing adversaries from modifying honestly generated ciphertexts to manipulate decryption queries.

Unfortunately, as highlighted in our previous discussion, merely preventing the adversary from modifying honestly generated ciphertexts for decryption queries is insufficient to guarantee IND security against malicious encryptors. In fact, an adversary could generate “bad” ciphertexts for slots where it has corrupted the encryption keys, then combine these faulty ciphertexts with honestly generated ones from uncorrupted slots to extract non-uniform or correlated outputs from the decryption oracle. Therefore, a more robust approach is required to construct an rMIFE scheme that meets the stronger IND security definition. Furthermore, a key assumption behind security proof of the above rMIFE scheme is the use of di [symbol] . Specifically, when function keys are switched to decrypt the second ciphertext in each pair, an adversary capable of detecting this change could exploit it to produce a false proof.

To address these issues, we introduce modifications to the scheme, allowing us to leverage a result from prior work, which shows that any indistinguishability obfuscator is, in fact, a di [symbol] for circuits that differ on polynomially many points. Fortunately, recent work demonstrated that this result extends to our setting. Thus, we begin with a sub-exponentially secure indistinguishability obfuscator, which forms the basis of our enhanced approach to achieving adaptive IND security in the presence of malicious encryptors.

Specifically, to ensure that the proofs of well-formedness are unique for each ciphertext pair—and to limit the number of differing input points in the corresponding hybrids of our security proofs to a polynomial amount-we design novel proof strategy using i [symbol] and puncturable PRFs. Here's how it works:
We include in the public parameters an obfuscated program that takes two ciphertexts and a witness proving they are well-formed (i.e., generated using the same message and randomness). If this check succeeds, the program outputs a puncturable PRF evaluation on those ciphertexts. The secret key for a function ƒ is then an obfuscated program that has hardwired the PRF keys and verifies the proofs of well-formedness by checking the correctness of the PRF evaluations. As in the construction by Goldwasser et al., the program also contains an additional puncturable PRF key K, which is sampled during key generation. Once all PRF evaluations are verified, this puncturable PRF with key K is applied to the entire collection of ciphertexts to generate the randomness needed for the functional output.

In the security proof, we introduce a key enhancement by performing the verification through an injective one-way function applied to the PRF values, rather than directly comparing the PRF outputs. This approach ensures that extracting a differing input at this stage of the proof corresponds to inverting the injective one-way function. Without this mechanism, we would need to hardcode the correct PRF evaluation into the obfuscated secret key, making it difficult to argue security effectively.

Security against malicious decryptors. We now sketch the sequence of hybrids in our IND security proof against malicious decryptors. The proof starts from a hybrid where each challenge ciphertext encrypts

$${x}_{i}^{0}$$

for i∈[n]. Then we switch to a hybrid where each

$${c}_{i}^{1}$$

is an encryption of

$${x}_{i}^{1}$$

instead. These two hybrids are indistinguishable due to security of the PKE scheme. Let s denote the length of a ciphertext. For each index i∈[n] we define hybrids indexed by w, for all w∈[2^{2sn}], in which function key SK_{ƒ} decrypts the first ciphertext in the pair using

$$S {K}_{i}^{0}$$

when

$$( {c}_{1}^{0} , {c}_{1}^{1} , … , {c}_{n}^{0} , {c}_{n}^{1} ) < w$$

and decrypts the second ciphertext in the pair using

$$S {K}_{i}^{1}$$

otherwise. Parse

$$w = ( {w}_{1}^{0} , {w}_{1}^{1} , … , {w}_{n}^{0} , {w}_{n}^{1} ) .$$

Hybrids indexed by w and w+1 can be proven indistinguishable as follows: We first switch to sub-hybrids that puncture the PRF key at

$${w}_{i}^{0} , {w}_{i}^{1} ,$$

changes a function key SK_{ƒ} to check correctness of an PRF value by applying an injective one-way function as described above, and hardcoded the output of the injective one-way function as the PRF evaluation at the punctured point. We also puncture the hardwired puncturable PRF key K used for generating output randomness as the point

$$( {w}_{1}^{0} , {w}_{1}^{1} , … , {w}_{n}^{0} , {w}_{n}^{1} ) .$$

Roughly speaking, if two hybrids differ at an input of the form

$$( {w}_{1}^{0} , {w}_{1}^{1} , {u}_{1} , … , {w}_{n}^{0} , {w}_{n}^{1} , {u}_{n} )$$

where uᵢ is some fixed value (a PRF evaluation of

$$( {w}_{i}^{0} , {w}_{i}^{1} ) ) ,$$

extracting the differing input can be used to invert the injective one-way function on random input (namely the uᵢ). The formal security argument is a bit subtle at this point since unlike deterministic MIFE, we do not have exactly quality of the functional values corresponding to 0 and 1 cases. Instead, we carefully leverage the sub-exponentially small statistical distance between the functional output distribution corresponding to the 0 and 1 cases. Please refer to our formal proof in the sequel. Finally, we note that exponentially many hybrids are indexed by all possible ciphertext vectors that could be input to decryption (i.e., vectors of length the arity of the functionality) and not all possible challenge ciphertext vectors. This allows us to handle any unbounded (polynomial) number of ciphertexts for every index. Also, by deterministically traversing over all possible ciphertexts, we are able to support adaptive adversary since the deduction does not need to know what challenge ciphertexts the adversary will be querying during the hardwiring at different stages of the security proof.
We now outline the sequence of hybrids in our IND security proof against malicious decryptors.
The proof begins with a hybrid where each challenge ciphertext encrypts

$${x}_{i}^{0}$$

for i∈[n].
We then switch to a hybrid where each

$${c}_{i}^{1}$$

encrypts

$${x}_{i}^{1}$$

instead. These two hybrids are indistinguishable due to the security of the underlying PKE scheme.
Let s denote the length of a ciphertext. For each index i∈[n], we define hybrids indexed by w, for all w∈[2^{2sn}]. In these hybrids, the function key SK_{ƒ} decrypts the first ciphertext in each par using

$$S {K}_{i}^{0}$$

when

$$( {c}_{1}^{0} , {c}_{1}^{1} , … , {c}_{n}^{0} , {c}_{n}^{1} ) < w ,$$

and decrypts the second ciphertext in each pair using

$$S {K}_{i}^{1}$$

otherwise. The index w is parsed as

$$( {w}_{1}^{0} , {w}_{1}^{1} , … , {w}_{n}^{0} , {w}_{n}^{1} ) .$$

Hybrids indexed by w and w+1 can be proven indistinguishable as follows:
   First, we introduce sub-hybrids that puncture the PRF key at the points

$${w}_{i}^{0} , {w}_{i}^{1} .$$

We then modify the function key SK_{ƒ} to check the correctness of a PRF value by applying an injective one-way function, as described earlier, and hardcode the output of this function at the punctured points. Additionally, we puncture the hardcoded PRF key K, used for generating output randomness, at the point

$$( {w}_{1}^{0} , {w}_{1}^{1} , … , {w}_{n}^{0} , {w}_{n}^{1} ) .$$

Roughly speaking, if the two hybrids differ on an input of the form

$$( {w}_{1}^{0} , {w}_{1}^{1} , {u}_{1} , … , {w}_{n}^{0} , {w}_{n}^{1} , {u}_{n} )$$

where u is the result of a PRF evaluation on

$$( {w}_{i}^{0} , {w}_{i}^{1} )$$

extracting the differing input would allow us to invert the injective one-way function on random input, i.e., the uᵢ. The formal security argument is subtle here, as unlike in deterministic MIFE, we do not have exact equality between functional values in the 0 and 1 cases. Instead, we carefully exploit the sub-exponentially small statistical distance between the output distributions of the function in these two cases. For full details, please refer to our formal proof.

Lastly, we note that the exponentially many hybrids are indexed by all possible ciphertext vectors that could be input to decryption (i.e., vectors of length equal to the function's arity), rather than just the challenge ciphertext vectors. This allows us to handle any unbounded (polynomial) number of ciphertexts per index. By deterministically traversing all possible ciphertexts, we support adaptive adversaries without needing to know in advance which challenge ciphertexts the adversary will query at different stages of the security proof.

Security against malicious encryptors Finally, to argue security against malicious encryptors, we observe that the randomness used to evaluate the function output within the secret key program is derived from the hardwired PRF key, which is applied to the entire tuple of input ciphertexts. As a result, the encryptor has no control over the randomness used to generate the function output. This is because due to the pseudorandom properties of the PRF, whenever a different collection of ciphertexts is provided to the secret key program, the program generates a fresh random string for evaluating the output. This ensures that the encryptors cannot influence the randomness, maintaining the integrity of the function evaluation.

### 2 Preliminaries

Throughout, we will use λ to denote the security parameter.

### Notation

We say that a function ƒ(λ) is negligible in λ if ƒ(λ)=λ^{-ω(1)}, and we denote it by ƒ(λ)=negl(λ).
We say that a function g(λ) is polynomial in λ if g(λ) p(λ) for some fixed polynomial p, and we denote it by g(λ)=poly(λ).
For n∈ [symbol] , we use [n] to denote {1, . . . , n}.
If R is a random variable, then r←R denotes sampling r from R. If T is a set, then i←T denotes sampling i uniformly at random from T.

Definition 2.1 (Statistical Distance). Let D₁ and D₂ be two distributions with support in X. The statistical distance between D₁ and D₂ is

$$Δ ( {D}_{1} , {D}_{2} ) = \frac{1}{2} {\sum }_{x ∈ X} \vert Pr [ {D}_{1} = x ] - P r [ {D}_{2} = x ] \vert$$

Notation Let A and B be two random variables with support in X. We use Δ(A,B) to denote the statistical distance Δ(P_{A},P_{B}) between the underlying distributions of the random variables.

Definition 2.2 (Pseudorandom Function (PRF)). A pseudorandom function family (PRF) with key space [symbol] is a tuple of PPT algorithms PRF=(PRF.Setup,PRF.Eval) where
PRF.Setup(1^{λ},1ⁿ,1^{m}) is a randomized algorithm that takes as input the security parameter λ, an input length n, and an output length m, and outputs a key K∈ [symbol] _{λ,n,m}.
PRF.Eval(K,x) is a deterministic algorithm that takes as input a key K∈ [symbol] _{λ,n,m} and an input x∈{0,1}ⁿ, and outputs a value y∈{0, 1}^{m}.

Security requires that there exists a negligible function μ such that for all λ∈ [symbol] and all PPT adversaries [symbol] ,

$$\vert Pr [ {Expt}_{A}^{PRF} ( {1}^{λ} , 0 ) = 1 ] - Pr [ {Expt}_{A}^{PRF} ( {1}^{λ} , 1 ) = 1 ] \vert \leq μ ( λ )$$

where for each b∈{0,1} and λ∈ [symbol] , we define
   [symbol] (1^{λ},b)
      1. Parameters: [symbol] takes as input 1^{λ} and outputs an input size 1ⁿ and an output size 1^{m}.
      2. Setup:
         (a) If b=0, sample K←PRF.Setup(1^{λ},1ⁿ,1^{m}).
         (b) If b=1, sample R← [symbol] _{n,m} where [symbol] ^{n,m} is the set of all functions from {0,1}ⁿ to {0,1}^{m}.
      3. PRF Queries: The following can be repeated any polynomial number of times:
         (a) [symbol] outputs a value x∈{0,1}ⁿ.
         (b) If b=0, send y=PRF.Eval(K,x) to [symbol] .
         (c) If b=1, send y=R(x) to [symbol] .
      4. Experiment Outcome: A outputs a bit b′ which is the output of the experiment.

Definition 2.3 (Puncturable Pseudorandom Function (PPRF)). A puncturable pseudorandom function family with key space [symbol] is a tuple of PPT algorithms PPRF=(PPRF.Setup,PPRF.Eval,PPRF.Punc,PPRF.EvalPunc) where
PPRF.Setup(1^{λ},1ⁿ,1^{m}) is a randomized algorithm that takes as input the security parameter λ, an input length n, and an output length m, and outputs a key K∈ [symbol] ^{λ,n,m}.
PPRF.Eval(K,x) is a deterministic algorithm that takes as input a key K∈ [symbol] _{λ,n,m} and an input x∈{0,1}ⁿ, and outputs a value y∈{0,1}^{m}.
PPRF.Punc(K,x*) is a randomized algorithm that takes as input a key K∈ [symbol] _{λ,n,m} and an input x*∈{0,1}ⁿ, and outputs a punctured key K[x*].
PPRF.EvalPunc(K[x*],x) is a deterministic algorithm that takes as input a punctured key K[x*] and an input x∈{0,1}ⁿ, and outputs either a value y∈{0,1}^{m} or ⊥.

We require the scheme to satisfy correctness under puncturing, and selective pseudorandomness at punctured points as defined below.

Remark 2.4. For convenience, we will sometimes combine PPRF.Eval and PPRF.EvalPunc into one algorithm. This can be done by having the combined algorithm run PPRF.Eval if it receives a regular key K and run PPRF.EvalPunc if it receives a punctured key K[x*] since the two types of keys are easily distinguishable in known constructions. When using the combined algorithm, we will overload notation and refer to it simply by PPRF.Eval.

Definition 2.5 (Correctness under Puncturing). For all λ, n, m ∈ [symbol] and all x*∈{0,1}ⁿ, if K←PPRF.Setup(1^{λ},1ⁿ, 1^{m}) and K[x*]←PPRF.Punc(K,x*), then

$$PPRF \cdot EvalPunc ( K [ {x}^{*} ] , x ) = \{ \begin{matrix}PPRF \cdot Eval ( K , x ) & if x \neq {x}^{*} \\ ⊥ & else\end{matrix}$$

Definition 2.6 (Selective Pseudorandomness at Punctured Points). There exists a negligible function μ such that for all λ∈ [symbol] and all PPT adversaries [symbol] ,

$$\vert Pr [ {Expt}_{A}^{PPRF} ( {1}^{λ} , 0 ) = 1 ] - Pr [ {Expt}_{A}^{PPRF} ( {1}^{λ} , 1 ) = 1 ] \vert \leq μ ( λ )$$

where for each b∈{0,1} and λ∈ [symbol] , we define
[symbol] [0178] 1. Parameters: [symbol] takes as input 1^{λ}, and outputs an input size 1ⁿ, an output size 1^{m}, and a message x*∈{0,1}ⁿ.
   2. Compute Values:
      (a) K←PPRF.Setup(1^{λ},1ⁿ,1^{m}).
      (b) K[x*]←PPRF.Punc(K,x*).
      (c) If b=0, send (y,K[x*]) to [symbol] where y=PPRF.Eval(K,x*).
      (d) If b=1, send (r,K[x*]) to [symbol] where r←{0,1}^{m}.
   3. Experiment Outcome: [symbol] outputs a bit b′ which is the output of the experiment.

Definition 2.7 (Symmetric Key Encryption (SKE)). A symmetric key encryption scheme with key space [symbol] and ciphertext size m(·) is a tuple of PPT algorithms SKE=(SKE.Setup,SKE.Enc,SKE.Dec) where
SKE.Setup(1^{λ},1ⁿ) is a randomized algorithm that takes as input the security parameter λ and an input length n and outputs a secret key k∈ [symbol] _{λ,n}
SKE.Enc(k,x) is a randomized algorithm that takes as input a secret key k∈ [symbol] _{λ,n} and a message x∈{0,1}ⁿ and outputs an encryption ct∈{0,1}^{m(λ,n)} of x.
SKE.Dec(k,ct) is a deterministic algorithm that takes as input a secret key k∈ [symbol] _{λ,n} and a ciphertext ct∈{0,1}^{m(λ,n)} and outputs a value y∈{0,1}ⁿ.

Correctness requires that for all λ, n∈ [symbol] and every x∈{0,1}ⁿ,

$$Pr [ SKE \cdot Dec ( k , SKE \cdot Enc ( k , x ) ) = x : k ← SKE \cdot Setup ( {1}^{λ} , {1}^{n} ) ] = 1$$

Security requires that there exists a negligible function μ such that for all λ∈ [symbol] and all PPT adversaries [symbol] ,

$$\vert Pr [ {Expt}_{A}^{SKE} ( {1}^{λ} , 0 ) = 1 ] - Pr [ {Expt}_{A}^{SKE} ( {1}^{λ} , 1 ) = 1 ] \vert \leq μ ( λ )$$

where for each b∈{0,1} and λ∈ [symbol] , we define
[symbol] [0193] 1. Parameters: [symbol] takes as input 1^{λ} and outputs an input size 1ⁿ.
   2. Setup: k←SKE.Setup(1^{λ},1ⁿ)
   3. Challenge Message Queries: The following can be repeated any polynomial number of times:
      (a) [symbol] outputs a challenge message pair (x₀,x₁) where x₀,x₁∈{0,1}ⁿ.
      (b) ct_{b}←SKE.Enc(k,x_{b})
      (c) Sent ct_{b} to [symbol] .
4. Experiment Outcome: [symbol] outputs a bit b′ which is the output of the experiment.

Definition 2.8 (Public Key Encryption (PKE)). A public-key encryption (PKE) scheme is a tuple of PPT algorithms PKE (PKE.Setup,PKE.Enc,PKE.Dec) with the following syntax:
(pk,sk)←Setup(1^{λ}): Takes as input the security parameter and samples a public/private key pair.
ct←Enc(pk,m): Takes as input the public key and a message, and outputs a ciphertext encrypting the corresponding message.
m←Dec(sk,ct): Takes as input the private key and a ciphertext, and outputs a decrypted message.

Correctness requires that for all A∈ [symbol] and every m,

$$Pr [ PKE \cdot Dec ( sk , PKE \cdot Enc ( pk , m ) ) = m : ( pk , sk ) ← PKE \cdot Setup ( {1}^{λ} ) ] = 1.$$

A PKE scheme PKE is IND-CPA secure if for all PPT adversaries [symbol] ( [symbol] ₁, [symbol] ₂), we have

$$Pr [ {b}^{′} = b : \begin{matrix}( pk , sk ) ← Setup ( {1}^{λ} ) ; \\ ( {m}_{0} , {m}_{1} , st ) ← {A}_{1} ( pk ) ; \\ b ← \{ 0 , 1 \} , {ct}^{*} ← Enc ( pk , {m}_{b} ) ; \\ {b}^{′} ← {A}_{2} ( st , {ct}^{*} )\end{matrix} ] \leq \frac{1}{2} + negl ( λ ) .$$

### 2.1 Indistinguishability Obfuscation

Recent work shows how to construct i [symbol] for P/Poly from well-established computational assumptions.

Definition 2.9 (Indistinguishability Obfuscation (i [symbol] ) for Circuits). A uniform PPT algorithm i [symbol] is an indistinguishability obfuscator for polynomial-sized circuits if the following holds:
Completeness: For every λ∈ [symbol] , every circuit C with input length n, and every input x∈{0,1}ⁿ,

$$Pr [ {C}^{′} ( x ) = C ( x ) : {C}^{′} ← i 𝒪 ( {1}^{λ} , C ) ] = 1$$

Indistinguishability: For every two ensembles {C_{0,λ}}, {C_{1,λ}} of polynomial-sized circuits that have the same size, input length, and output length, and are functionally equivalent, that is, ∀λ∈ [symbol] , C_{0,λ}(x)=C_{1,λ}(x) for every input x, then for all polynomial-time, non-uniform adversaries [symbol] , there exists a negligible function μ, such that for all λ,

$$\vert Pr [ A ( {1}^{λ} , i 𝒪 ( {1}^{λ} , {C}_{0 , λ} ) ) ] = 1 - Pr [ A ( {1}^{λ} , i 𝒪 ( {1}^{λ} , {C}_{1 , λ} ) ) ] = 1 \vert \leq μ ( λ )$$

### 2.2 Functional Encryption

Here we give some fundamental definitions for functional encryption (FE) schemes. First, we define a class of functions parameterized by function size, input length, and output length.

Definition 2.10 (Function Class). The function class [symbol] is the set of all functions ƒ that have a description \hat{ƒ}∈ [symbol] , take inputs in [symbol] , and output values in [symbol] .

Definition 2.11 (Public-Key Functional Encryption). A public-key functional encryption scheme for P/Poly is a tuple of PPT algorithms FE=(Setup,Enc,KeyGen,Dec) defined as follows: (We also allow Enc, KeyGen, and Dec to additionally receive parameters [symbol] as input, but omit them from our notation for convenience.)
Setup [symbol] : takes as input the security parameter λ, a function size [symbol] , an input size [symbol] , and an output size [symbol] , and outputs the master public key mpk and the master secret key msk.
Enc(mpk,x): takes as input the master public key mpk and a message x∈ [symbol] , and outputs an encryption ct of x.
KeyGen(msk,ƒ): takes as input the master secret key msk and a function ƒ∈ [symbol] , and outputs a function key sk_{ƒ}.
Dec(sk_{ƒ},ct): takes as input a function key sk_{ƒ} and a ciphertext ct, and outputs a value y∈ [symbol] .

FE satisfies correctness if for all polynomials p, there exists a negligible function μ such that for all λ∈ [symbol] , all [symbol] , all x∈ [symbol] , and all ƒ∈ [symbol] ,

$$Pr [ Dec ( {sk}_{f} , {ct}_{x} ) = f ( x ) : \begin{matrix}( mpk , msk ) ← Setup ( {1}^{λ} , {1}^{{ℓ}_{ℱ}} , {1}^{{ℓ}_{𝒳}} , {1}^{{ℓ}_{𝒴}} ) \\ {ct}_{x} ← Enc ( mpk , x ) \\ {sk}_{f} ← Key Gen ( msk , f )\end{matrix} ] \geq 1 - μ ( λ ) .$$

We now define adaptive security.

Definition 2.12 (Adaptive Security for Public-Key FE). A public-key functional encryption scheme FE for P/Poly is adaptively secure if there exists a negligible function μ such that for all λ∈ [symbol] and every PPT adversary [symbol] ,

$$\vert Pr [ {Expt}_{A}^{FE - Adaptive} ( {1}^{λ} , 0 ) = 1 ] - Pr [ {Expt}_{A}^{FE - Adaptive} ( {1}^{λ} , 1 ) = 1 ] \vert \leq μ ( λ )$$

where for each b∈{0,1} and λ∈ [symbol] , we define
[symbol] [0222] 1. Parameters: [symbol] takes as input 1^{λ}, and outputs a function size [symbol] , an input size [symbol] , and an output size [symbol] .
   2. Setup: Compute (mpk,msk)←FE.Setup [symbol] ,
   3. Public Key: Send mpk to [symbol] .
   4. Function Queries Phase 1: The following can be repeated any polynomial number of times:
      (a) [symbol] outputs a function query ƒ∈ [symbol]
      (b) sk_{ƒ}←FE.KeyGen(msk,ƒ)
      (c) Send sk_{ƒ} to [symbol]
   5. Challenge Message Query:
      (a) A outputs a challenge message pair (x₀,x₁) where x₀,x₁∈ [symbol] .
      (b) ct←FE.Enc(mpk,x_{b})
      (c) Send ct to [symbol] .
   6. Function Queries Phase [symbol] : This is identical to Function Queries Phase 1.
   7. Experiment Outcome: A outputs a bit b′ which is the output of the experiment.
Additionally, when running the experiment, we immediately halt and output 0 if the adversary ever aborts or if it at any point ƒ(x₀)≠ƒ(x₁) for some message query (x₀,x₁) and function query ƒ submitted by the adversary.

Definition 2.13 (Other Public-Key FE Security Definitions). There are many variations of the security definition. We list a few below:
Semi-Adaptive Security: The adversary is required to make the message query before the function queries. This is identical to adaptive security, except that we remove Function Queries Phase 1 from the security game.
Function-Selective Semi-Adaptive Security: The adversary is required to make all function queries before the message query. This is identical to adaptive security, except that we remove Function Queries Phase 2 from the security game.
Selective Security: The adversary is required to make the message query at the beginning of the experiment before receiving the master public key. This is similar to adaptive security, except that in the security game, we move the Challenge Message Query step so that it now lies between the Setup step and the Public Key step. Note that the two function query phases are now adjacent and can thus be merged into one step.
Function-Selective Security: The adversary is required to make the function queries at the beginning of the experiment before receiving the master public key. This is similar to adaptive security, except that in the security game, we move the two function query steps so that they now lie between the Setup step and the Public Key step. Note that the two function query phases are now adjacent and can thus be merged into one step.

### 2.3 Non-Interactive Zero Knowledge Proof Systems

Definition 2.14 (Non-Interactive Zero Knowledge Proof). Let L∈NP and R_{L} be the corresponding NP relation. Let λ∈ [symbol] be the security parameter. A Non-Interactive Zero Knowledge (NIZK) Proof is a tuple of algorithms 1=(Setup,Prove,Verify) with the following syntax:
crs←Setup(1^{λ}): Takes as input the security parameter 1^{λ} and outputs the common reference string crs.
π←Prove(crs,x,w): Takes as input the common reference string crs, a statement x, and a witness w, and outputs a proof π.
1/0←Verify(crs,x,π): Takes as input the common reference string crs, a statement x and a proof π, outputs a single bit 1/0 signaling whether the proof π is valid for the statement x.

We require the following properties of a NIZK scheme:
Perfect Completeness: For all security parameters λ∈ [symbol] , and all (x,w)∈R_{L}, we have

$$Pr [ Verify ( crs , x , π ) = 1 : \begin{matrix}crs ← Setup ( {1}^{λ} ) ; \\ π ← Prove ( crs , x , w ) ; \\ \end{matrix} ] = 1.$$

Computational Adaptive Soundness: For all PPT adversaries [symbol] , we have

$$Pr [ {Expt Sound}_{Π , A} ( {1}^{λ} ) = 1 ] \leq negl ( λ ) ,$$

where the experiment ExptSound is defined as below:
ExptSound_{Π,} [symbol] (λ):
   1. crs←Setup(1^{λ});
   2. (x,π)← [symbol] (1⁸⁰,crs);
   3. The experiment outputs 1 if and only if x∉L∧Verify(crs,x,π)=1.
Computational Zero-Knowledge: There exists a pair of PPT simulators Sim=(Sim₁,Sim₂) where Sim₁(1^{λ}) outputs ( [symbol] ,τ) and Sim₂( [symbol] ,τ,x) ouputs a simulated proof \tilde{π} such that for all non-uniform PPT adversaries [symbol] :

$$\vert Pr [ {A}^{{𝒪}_{1 ( crs , . , . )}} ( crs ) = 1 : crs ← Setup ( {1}^{λ} ) ] - Pr [ {A}^{{𝒪}_{2 ( crs , τ , . , . )}} ( ) = 1 : ( , τ ) ← {Sim}_{1} ( {1}^{λ} ) ] \vert \leq negl ( λ ) ,$$

where [symbol] ₁, [symbol] ₂ on input (x,w) returns ⊥ if (x,w)∉R_{L}. Otherwise, [symbol] ₁ returns Prove(crs,x,w) and [symbol] ₂ returns Sim₂( [symbol] ,τ,x).

We can also require a NIZK to have Simulation Soundness, saying that the protocol still has soundness after the adversary sees simulated proofs.

Definition 2.15 (Unbounded Simulation Soundness). Let Sim=(Sim₁,Sim₂) be the simulators for a NIZK protocol Π (Setup, Prove, Verify) as defined in Computational Zero Knowledge. We say Π has (unbounded) simulation soundness if for all PPT adversaries [symbol] , we have

$$Pr [ ( x , π ) ∉ Q ∧ x ∉ ℒ ∧ Verify ( , x , π ) = 1 : \begin{matrix}( , τ ) ← {Sim}_{1} ( {1}^{λ} ) ; \\ ( x , π ) ← ( )\end{matrix} ] \leq negl ( λ ) ,$$

where Q denotes the set of all Sim₂ queries by [symbol] and their corresponding responses (xᵢ,\tilde{π}ᵢ).

### 3 Improved Security Definitions for Randomized Multi-Input Functional Encryption (rMIFE)

The syntax of rMIFE follows naturally from that of MIFE and FE for randomized functionalities.

Definition 3.1 (Randomized Function Class). The randomized function class [symbol] is the set of all functions ƒ: [symbol] = [symbol] → [symbol] that have a description \hat{ƒ}∈ [symbol] . We interpret each function ƒ as a randomized function with arity n that takes as input values x₁, . . . xₙ where each xᵢ∈ [symbol] and randomness r∈ [symbol] out outputs a value y∈ [symbol] .

Definition 3.2 (rMIFE). A randomized multi-input functional encryption (rMIFE) scheme for P/Poly is a tuple of PPT algorithms rMIFE=(Setup,KeyGen,Enc,Dec) defined as follows:
Setup [symbol] : takes as input the security parameter λ, a function arity n, a function size [symbol] an nut size [symbol] a randomness size [symbol] and an output size [symbol] , out outputs n encryption keys EK₁, . . . EKₙ and the master secret key MSK.
KeyGen(MSK,ƒ): takes as input the master secret key MSK and a function ƒ∈ [symbol] and outputs a function key sk_{ƒ}.
Enc(EKⱼ,xⱼ): takes as input an encryption key EKⱼ and an input xⱼ∈ [symbol] and outputs an encryption ctⱼ of xⱼ.
Dec(sk_{ƒ},ct₁, . . . , ctₙ): takes as input a function key sk_{ƒ} and ciphertexts ct₁, . . . , ctₙ and outputs a value y∈ [symbol] .

rMIFE satisfies correctness if for all polynomials p, there exists a negligible function μ such that for all λ∈ [symbol] , all n, [symbol] q≤p(λ) all {ƒ}_{k∈[q]} where each ƒₖ∈ [symbol] all {x_{i,1}, . . . , x_{i,n}}_{i∈[q]} where each x_{i,j}∈ [symbol] , and all PPT adversaries [symbol] ,

$$\vert Pr [ {Real}_{A} ( {1}^{λ} ) = 1 ] - Pr [ {Ideal}_{A} ( {1}^{λ} ) = 1 \vert \leq μ ( {1}^{λ} )$$

where we define
   [symbol] [0268] 1. (EK₁, . . . , EKₙ,MSK)←Setup(1^{λ}).
      2. For k∈[q], skₖ←KeyGen(MSK,ƒₖ).
      3. For i∈[q], j∈[n], ct_{i,j}←Enc(EKⱼ,x_{i,j}).
      4. For k, i₁, . . . , iₙ∈[q], y_{k,i}_{₁}_{, . . . ,i}_{ₙ}=Dec(skₖ,cti_{i,1}, . . . , cᵢ_{ₙ}_{,n}).
      5. Output [symbol] (1^{λ}) where [symbol] (k,i₁ . . . , iₙ) y_{k,i}_{₁}_{, . . . , i}_{ₙ}.
   [symbol] [0274] 1. For k, i₁, . . . , iₙ∈[q],
      (a) r_{k,i}_{₁}_{, . . . , i}_{ₙ}← [symbol]
      (b) y_{k,i}_{₁}_{, . . . , i}_{ₙ}=ƒₖ(xᵢ_{₁}_{,1}, . . . , xᵢ_{ₙ}_{,n};r_{k,i}_{₁}_{, . . . , i}_{ₙ})
   2. Output [symbol] (1^{λ}) where [symbol] (k,i₁ . . . iₙ)=y_{k,i}_{₁}_{, . . . , i}_{ₙ}.

Definition 3.3 (Simulation-based Security for rMIFE). A randomized multi-input functional encryption scheme rMIFE=(Setup,KeyGen,Enc,Dec) for P/Poly is (q₁, q_{c}, q₂) simulation-secure against both malicious encryptors and decryptors if there exists a PPT simulator S=(S₁,S₂, . . . , S₅), a negligible function P such that for all sufficiently large λ, and all PPT adversaries [symbol] where [symbol] ₁ makes at most q₁ key-generation queries and [symbol] ₂ makes at most q₂ hey-generation queries, we have

$$\vert Pr [ {Expt}_{A}^{rMIFE , Real} ( {1}^{λ} ) = 1 ] - P r [ {Expt}_{A , S}^{rMIFE , Ideal} ( {1}^{λ} ) = 1 \vert \leq negl ( λ )$$

where we define,

$${Expt}_{A}^{rMIFE , Real} ( {1}^{λ} )$$

1. (EK₁, . . . . , EKₙ,MSK)← [symbol] .
We define \vec{EK}=(EK₁, . . . , EKₙ)
2.

$$( {\{ ( {x}_{i , j} ) \}}_{i ∈ [ n ] , j ∈ [ {q}_{c} ]} , st ) ← {A}_{1}^{OGetEK ( \vec{EK} , \cdot ) , KeyGen ( MSK , \cdot ) , OKeyStore ( MSK , \cdot ) , ODec ( MSK , \cdot )} ( {1}^{λ} ) .$$

3.

$$c {t}_{i , j}^{*} ← Enc ( {EK}_{i} , {x}_{i , j} )$$

4.

$$α ← {A}_{2}^{OGetEK ( \vec{EK} , \cdot ) , KeyGen ( MSK , \cdot ) , OKeyStore ( MSK , \cdot ) , ODec ( MSK , \cdot )} ( \{ {ct}_{i , j}^{*} \} i ∈ [ n ] , j ∈ [ {q}_{c} ] , st ) .$$

5. Output ({(x_{i,j})}_{i∈[n],j∈[c]}, {ƒₖ}_{k∈[q1+q2]}, {g}, {y}, α).

$${Expt}_{A , S}^{rMIFEIdeal} ( {1}^{λ} )$$

1. st′←S₁ [symbol]
2.

$$( {\{ ( {x}_{i , j} ) \}}_{i ∈ [ n ] , j ∈ [ {q}_{c} ]} , st ) ← {A}_{1}^{{O}^{′} GetEK ( {st}^{′} , \cdot ) , {O}^{′} {KeyGen}_{1} ( {st}^{′} , \cdot ) , {O}^{′} KeyStore ( {st}^{′} , \cdot ) , {ODec}^{′} ( {st}^{′} , \cdot )} ( {1}^{λ} ) .$$

Let {ƒₖ}_{k∈[q1]} be [symbol] ₁'s oracle queries to O′KeyGen₁(st′,·).
Pick rⱼ_{₁}_{, . . . , j}_{ₙ}_{,k}← [symbol] and let yⱼ_{₁}_{, . . . , j}_{ₙ}_{,k}=ƒₖ (x_{1,j}_{₁}, . . . , x_{n,j}_{ₙ};rⱼ_{₁}_{, . . . , j}_{ₙ}_{,k}) for all j₁, . . . , jₙ∈[q_{c}], k∈[q₁].
3.

$$( {\{ c {t}_{i , j}^{*} \}}_{i ∈ [ n ] , j ∈ [ {q}_{c} ]} , {st}^{′} ) ← {S}_{3} ( {st}^{′} , {\{ {y}_{{j}_{1} , … , {j}_{n , k}} \}}_{{j}_{1} , … , {j}_{n} ∈ [ {q}_{c} ] , k ∈ [ {q}_{1} ]} ) .$$

4.

$$α ← {A}_{2}^{{O}^{′} GetEK ( {st}^{′} , \cdot ) , {O}^{′} {KeyGen}_{2} ( {st}^{′} , \cdot ) , {O}^{′} KeyStore ( {st}^{′} , \cdot ) , {O}^{′} Dec ( {st}^{′} , \cdot )} ( {\{ c {t}_{i , j}^{*} \}}_{i ∈ [ n ] , j ∈ {q}_{c}} , st ) .$$

Output ({(x_{i,j})}_{i∈[n],j∈[q}_{_{c}}_{]}, {ƒₖ}_{k∈[q1+q2]}, {9}, {y′}, α).
and where we define

### In Real Experiment:

OGetEK(\vec{EK},i): Output EKᵢ.
OKeyStore(MSK,g):
   1. sk_{g}←KeyGen(MSK,g).
   2. Store (g,sk_{g}) in register KeyReg.
   3. Output ⊥.
ODec({ct_{i,j}*}_{i∈[n],j∈[q}_{_{c}}_{]}, {ctᵢ}_{i∈[n]}):
   1. For each (gₗ,sk_{gl}) stored in register KeyReg: yₗ=Dec(sk_{gl},{ctᵢ}_{i∈[n]})
   2. Output {yᵢ}.

### In Ideal Experiment:

O′GetEK(st′,i): Output

$${EK}_{i}^{′}$$

O′KeyGen₁(st′,ƒₖ)
   1. s_{ƒ}_{ₖ}′←S₂(st′,ƒₖ)
   2. Output {sk_{ƒ}_{ₖ}′}
O′KeyGen₂(st′,ƒₖ)
   1.

$${sk}_{{f}_{k}}^{′} ← {S}_{4} ( {st}^{′} , {f}_{k} , KeyIdeal ( {\{ {x}_{i , j} \}}_{i ∈ [ n ] , j ∈ {q}_{c}} ) )$$

2.

$$Output {sk}_{{f}_{k}}^{′}$$

3. KeyIdeal({x_{i,j}}_{i∈[n],j∈q}_{_{c}})
   (a) rⱼ_{₁}_{, . . . , j}_{ₙ}_{,k}← [symbol] ,{0,1}, jₙ∈[q_{c}]
   (b) yⱼ_{₁}_{, . . . , j}_{ₙ}_{,k}=ƒₖ(x_{1,j}_{₁}, . . . , n_{n,j}_{ₙ};rⱼ_{₁}_{, . . . , j}_{ₙ}_{,k}) for all j₁, . . . , jₙ∈[q_{c}]
   (c) Output {yⱼ_{₁}_{, . . . , j}_{ₙ}_{,k}} for all j₁, . . . , jₙ∈[q_{c}].
O′KeyStore(st′,g):
   1. Store (g,⊥) in register KeyReg.
   2. Output ⊥.
O′Dec(st′,

$${\{ c {t}_{i , j}^{*} \}}_{i ∈ [ n ] , j ∈ q [ c ] ,}$$

{ctᵢ}_{i∈[n]}):
   1. For each (gₗ,⊥) stored in register KeyReg:
      (a) If (l,{ctᵢ}_{i∈[n]},y) is stored in register OutReg for some y, output y.
      (b) For i∈[n], xᵢ=S₅(st′,ctᵢ).
      (c) rₗ← [symbol] .
      (d) yₗ←gₗ({xᵢ}_{i∈[n]};rₗ).
      (e) Store (l,{ctᵢ}_{i∈[n]},yₗ) in OutReg.
   2. Output {yₗ}.

Definition 3.4 (( [symbol] ,ϵ)- [symbol] -randomized-compatible). Let n, [symbol] , q₁, q₂∈ [symbol] .
Let [symbol] ⊆[n].
Let

$${\{ ( {x}_{i , j}^{( 0 )} , {x}_{i , j}^{( 1 )} ) \}}_{i ∈ [ n ] , j ∈ [ {q}_{1} ]}$$

be a set of inputs where each

$${x}_{i , j}^{( b )}$$

∈ [symbol] .
Let {ƒₖ}_{k∈[q2]} be a set of functions where each ƒₖ∈ [symbol] .

We say that

$${\{ {x}_{i , j}^{( 0 )} , {x}_{i , j}^{( 1 )} \}}_{i ∈ [ n ] , j ∈ [ {q}_{1} ]}$$

is ϵ- [symbol] -randomized-compatible with {ƒₖ}_{k∈[q2]} if
For all U⊆I, all {xᵤ′}_{u∈U} where each xᵤ′∈ [symbol] , all {jₜ}_{t∈[n]\U} where each jₜ∈[q₁], and all k∈[q₂],

$$\vert Pr [ 𝒜 ( {f}_{k} , U , {\{ {x}_{u}^{′} \}}_{u ∈ U} , {\{ {x}_{t , {j}_{t}}^{( 0 )} \}}_{t ∈ [ n ] \backslash U} , {f}_{k} ( 〈 {\{ {x}_{u}^{′} \}}_{u ∈ U} , {\{ {x}_{t , {j}_{t}}^{( 0 )} \}}_{t ∈ [ n ] \backslash U} 〉 ) ) = 1 ] - Pr [ 𝒜 ( {f}_{k} , U , {\{ {x}_{u}^{′} \}}_{u ∈ U} , {\{ {x}_{t , {j}_{t}}^{( 0 )} \}}_{t ∈ [ n ] \backslash U} , {f}_{k} ( 〈 {\{ {x}_{u}^{′} \}}_{u ∈ U} , {\{ {x}_{t , {j}_{t}}^{( 1 )} \}}_{t ∈ [ n ] \backslash U} 〉 ) ) = 1 ] \vert \leq ϵ$$

where

$$〈 {\{ {x}_{u}^{′} \}}_{u ∈ U} , {\{ {x}_{t , {j}_{t}}^{( b )} \}}_{t ∈ [ n ] \backslash U} 〉$$

is a permutation (x₁, . . . , xₙ) such that

$${x}_{i} = \{ \begin{matrix}{x}_{i}^{′} & if i ∈ U \\ {x}_{i , {j}_{i}}^{( b )} & if i ∈ [ n ] \backslash U\end{matrix}$$

Definition 3.5 (Indistinguishability Based Security Against Malicious decryptors for rMIFE). A randomized multi-input functional encryption scheme rMIFE=(Setup,KeyGen,Enc,Dec) for P/Poly is IND secure against malicious receivers for ϵ=ϵ(λ)-distinguishable distributions if there exists a negligible function μ such that for all sufficiently large λ, and all PPT adversaries [symbol] ,

$$Pr [ {Expt}_{𝒜}^{rMIFE - Decryptors} ( {1}^{λ} ) = 1 ] \leq \frac{1}{2} + negl ( λ )$$

where we define

$${Expt}_{𝒜}^{rMIFE - Decryptors} ( {1}^{λ} ) :$$

1. Parameters: [symbol] takes as input 1^{λ}, and outputs an arity 1ⁿ, a function size [symbol] , an input size [symbol] , a randomness size [symbol] , and an output size [symbol] .
2. Setup: (EK₁, . . . , EKₙ,MSK)←Setup [symbol] .
   We define \vec{EK}=(EK₁, . . . , EKₙ).
3. Challenge Bit: b←{0,1}.
4. Adversary's Output: b′← [symbol] ^{OGetEK(\vec{EK},·),OEncLR(\vec{EK},b,·),KeyGen(MSK,·)}
5. Experiment Output: Output 1 if b=b′ and if

$${\{ ( {x}_{i , j}^{( 0 )} , {x}_{i , j}^{( 1 )} ) \}}_{i ∈ [ n ] , j ∈ [ {q}_{1} ]}$$

( [symbol] ,ϵ)- [symbol] -randomized-compatible with {ƒₖ}_{k∈[q2]} where
   [symbol] are the set of queries made to OGetEK by [symbol] .
   {

$${( {x}_{i , j}^{( 0 )} , {x}_{i , j}^{( 1 )} ) \}}_{i ∈ [ n ] , j ∈ [ {q}_{1} ]}$$

are the set of queries made to OEncLR by [symbol] .
{ƒₖ}_{k∈q2} are the set of queries made to KeyGen by [symbol] .
and where we define
   OGetEK(\vec{EK},j): Output EKⱼ.
   OEncLR(\vec{EK},b,

$${\{ ( {x}_{i}^{( 0 )} , {x}_{i}^{( 1 )} ) \}}_{i ∈ [ n ]} )$$

1. For i∈[n],

$${ct}_{i}^{( b )} ← M I F E \cdot Enc ( E {K}_{i} , {x}_{i}^{( b )} ) . \qquad ( a )$$

2. Output

$$C {T}_{b} = {\{ {ct}_{i}^{( b )} \}}_{i ∈ [ n ]} .$$

Definition 3.6 (Indistinguishability Based Security Against Malicious Encryptors for rMIFE). A randomized multi-input functional encryption scheme rMIFE=(Setup,KeyGen,Enc,Dec) for P/Poly is IND secure against malicious encryptors if there exists a PPT extractor Extr and a negligible function μ such that for all λ∈ [symbol] , and all PPT adversaries [symbol] ,

$$Pr [ {Expt}_{𝒜}^{rMIFE - Encryptors} ( {1}^{λ} ) = 1 ] \leq \frac{1}{2} + negl ( λ )$$

where we define

$${Expt}_{𝒜}^{rMIFE - Encryptors} ( {1}^{λ} ) :$$

1. Parameters: [symbol] takes as input 1^{λ}, and outputs an arity 1ⁿ, a function size [symbol] , an input size [symbol] , a randomness size [symbol] , and an output size [symbol] .
2. Setup: (EK₁, . . . , EKₙ,MSK)←Setup [symbol]
We define \vec{EK}=(EK₁, . . . , EKₙ).
3. Challenge Bit: b←{0,1}.
4. Adversary's Output:
   b [symbol] ^{OGetEK(\vec{EK},·),OEnc(\vec{EK},·),KeyGen(MSK,·),OKeyStore(MSK,·),ODec(MSK,b,·)}
5. Experiment Output: Output 1 if b=b′.
and where we define
   OGetEK(\vec{EK},j): Output EKⱼ.
   OEnc(\vec{EK},{xᵢ}_{i∈[n]})
      1. For i∈[n],
         (a) ctᵢ←Enc(EKᵢ,xᵢ).
      2. Output CT={ctᵢ}.
OKeyStore(MSK,g):
   1. sk_{g}←KeyGen(MSK,g).
   2. Store (g,sk_{g}) in register KeyReg.
   3. Output ⊥.
ODec(MSK,b,{ctᵢ}_{i∈[n]}):
   1. For each (gⱼ,sk_{g}_{ⱼ}) stored in register KeyReg:
      (a) If (j,{ctᵢ}_{i∈[n]},y) is stored in register OutReg for some y, output y.
      (b) Else if b=0,
         i. yⱼ=Dec(sk_{g}_{ⱼ},{ctᵢ}_{i∈[n]}).
         ii. Store (j,{ctᵢ}_{i∈[n]},yⱼ) in OutReg.
      (c) Else if b=1,
         i. For i∈[n], xᵢ←Extr(MSK,ctᵢ).
         ii. rⱼ← [symbol]
         iii. yⱼ←gⱼ ({xᵢ}_{i∈[n]};rⱼ).
         iv. Store (j,{ctᵢ}_{i∈[n]},yⱼ) in OutReg.
   2. Output {yⱼ}.

Remark 3.7 (On Imposing Equivalence Relations over Ciphertexts.). The work in the literature defines randomized (single-input) functional encryption with respect to “admissible ciphertext equivalence relations.”

In more detail, in their scheme (and some prior schemes), it may be the case that Dec(sk_{ƒ},ct) Dec(sk_{ƒ},ct′) even though ct≠ct′. This could occur for example if the ciphertext ct′=(c,π) where π only serves to prove the validity of c, but does not otherwise contribute to the decryption output. Thus, if we were to generate a different proof π′ attesting to the validity of c, then we could have two different valid ciphertexts ct=(c,π) and ct′=(c,π′) that decrypt to the same value on every function key.

However, this means that their scheme would be insecure if we define security against malicious encryptors in the manner which we have done. This is because the decryption oracle ODec′ in the ideal world will output independently generated values whenever it decrypts two different ciphertexts ct and ct′. However, in the real world, the decryption of these two ciphertexts may be the same value, leading to a trivial distinguisher between the real and ideal worlds.

To handle this, previous work proposes the notion of an admissable ciphertext equivalence relation which is an efficiently checkable relation where two ciphertexts are considered equivalent if they decrypt to the same value. (In more detail, consider an equivalence relation ˜ on the ciphertext space. We say that ˜ is admissible if it is efficiently checkable and if for every two ciphertexts ct⁽⁰⁾ and ct⁽¹⁾, then ct⁽⁰⁾˜ct⁽¹⁾ if and only if for any honestly generated function key sk_{ƒ}, one of the following holds: (1) Dec(sk_{ƒ},ct⁽⁰⁾)=⊥ or Dec(sk_{ƒ},ct⁽¹⁾)±⊥, or (2) Dec(sk_{ƒ},ct⁽⁰⁾) Dec(sk_{ƒ},ct⁽¹⁾).) (This notion can also be extended to the multi-input setting by defining an equivalence relation on sets {ctᵢ}_{i∈[n]} of ciphertext queries where n is the arity of the function.) Then, in their security game, they require that the adversary does not query the decryption oracle on two different ciphertexts from the same equivalence class. This restriction allows them to prove the security of their scheme under some reasonable notion of security.

Although our definition of security is different from that in prior work, we believe that both schemes from the existing literature will be secure under our definitions if we additionally add the restriction that an adversary cannot query the decryption oracle on two different ciphertexts from the same admissable equivalence class.

We further remark that the rMIFE scheme we construct in this paper does not require this restriction or any notion of ciphertext equivalence relations and can be proven secure as per our main definitions given above.

Remark 3.8 (On SIM Security of existing constructions under our new definition.). As mentioned above, the existing rFE/rMIFE constructions from the literature, which were proven secure under the previous SIM-security definition, also achieve SIM-security under our new definition (of course with the equivalence relations restriction mentioned in 3.7). Observe that the key distinction between our new definition and the prior one lies in the handling of secret keys within the decryption oracle. In previous definitions, the decryption oracle generates a fresh secret key for the function each time a decryption is performed involving that function. In contrast, under our new definition, the secret key for the function is generated once and reused for subsequent decryptions involving that function. Importantly, the security proofs in the prior works do not rely on the generation of fresh secret keys for each decryption by the decryption oracle. As a result, their security proofs should naturally extend to our new definition without modification.

Remark 3.9 (On submitting multiple ciphertexts to the decryption oracle.). Recall that recent work extends the original SIM security definition by allowing the adversary to submit multiple ciphertexts to the decryption oracle simultaneously, rather than one at a time. As noted in that work, this modification captures security against adversarially generated correlated ciphertexts, which could potentially influence the decryption outputs.

In contrast, our definition, similar to earlier approaches, allows the adversary to submit a single ciphertext (or a single tuple of ciphertexts in the multi-input case) to the decryption oracle at a time. However, this does not make our model more restrictive compared to recent enhancements. In their model, the decryption oracle generates a fresh secret key for each randomized function every time a decryption query is made, and this key is used to decrypt the set of ciphertexts submitted along with the function. In our definition, the same secret keys are used consistently for decrypting all ciphertexts submitted over time.

Therefore, our model naturally addresses attacks involving adversarially generated correlated ciphertexts, even though we submit one ciphertext at a time to the decryption oracle.

Lemma (SIM-Security Implies IND-Security for rFE/rMIFE.).

Let rMIFE=(Setup,KeyGen,Enc,Dec) be SIM-secure as per Definition [symbol] . Then, rMIFE is IND-secure against both malicious encryptors and malicious decryptors as per Definitions [symbol] .5 and [symbol] .6, respectively.

The proof that SIM-security of rMIFE as per definition 3.3 implies IND-security against malicious decryptors (definition 3.5) is essentially the same as the one in the existing literature. Please refer to the proof of Lemma 2.9, Appendix C in prior work for details.

To show that SIM-security implies IND-security against malicious encryptors (Definition 3.6), we proceed as follows. Observe that

$${Expt}_{𝒜}^{rMIFE - Encryptors} ( {1}^{λ} )$$

with challenge bit b=0 is equivalent to

$${Expt}_{𝒜}^{rMIFE , Real} ( {1}^{λ} )$$

where the adversary issues a zero-challenge ciphertext query. Similarly,

$${Expt}_{𝒜}^{rMIFE - Encryptors} ( {1}^{λ} )$$

with challenge bit b=1 is identical to

$${Expt}_{𝒜 , 𝒮}^{rMIFE , Ideal} ( {1}^{λ} )$$

under the same zero-challenge query.

Since

$${Expt}_{𝒜}^{rMIFE , Real} ( {1}^{λ} ) and {Expt}_{𝒜 , 𝒮}^{rMIFE , Ideal} ( {1}^{λ} )$$

are computationally indistinguishable under the SIM-security guarantee, it follows that

$${Expt}_{𝒜}^{rMIFE - Encryptors} ( {1}^{λ} )$$

with b=0 and b=1 are also computationally indistinguishable. Hence, SIM-security implies IND-security against malicious encryptors.

### 4 Constructing rMIFE

In this section we present our construction of rMIFE. It is inspired by prior work, and we build upon the adaptively secure deterministic MIFE construction of Goldwasser et al.

For our construction, we utilize a subexponentially-secure indistinguishability obfuscation (i [symbol] ), a plain PKE, a puncturable PRF and injective One Way Functions (OWFs), with parameters specified in the following subsection. The definitions of these tools can be found in Section 2 of the auxiliary supporting material.

### 4.1 Parameters

PKE
   Security parameter λ.
   Ciphertexts of length s on inputs xᵢ.
i [symbol] =i [symbol] with (1, [symbol] ) weak extractability. This means for any two equivalent circuits, the security gap of the obfuscation is bounded by [symbol] (any algorithm that distinguishes obfuscations of two circuits with more than this gap will yield an algorithm that extracts a differing point).
   Security parameter [symbol] =λ.
PRF Puncturable PRF with security 2^{-c}^{_{PRF1}}^{λ}^{_{PRF1}}. This is the PRF using Kᵢ as keys.
   Security parameter λ_{PRF1}>(2ns+ [symbol] )^{(1/λ}^{_{PRF1}}⁾.
PRF Puncturable PRF with security 2^{-c}^{_{PRF2}}^{λ}^{_{PRF2}}. This is the PRF using K_{ƒ} as keys.
   Security parameter λ_{PRF2}>(2ns+ [symbol] )^{(1/λ}^{_{PRF2}}⁾.
InjOWF Injective OWF with security 2^{-c}^{_{OWF}}^{λ}^{_{OWF}}
   Security parameter λ_{lnjOWF}>(3ns+λ)^{1/c}^{_{PRF}}.
   Output length>max{(5ns+ [symbol] )^{1/c}^{_{2,OWF}}, (3ns+ [symbol] )^{1/c}^{_{PRF1}}, (3ns+ [symbol] )^{1/c}^{_{PRF2}}}

### 4.2 Construction

Now we present our main construction of rMIFE.

Construction 1. Let λ be the security parameter and n be the number of inputs. Let i [symbol] be an indistinguishability obfuscation scheme, PKE=(Setup,Enc,Dec) be a plain model PKE, PRF=(Setup,Eval,Punc) be a puncturable PRF, InjOWF be an injective OWF. We construct our rMIFE=(Setup,Enc,KeyGen,Dec) as follows:
Setup(1^{λ},n):
   1. For i∈[n],
      (a) Kᵢ←PRF.Setup(1^{A}).
      (b) For b∈{0,1},

$$( p {k}_{i}^{b} , s {k}_{i}^{b} )$$

←PKE.Setup(1^{λ}).
(c)

$${\tilde{E}}_{i} = i 𝒪 ( {1}^{λ} , {E}_{i} [ p {k}_{i}^{0} , {pk}_{i}^{1} , {K}_{i} ] ) .$$

(d)

$${EK}_{i} = ( p {k}_{i}^{0} , {pk}_{i}^{1} , {\tilde{E}}_{i} ) .$$

2.

$$MSK = {\{ s {k}_{i}^{0} , {sk}_{i}^{1} , {K}_{i} \}}_{i ∈ [ n ]} .$$

3. Output (MSK, {EKᵢ}_{i∈[n]}).

$${E}_{i} [ p {k}_{i}^{0} , {pk}_{i}^{1} , {K}_{i} ] ( {c}_{i}^{0} , {c}_{i}^{1} , {x}_{i} , {r}_{i}^{0} , {r}_{i}^{1} ) :$$

1. For b∈{0,1}, if

$${c}_{i}^{b} \neq PKE . Enc ( {pk}_{i}^{b} , {x}_{i} ; {r}_{i}^{b} ) ,$$

output ⊥.
2. Output

$${z}_{i} = PRF . Eval ( {K}_{i} ( {c}_{i}^{0} , {c}_{i}^{1} ) ) .$$

Enc(EKᵢ,xᵢ):
   1. Parse

$$E {K}_{i} = ( p {k}_{i}^{0} , {pk}_{i}^{1} , {\tilde{E}}_{i} ) .$$

2.

$${r}_{i}^{0} , {r}_{i}^{1} ← {\{ 0 , 1 \}}^{λ} .$$

3. For b∈{0,1},

$${c}_{i}^{b} = PKE . En c ( p {k}_{i}^{b} , {x}_{i} ; {r}_{i}^{b} ) .$$

4.

$${z}_{i} = {\tilde{E}}_{i} ( {c}_{i}^{0} , {c}_{i}^{1} , {x}_{i} , {r}_{i}^{0} , {r}_{i}^{1} ) .$$

5. Output

$$C {T}_{i} = ( {c}_{i}^{0} , {c}_{i}^{1} , {z}_{i} ) .$$

KeyGen(MSK,ƒ):
   1. Parse

$$MSK = ( {\{ s {k}_{i}^{0} , s {k}_{i}^{1} , {K}_{i} \}}_{i ∈ [ n ]} ) .$$

2. Sample K_{ƒ}←PRF.Setup(1^{λ}).
3.

$${\tilde{G}}_{f} ← i 𝔒 ( {1}^{λ} , G [ f , {\{ s {k}_{i}^{0} , {K}_{i} \}}_{i ∈ [ n ]} , {K}_{f} , InjOWF ] ) .$$

4. Output SK_{ƒ}=\tilde{G}_{ƒ}.

$$G [ f , {\{ s {k}_{i}^{0} , {K}_{i} \}}_{i ∈ [ n ]} , {K}_{f} , InjOWF ] ( {( {c}_{i}^{0} , {c}_{i}^{1} , {z}_{i} )}_{i ∈ [ n ]} ) :$$

1. For i∈[n],
   (a) If

$$InjOWF ( {z}_{i} ) \neq InjOWF ( PRF . Eval ( {K}_{i} , {c}_{i}^{0} , {c}_{i}^{1} ) ) ,$$

output ⊥.
(b)

$${x}_{i} = PKE . Dec ( {sk}_{i}^{0} , {c}_{i}^{0} ) .$$

2.

$${r}_{f} = PRF . Eval ( {K}_{f} , {( {c}_{i}^{0} , {c}_{i}^{1} )}_{i ∈ [ n ]} ) .$$

3. Output y=ƒ(x₁, x₂, . . . , xₙ;r_{ƒ}).
Dec(SK_{ƒ},{CTᵢ}_{i∈[n]}).
   1. Parse SK_{ƒ}=\tilde{G}_{ƒ}, and for i∈[n], parse

$$C {T}_{i} = ( {c}_{i}^{0} , {c}_{i}^{1} , {z}_{i} ) .$$

2. Output

$$y = {\tilde{G}}_{f} ( {\{ {c}_{i}^{0} , {c}_{i}^{1} , {z}_{i} \}}_{i ∈ [ n ]} ) .$$

Correctness follows from correctness of the underlying schemes.

### Toolkit and Library Implementations

Functional encryption represents a paradigm shift from traditional public-key encryption by enabling fine-grained access control over encrypted data. In conventional encryption schemes, decryption reveals the entire plaintext message. Functional encryption, however, allows authorized parties to compute specific functions on encrypted data without exposing the underlying plaintext beyond the function's output.

Multi-input functional encryption extends this concept to scenarios involving multiple data sources. In a multi-input setting, ciphertexts may be generated from different parties or data sources, and a secret key for an n-input function allows computation of ƒ(x₁, x₂, . . . , xₙ) where each xᵢ represents data encrypted by potentially different entities. This capability addresses practical scenarios such as privacy-preserving database queries across multiple organizations, joint statistical analysis, and collaborative computation on sensitive data.

Randomized functional encryption introduces probabilistic elements to the functional evaluation process. Unlike deterministic functional encryption where the same inputs always produce identical outputs, randomized functional encryption incorporates randomness into the function evaluation. For a randomized function ƒ and input x, each decryption operation may yield a sample from the output distribution ƒ(x) rather than a fixed deterministic result. This randomization serves multiple purposes including differential privacy, preventing correlation attacks, and enabling probabilistic computations on encrypted data.

The combination of multi-input capabilities with randomized functionality creates randomized multi-input functional encryption (rMIFE). In rMIFE schemes, secret keys correspond to randomized functions that operate on multiple encrypted inputs. Each decryption operation produces an independent sample from the appropriate output distribution, ensuring that repeated evaluations with the same key and ciphertexts yield statistically independent results.

Security considerations for rMIFE encompass protection against both malicious decryptors and malicious encryptors. Malicious decryptors may attempt to extract information beyond what the authorized function should reveal. Malicious encryptors may craft faulty ciphertexts designed to bias or correlate the outputs of randomized functions, potentially compromising the statistical properties that randomized encryption aims to preserve.

Traditional indistinguishability-based security definitions for functional encryption may prove insufficient for randomized schemes. The presence of randomness in function evaluation creates additional attack vectors that deterministic schemes do not face. Simulation-based security definitions provide stronger guarantees but impose limitations on the number of queries that can be supported, particularly in multi-input settings.

The disclosed system addresses these challenges through an enhanced security framework that separates protection against malicious decryptors from protection against malicious encryptors. This separation allows for more precise security analysis and enables the construction of schemes that provide robust guarantees against both types of adversaries.

Adaptive security represents another dimension of the security challenge. Many existing constructions require adversaries to declare their challenge queries in advance, limiting practical applicability. The disclosed approach supports fully adaptive adversaries who may make encryption, decryption, and corruption queries in arbitrary order throughout the security experiment.

The technical approach leverages indistinguishability obfuscation as a foundational primitive. Obfuscation allows the construction of programs that perform the same computation as the original while hiding the internal structure and secrets. In the context of rMIFE, obfuscated programs may serve as secret keys that can evaluate randomized functions on encrypted inputs while maintaining security properties.

Puncturable pseudorandom functions provide another building block for the disclosed constructions. These functions allow selective “puncturing” at specific input points, enabling security proofs that rely on the pseudorandomness of function outputs at non-punctured points while allowing arbitrary values at punctured points.

The disclosed system incorporates novel proof techniques that handle the statistical nature of randomized function outputs. Unlike deterministic schemes where functional equivalence can be established through exact equality, randomized schemes require careful analysis of statistical distance between output distributions. The security proofs accommodate scenarios where output distributions are statistically close rather than identical.

Implementation considerations include the management of randomness sources, the generation and distribution of encryption keys across multiple input slots, and the coordination of decryption operations that may involve ciphertexts from different parties. The system architecture supports scenarios where encryption keys for different input positions may be controlled by different entities while maintaining overall security properties.

The disclosed approach enables applications in privacy-aware auditing, where multiple organizations can encrypt their data and allow auditors to perform randomized sampling without revealing the underlying datasets. Joint statistical analysis becomes feasible where parties can contribute encrypted data and compute aggregate statistics without exposing individual records. Differential privacy mechanisms may be implemented through appropriate choice of randomized functions, providing formal privacy guarantees for sensitive computations.

### System Architecture

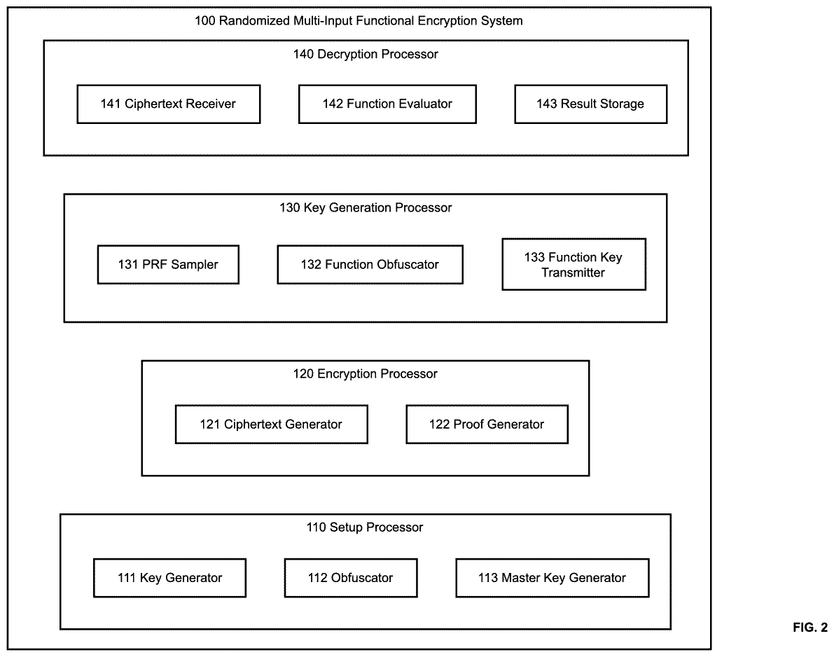

Referring to FIG. 2, an encryption system 100 implements randomized multi-input functional encryption (rMIFE) that supports multiple input sources and randomized function evaluation, extending beyond traditional single-input functional encryption schemes. The encryption system 100 may comprise four main processing components that work in coordination to provide secure multi-input functional encryption capabilities: a setup processor 110, an encryption processor 120, a key generation processor 130, and a decryption processor 140.

The setup processor 110 may be configured to initialize the encryption system 100 and establish the foundational cryptographic parameters for the randomized multi-input functional encryption scheme. The setup processor 110 may include a key generator 111, an obfuscator 112, and a master key generator 113. The key generator 111 may generate encryption keys for each input slot in the multi-input scheme, creating pairs of public keys

$$( p {k}_{i}^{0} , p {k}_{i}^{1} )$$

for each index i∈[n], where n represents the arity of the function. The obfuscator 112 may create obfuscated programs that form part of the encryption keys, while the master key generator 113 may generate a master secret key that serves as the root of trust for the entire system.

The encryption processor 120 may handle the encryption of input data and generation of cryptographic proofs. As further shown in FIG. 2, the encryption processor 120 may comprise a ciphertext generator 121 and a proof generator 122. The encryption processor 120 generates dual ciphertexts for each input slot, creating pairs of encryptions under different public keys with associated zero-knowledge proofs of consistency. The ciphertext generator 121 may encrypt each input message under both public keys in the pair

$$( p {k}_{i}^{0} , p {k}_{i}^{1} ) ,$$

producing ciphertext pairs

$$( {c}_{i}^{0} , {c}_{i}^{1} )$$

where both ciphertexts encrypt the same plaintext. The proof generator 122 may create simulation-sound non-interactive zero-knowledge (NIZK) proofs that demonstrate both ciphertexts in each pair encrypt the same message, ensuring the integrity and consistency of the dual ciphertext structure.

With continued reference to FIG. 2, the key generation processor 130 may be responsible for generating function-specific secret keys that enable authorized parties to compute randomized functions on encrypted data. The key generation processor 130 may include a PRF sampler 131, a function obfuscator 132, and a function key transmitter 133. The PRF sampler 131 may sample pseudorandom function keys that provide the randomness needed for evaluating randomized functions on the encrypted inputs. The function obfuscator 132 may generate obfuscated programs that contain the target function ƒ and the necessary cryptographic keys, creating secret keys that can decrypt and evaluate the function while maintaining security properties. The function key transmitter 133 may securely transmit the generated function keys to authorized decryption entities.

The decryption processor 140 may perform the final computation and decryption operations in the randomized multi-input functional encryption system 100. The decryption processor 140 may comprise a ciphertext receiver 141, a function evaluator 142, and a result storage 143. The ciphertext receiver 141 may accept encrypted data from multiple input sources, receiving ciphertext collections that correspond to different input slots in the multi-input scheme. The function evaluator 142 may process the received ciphertexts using the function-specific secret keys, verifying the zero-knowledge proofs, decrypting the appropriate ciphertexts from each pair, and applying the randomized function to compute the final result. The result storage 143 may store the computed results, maintaining a record of the functional evaluations performed on the encrypted data.

The system 100 may operate through coordinated interactions between these four main components. The setup processor 110 may establish the cryptographic foundation by generating the master secret key and encryption key pairs for each input slot. The encryption processor 120 may then encrypt input data using the dual ciphertext approach, creating pairs of encryptions with consistency proofs. The key generation processor 130 may derive function-specific keys from the master secret key, incorporating the randomized function and necessary cryptographic parameters into obfuscated programs. The decryption processor 140 may combine the encrypted inputs and function keys to compute randomized functional outputs while preserving the security properties of the underlying encryption scheme.

This architectural arrangement enables the system 100 to support adaptive security against both malicious decryptors and encryptors, handling an unbounded number of ciphertext queries per encryption slot while maintaining indistinguishability-based security properties. The dual ciphertext structure implemented by the encryption processor 120 provides the flexibility needed for the security proof techniques, while the obfuscated programs generated by the setup processor 110 and key generation processor 130 ensure that the functional evaluation process remains secure even when secret keys are distributed to multiple parties.

### Setup Processor Components

Referring to FIG. 2, the setup processor 110 may include several specialized components that work together to establish the foundational cryptographic infrastructure for the randomized multi-input functional encryption system 100. The setup processor 110 may comprise a key generator 111, an obfuscator 112, and a master key generator 113, each configured to perform distinct operations in the initialization phase of the encryption system 100.

The key generator 111 may be configured to generate, for each input i in [n] where n is a number of inputs, public-private key pairs

$$( p {k}_{i}^{0} , s {k}_{i}^{0} ) and ( {pk}_{i}^{1} , s {k}_{i}^{1} ) .$$

In some cases, the key generator 111 utilizes sub-exponentially secure indistinguishability obfuscation (i [symbol] ) with security parameters that depend on function arity rather than number of challenge messages. The key generator 111 may implement a dual-key approach where each input index i receives two separate public-private key pairs, providing enhanced security through redundancy and enabling the system to handle multiple encryption paths for the same input data.

The key generator 111 may also generate a component Kᵢ for use in generating a proof, wherein Kᵢ could be a pseudorandom function (PRF) key. The system may incorporate puncturable pseudorandom functions (PRFs) that can be selectively disabled at specific input points while maintaining security at all other points. In some cases, the PRF keys Kᵢ serve as foundational elements for creating cryptographic proofs that verify the integrity and authenticity of encrypted data within the multi-input functional encryption framework.

The obfuscator 112 may be configured to create an obfuscated program \tilde{E}ᵢ using

$$p {k}_{i}^{0} , p {k}_{i}^{1}$$

and Kᵢ. The obfuscated program \tilde{E}ᵢ may be configured for taking as input two different ciphertexts, verifying that the two ciphertexts are encryptions of an identical message, and outputting a proof πᵢ that the two ciphertexts are encryptions of an identical message. In some cases, the obfuscator 112 implements injective one-way functions for verification of PRF evaluations, providing additional security against extraction attacks.

The obfuscator 112 may utilize indistinguishability obfuscation techniques to create programs that are computationally indistinguishable from functionally equivalent programs while hiding the internal structure and implementation details. The obfuscated program \tilde{E}ᵢ may incorporate verification mechanisms that check the consistency of ciphertext pairs by comparing their underlying plaintexts without revealing the actual message content. In some cases, the obfuscator 112 integrates puncturable PRF functionality within the obfuscated program \tilde{E}ᵢ to enable selective disabling of specific input points while preserving security properties at all other evaluation points.

The verification process within the obfuscated program \tilde{E}ᵢ may involve applying injective one-way functions to PRF evaluations, creating a cryptographic binding between the input ciphertexts and their corresponding proofs. The injective one-way functions may provide computational hardness guarantees that prevent adversaries from extracting sensitive information even when given access to the obfuscated program \tilde{E}ᵢ. In some cases, the obfuscator 112 configures the program \tilde{E}ᵢ to output a proof πᵢ only when the verification process confirms that both input ciphertexts encrypt the same underlying message.

The key generator 111 may further generate an encryption key

$$E {K}_{i} = ( p {k}_{i}^{0} , p {k}_{i}^{1} , {\tilde{E}}_{i} )$$

for each input i. The encryption key EKᵢ may combine the dual public keys with the obfuscated verification program, creating a comprehensive cryptographic package that enables secure encryption and proof generation for each input position in the multi-input functional encryption scheme.

The master key generator 113 may be configured to generate a master secret key

$$MSK = {\{ {sk}_{i}^{0} , s {k}_{i}^{1} , {K}_{i} \}}_{i ∈ [ n ]} .$$

The master secret key MSK may aggregate all private keys and PRF keys across all input positions, providing the setup processor 110 with the cryptographic authority to derive functional keys and perform decryption operations. In some cases, the master key generator 113 organizes the master secret key MSK as a structured collection that maintains the correspondence between each input index i and its associated private key pairs and PRF key.

The master key generator 113 may implement security measures to protect the master secret key MSK during generation and storage. The master secret key MSK may serve as the root of trust for the entire randomized multi-input functional encryption system 100, enabling the derivation of function-specific keys while maintaining the confidentiality of the underlying cryptographic parameters. In some cases, the master key generator 113 coordinates with the key generator 111 and obfuscator 112 to ensure that all components of the master secret key MSK are generated using consistent security parameters and cryptographic assumptions.

The setup processor 110 may coordinate the operations of the key generator 111, obfuscator 112, and master key generator 113 to establish the complete cryptographic infrastructure for the randomized multi-input functional encryption system 100. The setup processor 110 may ensure that the security parameters for sub-exponential i [symbol] , puncturable PRFs, and injective one-way functions are properly configured across all components to maintain the overall security properties of the encryption system 100.

The setup processor 110 may generate components for each input index i∈[n], where n represents the arity of the randomized multi-input functional encryption scheme. For each input index i, the setup processor 110 may generate a pair of public keys

$$( p {k}_{i}^{0} , p {k}_{i}^{1} )$$

and corresponding private keys

$$( s {k}_{i}^{0} , s {k}_{i}^{1} )$$

using an underlying public key encryption scheme. In some cases, the setup processor 110 may implement a symmetric key configuration where

$$p {k}_{i}^{0} = s {k}_{i}^{0} and p {k}_{i}^{1} = s {k}_{i}^{1}$$

for all i∈[n], effectively using the same key material for both encryption and decryption operations.

The key generator 111 may sample a pseudorandom function key Kᵢ for each input index i using a puncturable pseudorandom function setup algorithm. The obfuscator 112 may create an obfuscated program \tilde{E}ᵢ that incorporates the public keys

$$p {k}_{i}^{0} and {pk}_{i}^{1}$$

along with the pseudorandom function key Kᵢ. This obfuscated program \tilde{E}ᵢ may serve as a verification mechanism that takes as input two ciphertexts

$$( {c}_{i}^{0} , {c}_{i}^{1} )$$

and additional parameters including a message xᵢ and randomness values

$$( {r}_{i}^{0} , {r}_{i}^{1} ) .$$

The obfuscated program \tilde{E}ᵢ may verify that the two input ciphertexts

$${c}_{i}^{0} and {c}_{i}^{1}$$

are encryptions of an identical message xᵢ by checking whether

$${c}_{i}^{0} = PKE . Enc ( p {k}_{i}^{0} , {x}_{i} ; {r}_{i}^{0} ) and$$

$${c}_{i}^{1} = PKE . Enc ( p {k}_{i}^{1} , {x}_{i} ; {r}_{i}^{1} ) ,$$

where PKE.Enc represents the encryption algorithm of the underlying public key encryption scheme. When the verification succeeds, the obfuscated program may output a proof in the form of a pseudorandom function evaluation

$${z}_{i} = PRF . Eval ( {K}_{i} , ( {c}_{i}^{0} , {c}_{i}^{1} ) ) ,$$

where PRF.Eval denotes the evaluation algorithm of the puncturable pseudorandom function.

The setup processor 110 may form an encryption key EKᵢ for each input index i by combining the public key pair and the obfuscated program. The encryption key may be structured as

$$E {K}_{i} = ( p {k}_{i}^{0} , p {k}_{i}^{1} , {\tilde{E}}_{i} ) ,$$

providing the encryption processor with the necessary components to generate well-formed ciphertexts and corresponding proofs of correctness.

The master key generator 113 may generate a master secret key MSK that encompasses the private keys for all input indices. The master secret key may be represented as

$$MSK = {\{ {sk}_{i}^{0} , s {k}_{i}^{1} \}}_{i ∈ \vert n \vert} ,$$

containing the complete set of private keys needed for decryption operations across all input slots.

The setup processor 110 may transmit at least one of the encryption keys {EKᵢ}_{i∈[n]} to at least one encryption processor. This transmission may occur through secure communication channels to maintain the confidentiality of the cryptographic components. The encryption processor may receive the encryption keys and use them to generate ciphertexts for messages intended for the corresponding input slots.

The setup processor 110 may transmit the master secret key MSK to a key generation processor. The key generation processor may receive the master secret key and use the contained private keys to construct functional keys for randomized functions. The transmission of the master secret key may occur through authenticated channels to prevent unauthorized access to the cryptographic material.

The setup processor 110 may coordinate the distribution of cryptographic components to ensure that each processor receives the appropriate keys for their designated operations. The encryption processors may receive encryption keys corresponding to their assigned input indices, while the key generation processor may receive the complete master secret key to enable the generation of functional keys for arbitrary randomized functions within the supported function class.

### Encryption Processor Operations

Referring to FIG. 2, the encryption processor 120 may be configured to handle the encryption of input data and generation of cryptographic proofs within the randomized multi-input functional encryption system 100. The encryption processor 120 may include a ciphertext generator 121 and a proof generator 122, which may work in coordination to produce secure encrypted outputs with accompanying integrity proofs.

The ciphertext generator 121 may be configured to compute multiple ciphertexts for each input xᵢ using the public keys generated during the setup phase. In some cases, for each input xᵢ, the ciphertext generator 121 may compute a ciphertext

$${c}_{i}^{0}$$

of xᵢ using

$$p {k}_{i}^{0}$$

and a ciphertext

$${c}_{i}^{1}$$

of xᵢ using

$$p {k}_{i}^{1} .$$

This dual encryption approach may provide redundancy and may enable the system to maintain security properties even when one of the encryption keys becomes compromised. The ciphertext generator 121 may utilize standard public key encryption algorithms to perform these computations, ensuring that the same plaintext xᵢ is encrypted under both public keys while maintaining cryptographic security.

The proof generator 122 may be configured to create cryptographic proofs that demonstrate the integrity and consistency of the generated ciphertexts. In some cases, the proof generator 122 may use the obfuscated program \tilde{E}ᵢ to compute a proof πᵢ that

$${c}_{i}^{0} and {c}_{i}^{1}$$

encrypt the same message. This proof generation process may incorporate simulation-sound non-interactive zero-knowledge (NIZK) proof systems to ensure ciphertext integrity and prevent malicious modifications. The simulation-sound NIZK properties may ensure that even if an adversary has access to simulated proofs, the adversary cannot generate false proofs for statements that are not true.

In some cases, the proof πᵢ may be computed as

$$P R F ( {K}_{i} , ( {c}_{i}^{0} , {c}_{i}^{1} ) ) ,$$

where Kᵢ represents a pseudorandom function key associated with the encryption index i. This computation may leverage the pseudorandom properties of the function to generate proofs that are computationally indistinguishable from random values while maintaining the necessary cryptographic properties for verification. The use of pseudorandom functions in proof generation may provide efficiency advantages over traditional NIZK constructions while maintaining the required security properties.

The encryption processor 120 may coordinate the operations of the ciphertext generator 121 and proof generator 122 to generate a final ciphertext

$$C {T}_{i} = ( {c}_{i}^{0} , {c}_{i}^{1} , {π}_{i} )$$

for each input. This composite ciphertext structure may include both encrypted versions of the input data and the accompanying proof of consistency. The encryption processor 120 may ensure that all components of the ciphertext are properly formatted and contain the necessary information for subsequent decryption and verification operations.

The randomness for computing the function ƒ may be computed as

$$P R F ( {K}_{f} , {( {c}_{i}^{0} , {c}_{i}^{1} )}_{i ∈ [ n ]} ) ,$$

where K_{ƒ} represents a function-specific pseudorandom function key and the input consists of all ciphertext pairs generated for the multi-input computation. This approach may ensure that the randomness used in functional evaluation is derived deterministically from the ciphertexts while maintaining unpredictability for adversaries who do not possess the appropriate keys.

The encryption processor 120 may implement various optimization techniques to improve the efficiency of ciphertext and proof generation. In some cases, the encryption processor 120 may utilize parallel processing capabilities to compute multiple ciphertexts simultaneously, reducing the overall computation time for multi-input scenarios. The encryption processor 120 may also implement caching mechanisms to store frequently used cryptographic parameters and intermediate computation results.

The proof generator 122 may implement additional verification steps to ensure the correctness of generated proofs before including them in the final ciphertext structure. These verification steps may include checking the consistency of the proof with the corresponding ciphertexts and validating that the proof satisfies the required cryptographic properties. The proof generator 122 may also implement error handling mechanisms to detect and respond to potential failures in the proof generation process.

The key generation processor 130 may be configured to receive the master secret key MSK from the setup processor and a randomized function ƒ from a decryption processor. The key generation processor 130 may comprise several internal components that work together to generate function keys for the randomized multi-input functional encryption system.

A PRF sampler 131 may be included within the key generation processor 130. The PRF sampler 131 may be configured to sample a PRF key K_{ƒ} used for generating randomness for evaluating the randomized functionalities ƒ on inputs x₁, . . . , xₙ. In some cases, the PRF sampler 131 generates the PRF key K_{ƒ} using a pseudorandom function setup algorithm that produces cryptographically secure keys. The PRF key K_{ƒ} may serve as a source of randomness that ensures the proper evaluation of randomized functions while maintaining security properties against malicious adversaries.

The key generation processor 130 may also include a function obfuscator 132. The function obfuscator 132 may be configured to generate an obfuscated program \tilde{G}_{ƒ} using the master secret key MSK and the PRF key K_{ƒ} received from the PRF sampler 131. The obfuscated program \tilde{G}_{ƒ} may be configured for taking as input ciphertexts

$$\{ C {T}_{i} \} = {\{ ( {c}_{i}^{0} , {c}_{i}^{1} , {π}_{i} ) \}}_{i ∈ [ n ]} ,$$

verifying the proof πᵢ for each ciphertext CTᵢ, and outputting ƒ(xᵢ, . . . , xₙ) computed using randomness generated from K_{ƒ}.

In some cases, the function obfuscator 132 creates the obfuscated program \tilde{G}_{ƒ} by implementing a circuit that first verifies the correctness of each proof πᵢ associated with the ciphertext pairs

$$( {c}_{i}^{0} , {c}_{i}^{1} ) .$$

The verification process may ensure that both ciphertexts in each pair encrypt the same underlying message. After successful verification, the obfuscated program may decrypt the ciphertexts using the appropriate secret keys embedded within the program structure.

The function obfuscator 132 may utilize the PRF key K_{ƒ} to generate randomness for the function evaluation. In some cases, the obfuscated program applies the PRF key K_{ƒ} to the collection of ciphertexts to produce deterministic randomness that may be used for evaluating the randomized function ƒ on the decrypted inputs. This approach may ensure that the same set of ciphertexts produces consistent randomness while maintaining security against malicious encryptors who might attempt to influence the randomness generation.

The obfuscated program may be obtained by an indistinguishability obfuscation scheme i [symbol] which satisfies the property that for any two equivalent circuits C₀ and C₁, the distributions i [symbol] (λ,C₀) and i [symbol] (λ,C₁) are computationally indistinguishable, where λ is a security parameter. The indistinguishability obfuscation scheme may provide security guarantees by ensuring that functionally equivalent programs produce computationally indistinguishable obfuscated versions.

A function key transmitter 133 may be included in the key generation processor 130. The function key transmitter 133 may be configured to transmit a function key \tilde{G}_{ƒ} as SK_{ƒ} to the decryption processor. In some cases, the function key transmitter 133 receives the obfuscated program \tilde{G}_{ƒ} from the function obfuscator 132 and formats the program as a function key SK_{ƒ} suitable for transmission to the decryption processor.

The function key transmitter 133 may implement secure communication protocols to ensure the function key SK_{ƒ} reaches the decryption processor without compromise. In some cases, the transmission may occur over secure channels that protect the function key from interception or modification during transit. The function key SK_{ƒ} may contain all information necessary for the decryption processor to evaluate the randomized function ƒ on encrypted inputs while maintaining the security properties of the randomized multi-input functional encryption scheme.

The key generation processor 130 may coordinate the operations of the PRF sampler 131, function obfuscator 132, and function key transmitter 133 to ensure proper function key generation. In some cases, the key generation processor 130 manages the flow of information between these components, ensuring that the PRF key K_{ƒ} generated by the PRF sampler 131 may be properly incorporated into the obfuscated program created by the function obfuscator 132, and that the resulting function key may be transmitted by the function key transmitter 133.

The system may support multiple concurrent function key generation operations, where the key generation processor 130 processes requests for different randomized functions ƒ simultaneously. In some cases, each function key generation operation may involve independent sampling of PRF keys, creation of separate obfuscated programs, and individual transmission of function keys to requesting decryption processors.

Referring to FIG. 2, a decryption processor 140 may be configured to perform decryption operations within the randomized multi-input functional encryption system 100. The decryption processor 140 may include multiple internal components that work together to process encrypted data and generate decryption results. In some cases, the decryption processor 140 may comprise a ciphertext receiver 141, a function evaluator 142, and a result storage 143.

A ciphertext receiver 141 may be configured to receive inputs from multiple sources within the encryption system 100. The ciphertext receiver 141 may receive the function key SK_{ƒ} from the key generation processor 130. In some cases, the function key SK_{ƒ} may be transmitted from the function key transmitter 133 of the key generation processor 130 to the ciphertext receiver 141. The ciphertext receiver 141 may also receive ciphertexts {CTᵢ}_{i∈[n]}, from the encryption processor 120. In some cases, the ciphertexts {CTᵢ}_{i∈[n]} may be generated by the ciphertext generator 121 and transmitted to the ciphertext receiver 141 for processing.

The ciphertext receiver 141 may be configured to handle multiple types of cryptographic data structures. In some cases, each ciphertext CTᵢ may comprise multiple components including encrypted data and associated proofs. The ciphertext receiver 141 may process these components and prepare them for evaluation by other components within the decryption processor 140.

A function evaluator 142 may be configured to calculate decryption results using the received function key ad ciphertexts. The function evaluator 142 may calculate a decryption result as SK_{ƒ}({CTᵢ}_{i∈[n]}) which is

$${\tilde{G}}_{f} ( {\{ {c}_{i}^{0} , {c}_{i}^{1} , {π}_{i} \}}_{i ∈ [ n ]} ) .$$

In some cases, the function evaluator 142 may process the obfuscated program \tilde{G}_{ƒ} using the ciphertext components

$${c}_{i}^{0} , {c}_{i}^{1} ,$$

and proofs πᵢ for each index i in the range [n].

The function evaluator 142 may perform verification operations on the received ciphertexts before computing the functional output. In some cases, the function evaluator 142 may verify the proofs πᵢ to ensure that the ciphertext pairs

$${c}_{i}^{0} and {c}_{i}^{1}$$

encrypt the same message for each encryption slot. The function evaluator 142 may also verify pseudorandom function evaluations to ensure the authenticity of the ciphertexts.

In some cases, the function evaluator 142 may decrypt the ciphertext components using secret keys embedded within the obfuscated program \tilde{G}_{ƒ}. The function evaluator 142 may extract plaintexts from the ciphertext pairs and apply the randomized function ƒ to generate the functional output. The function evaluator 142 may use pseudorandom function evaluations to generate randomness for the functional computation, ensuring that the output follows the correct distribution for the randomized function.

A result storage 143 may be configured to electronically store the decryption result generated by the function evaluator 142. The result storage 143 may maintain a persistent record of the computed functional outputs for subsequent retrieval or processing. In some cases, the result storage 143 may store the decryption results in association with identifiers that link the results to the corresponding function keys and ciphertext sets.

The result storage 143 may be configured to support unbounded query processing capabilities. In some cases, the decryption processor 140 may support an unbounded polynomial number of secret key queries and challenge ciphertext queries per encryption slot without predetermined limits. The result storage 143 may accommodate this unbounded query support by dynamically allocating storage resources as needed for new decryption operations.

The result storage 143 may implement storage mechanisms that scale with the number of queries processed by the decryption processor 140. In some cases, the result storage 143 may organize stored results using indexing structures that enable efficient retrieval of previously computed decryption results. The result storage 143 may also implement caching mechanisms to optimize performance when processing repeated queries with the same function keys and ciphertext combinations.

The decryption processor 140 may coordinate the operations of the ciphertext receiver 141, function evaluator 142, and result storage 143 to provide a complete decryption service within the randomized multi-input functional encryption system 100. In some cases, the decryption processor 140 may process multiple decryption requests concurrently, with each request involving the reception of function keys and ciphertexts, evaluation of the functional output, and storage of the results.

The decryption processor 140 may implement security measures to protect against malicious encryptors and ensure the integrity of the decryption process. In some cases, the decryption processor 140 may verify that ciphertexts conform to the expected format and contain valid proofs before processing them through the function evaluator 142. The decryption processor 140 may also implement access controls to ensure that only authorized parties can retrieve stored decryption results from the result storage 143.

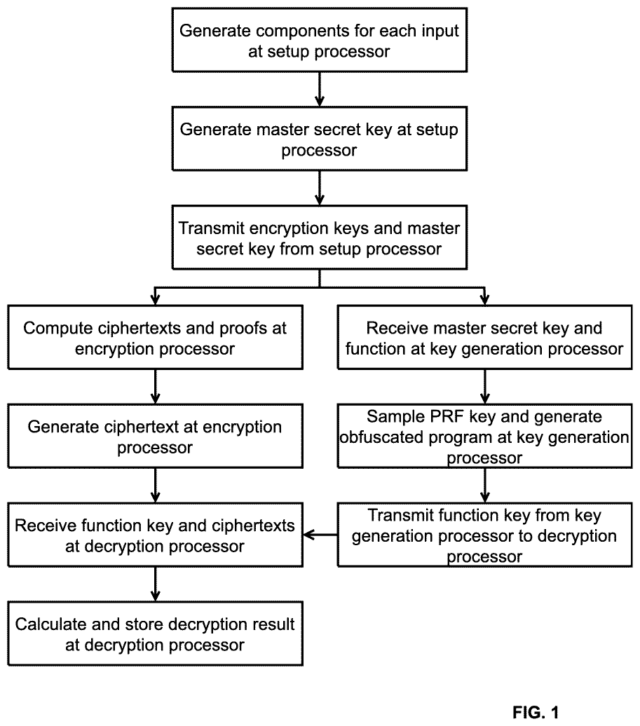

Referring to FIG. 1, the randomized multi-input functional encryption process may begin with a setup processor generating components for each input. The setup processor may generate, for each input i in [n] where n is a number of inputs, a component Kᵢ for use in generating a proof, wherein Kᵢ could be a pseudorandom function (PRF) key. The setup processor may also generate public-private key pairs

$$( p {k}_{i}^{0} , s {k}_{i}^{0} ) and ( {pk}_{i}^{1} , s {k}_{i}^{1} )$$

for each input. In some cases,

$$p {k}_{i}^{0} = s {k}_{i}^{0} and {pk}_{i}^{1} = s {k}_{i}^{1}$$

for all i∈[n].

The setup processor may further generate an obfuscated program \tilde{E}ᵢ using

$$p {k}_{i}^{0} , p {k}_{i}^{1}$$

and Kᵢ. The obfuscated program \tilde{E}ᵢ may be configured for taking as input two different ciphertexts, verifying that the two ciphertexts are encryptions of an identical message, and outputting a proof πᵢ that the two ciphertexts are encryptions of an identical message. The obfuscated program may be obtained by an indistinguishability obfuscation scheme i [symbol] which satisfies the property that for any two equivalent circuits C₀ and C₁, the distributions i [symbol] (λ,C₀) and i [symbol] (λ,C₁) are computationally indistinguishable, where λ is a security parameter.

As shown in FIG. 1, the setup processor may generate an encryption key

$$E {K}_{i} = ( p {k}_{i}^{0} , p {k}_{i}^{1} , {\tilde{E}}_{i} )$$

for each input. The setup processor may also generate a master secret key

$$MSK = {\{ s {k}_{i}^{0} , {sk}_{i}^{1} , {K}_{i} \}}_{i ∈ [ n ]} .$$

Following the generation of these components, the setup processor may transmit at least one of the encryption keys {EKᵢ}_{i∈[n]} to at least one encryption processor and may transmit the master secret key MSK to a key generation processor.

With continued reference to FIG. 1, the process may split into two parallel paths following the transmission of keys from the setup processor. On one path, the encryption processor may receive the encryption keys and may process input data. For each input xᵢ, the encryption processor may compute a ciphertext

$${c}_{i}^{0}$$

of xᵢ using

$$p {k}_{i}^{0}$$

and a ciphertext

$${c}_{i}^{1}$$

of xᵢ using

$$p {k}_{i}^{1} .$$

The encryption processor may use \tilde{E}ᵢ to compute a proof πᵢ that

$${c}_{i}^{0} and {c}_{i}^{1}$$

encrypt the same message. In some cases, the proof πᵢ may be computed as

$$P R F ( {K}_{i} , ( {c}_{i}^{0} , {c}_{i}^{1} ) ) .$$

The encryption processor may generate a ciphertext

$$C {T}_{i} = ( {c}_{i}^{0} , {c}_{i}^{1} , {π}_{i} )$$

for each input.

On the parallel path shown in FIG. 1, the key generation processor may receive the master secret key MSK from the setup processor and may receive a randomized function ƒ from a decryption processor. The key generation processor may sample a PRF key K_{ƒ} used for generating randomness for evaluating the randomized functionalities ƒ on inputs x₁, . . . , xₙ. In some cases, the randomness for computing the function ƒ may be computed as

$$P R F ( {K}_{f} , {( {c}_{i}^{0} , {c}_{i}^{1} )}_{i ∈ [ n ]} ) .$$

The key generation processor may generate an obfuscated program \tilde{G}_{ƒ} using MSK and K_{ƒ}. The obfuscated program \tilde{G}_{ƒ} may be configured for taking as input ciphertexts

$$\{ C {T}_{i} \} = \{ ( {c}_{i}^{0} , {c}_{i}^{1} , {π}_{i} ) \} ,$$

verifying the proof \tilde{G}_{ƒ} for each ciphertext CTᵢ, and outputting ƒ(xᵢ, . . . , xₙ) computed using randomness generated from K_{ƒ}. The key generation processor may transmit a function key \tilde{G}_{ƒ} as SK_{ƒ} to the decryption processor.

As further shown in FIG. 1, the two parallel paths may converge at the decryption processor. The decryption processor may receive the function key SK_{ƒ} from the key generation processor and may receive ciphertexts {CTᵢ}_{i∈[n]} from the encryption processor. The decryption processor may calculate a decryption result as SK_{ƒ}({CTᵢ}_{i∈[n]}) which is

$${\tilde{G}}_{f} ( {\{ {c}_{i}^{0} , {c}_{i}^{1} , {π}_{i} \}}_{i ∈ [ n ]} ) .$$

The decryption processor may electronically store the decryption result, completing the randomized multi-input functional encryption process.

The sequential and parallel operations shown in FIG. 1 may provide an efficient approach to randomized multi-input functional encryption. The parallel processing paths may allow the encryption processor and key generation processor to operate simultaneously, reducing overall processing time. The verification mechanisms built into the obfuscated programs may ensure the integrity of the encryption and decryption operations while maintaining the randomized nature of the functional encryption scheme.

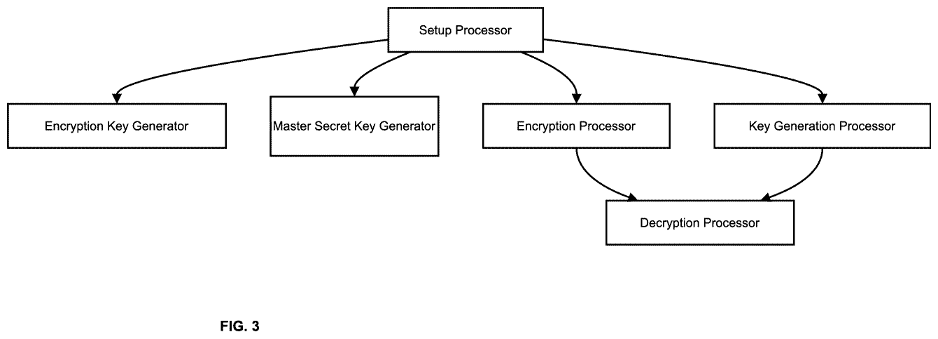

Referring to FIG. 3, a randomized multi-input functional encryption system may implement a distributed communication architecture where multiple processing components operate through secure network channels. The Setup Processor may serve as a central coordination hub that establishes secure communication pathways with an Encryption Key Generator, a Master Secret Key Generator, an Encryption Processor, and a Key Generation Processor. In some cases, the setup processor, encryption processor, key generation processor, and decryption processor are in electronic communication with each other through a secure network.

The Encryption Key Generator may receive initialization parameters from the Setup Processor through a dedicated secure channel. In some cases, the Encryption Key Generator generates public key pairs

$$( p {k}_{i}^{0} , {pk}_{i}^{1} )$$

for each encryption slot i∈[n], where n represents the arity of the multi-input functionality. The secure communication pathway may ensure that encryption keys are transmitted without exposure to unauthorized entities during the key distribution phase.

The Master Secret Key Generator may establish a separate secure communication channel with the Setup Processor to generate and distribute master secret keys. In some cases, the Master Secret Key Generator produces master secret key components that enable the generation of functional secret keys for randomized functions. The secure network communication may protect the master secret key during transmission to authorized system components.

With continued reference to FIG. 3, the system architecture may separate security against malicious decryptors and malicious encryptors into distinct indistinguishability-based experiments rather than unified security games. The Encryption Processor may receive encryption keys through a first secure communication channel that implements security measures against malicious decryptors. In some cases, this communication pathway enables the Encryption Processor to generate ciphertexts

$$( {c}_{i}^{0} , {c}_{i}^{1} )$$

for each input slot, where each ciphertext pair encrypts the same message under different public keys.

The Key Generation Processor may operate through a second distinct secure communication channel that addresses security against malicious encryptors. In some cases, the Key Generation Processor receives the master secret key from the Setup Processor and generates functional secret keys for randomized functions. The separation of communication channels may enable the implementation of different security experiments that address distinct threat models.

As further shown in FIG. 3, the Decryption Processor may receive inputs from both the Encryption Processor and the Key Generation Processor through separate secure network pathways. The communication architecture may enable the Decryption Processor to receive ciphertexts from the Encryption Processor while simultaneously obtaining functional secret keys from the Key Generation Processor. In some cases, the secure network communication ensures that ciphertexts and functional keys are transmitted without compromise during the decryption phase.

The dual-channel communication architecture may implement distinct security experiments for different adversarial models. In some cases, the first communication pathway between the Setup Processor and Encryption Processor implements an indistinguishability-based security experiment against malicious decryptors. This security model may evaluate whether an adversary can distinguish between encryptions of two different messages when provided with functional secret keys for randomized functions whose output distributions are statistically close.

The second communication pathway between the Setup Processor and Key Generation Processor may implement a separate indistinguishability-based security experiment against malicious encryptors. In some cases, this security model addresses scenarios where adversaries attempt to generate malicious ciphertexts that produce biased or correlated outputs when decrypted with functional secret keys. The separation of security experiments through distinct communication channels may enable more robust security analysis compared to unified security frameworks.

The secure network communication may utilize cryptographic protocols to protect data transmission between system components. In some cases, the network channels implement authentication mechanisms to verify the identity of communicating processors. The secure communication pathways may also employ encryption protocols to protect sensitive data such as master secret keys, functional secret keys, and ciphertexts during transmission.

The distributed architecture shown in FIG. 3 may enable scalable deployment across multiple computing environments. In some cases, the Setup Processor, Encryption Processor, Key Generation Processor, and Decryption Processor operate on separate computing systems connected through secure network infrastructure. The secure network communication may support both local area network deployments and wide area network configurations while maintaining security properties.

The communication architecture may implement message queuing mechanisms to handle asynchronous communication between processors. In some cases, the secure network channels buffer messages between system components to accommodate varying processing speeds and network latencies. The message queuing system may ensure reliable delivery of encryption keys, ciphertexts, and functional secret keys even in the presence of temporary network disruptions.

### Computing Infrastructure

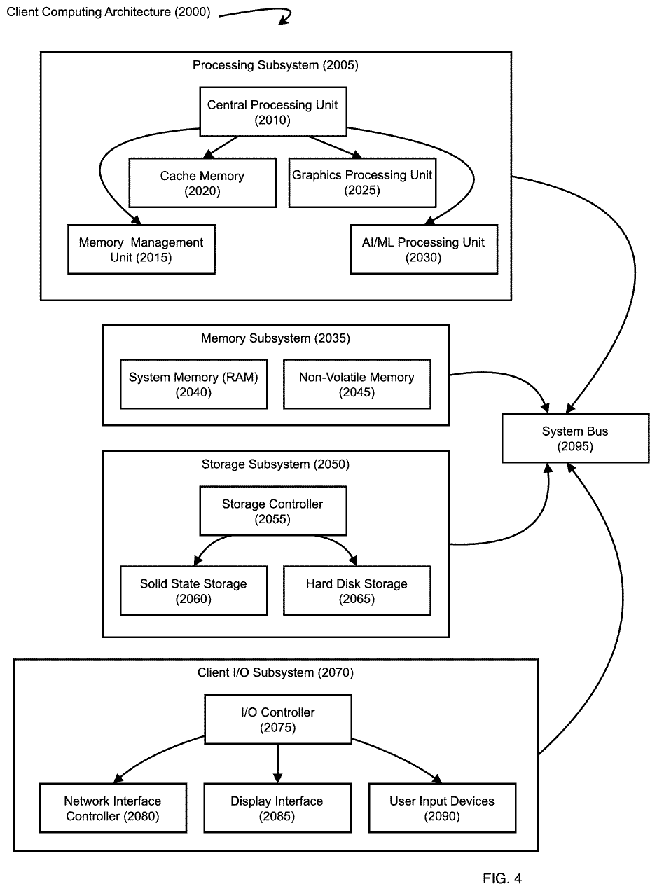

Referring to FIG. 4, a client computing architecture 2000 provides the hardware foundation for implementing the randomized multi-input functional encryption operations described herein. The client computing architecture 2000 may comprise multiple interconnected subsystems that work together to execute the cryptographic computations and data processing tasks associated with the encryption system.

The client computing architecture 2000 may include a processing subsystem 2005 that handles computational operations for the encryption and decryption processes. A central processing unit 2010 within the processing subsystem 2005 may perform general-purpose computational tasks and coordinate the operation of other processing components throughout the system. The central processing unit 2010 may execute instructions for implementing the setup algorithms, encryption procedures, key generation processes, and decryption operations described in the randomized multi-input functional encryption scheme.

A memory management unit 2015 may manage memory access operations and virtual memory functions within the processing subsystem 2005. The memory management unit 2015 may coordinate data transfers between different memory locations and manage address translation for the various cryptographic operations. In some cases, the memory management unit 2015 handles the secure allocation and deallocation of memory regions used for storing sensitive cryptographic materials such as master secret keys, function keys, and intermediate computation results.

A cache memory 2020 may provide high-speed temporary storage for frequently accessed data and instructions within the processing subsystem 2005. The cache memory 2020 may store commonly used cryptographic parameters, pseudorandom function outputs, and intermediate results from obfuscation operations to improve processing efficiency. In some cases, the cache memory 2020 maintains copies of encryption keys and function parameters that are repeatedly accessed during multiple encryption or decryption operations.

A graphics processing unit 2025 may handle parallel processing operations that are particularly suited for certain cryptographic computations. The graphics processing unit 2025 may accelerate mathematical operations involved in the functional encryption scheme, such as matrix computations, polynomial evaluations, and parallel pseudorandom function evaluations across multiple input values. In some cases, the graphics processing unit 2025 processes multiple ciphertext pairs simultaneously during the decryption phase of the multi-input functional encryption protocol.

An AI/ML processing unit 2030 may perform specialized computations for artificial intelligence and machine learning workloads that may be integrated with the functional encryption system. The AI/ML processing unit 2030 may execute machine learning algorithms on encrypted data using the functional encryption capabilities, enabling privacy-preserving computation on sensitive datasets. In some cases, the AI/ML processing unit 2030 processes randomized functions that implement differential privacy mechanisms or other privacy-enhancing techniques within the encrypted domain.

The client computing architecture 2000 may include a memory subsystem 2035 that provides data storage capabilities for the encryption operations. A system memory 2040 within the memory subsystem 2035 may provide volatile random access memory for active program execution and data processing. The system memory 2040 may store the master public key, encryption keys for multiple input slots, function keys, and ciphertexts during active encryption and decryption operations. In some cases, the system memory 2040 maintains working copies of obfuscated programs and pseudorandom function keys that are currently being used for cryptographic computations.

A non-volatile memory 2045 may retain data without power and store persistent information related to the encryption system. The non-volatile memory 2045 may store long-term cryptographic parameters, system configuration data, and persistent copies of encryption keys that need to be maintained across system restarts. In some cases, the non-volatile memory 2045 contains firmware or microcode that implements low-level cryptographic primitives used by the functional encryption scheme.

A storage subsystem 2050 may provide long-term data storage capabilities for the encryption system. A storage controller 2055 within the storage subsystem 2050 may manage data transfer between storage devices and other system components. The storage controller 2055 may coordinate the reading and writing of encrypted data, ciphertext collections, and cryptographic key material to and from the storage devices. In some cases, the storage controller 2055 implements hardware-based encryption and decryption operations to protect data stored on the storage devices.

A solid state storage 2060 may provide fast, non-volatile data storage using semiconductor technology. The solid state storage 2060 may store encrypted databases, collections of ciphertexts, and archived cryptographic keys with rapid access times suitable for real-time encryption and decryption operations. In some cases, the solid state storage 2060 maintains indexed collections of ciphertext pairs organized by input slot and encryption timestamp to facilitate efficient retrieval during multi-input functional encryption operations.

A hard disk storage 2065 may offer high-capacity magnetic storage for long-term data retention. The hard disk storage 2065 may store large volumes of encrypted data, historical cryptographic logs, and backup copies of encryption keys and system parameters. In some cases, the hard disk storage 2065 maintains archived audit trails of encryption and decryption operations for compliance and security monitoring purposes.

The client computing architecture 2000 may include a client I/O subsystem 2070 that manages input and output operations for the encryption system. An I/O controller 2075 within the client I/O subsystem 2070 may coordinate input and output operations across various peripheral devices connected to the system. The I/O controller 2075 may manage the flow of plaintext data into the encryption system and the delivery of decrypted results to authorized recipients. In some cases, the I/O controller 2075 implements access control mechanisms that verify user authorization before allowing access to encryption or decryption capabilities.

A network interface controller 2080 may enable network communication and data exchange with external systems. The network interface controller 2080 may facilitate the transmission of encrypted ciphertexts between different parties in a multi-party computation scenario, and may handle the secure distribution of function keys to authorized decryptors. In some cases, the network interface controller 2080 implements secure communication protocols that protect the confidentiality and integrity of cryptographic material during transmission over untrusted networks.

A display interface 2085 may manage the connection and data transmission to display devices used for system monitoring and user interaction. The display interface 2085 may present user interfaces for configuring encryption parameters, monitoring system status, and displaying decryption results to authorized users. In some cases, the display interface 2085 implements security measures to prevent unauthorized viewing of sensitive cryptographic information displayed on connected monitors or screens.

User input devices 2090 may receive user commands and interactions for controlling the encryption system. The user input devices 2090 may include keyboards, pointing devices, biometric sensors, and other input mechanisms that allow users to specify encryption parameters, select functions for key generation, and initiate encryption or decryption operations. In some cases, the user input devices 2090 implement multi-factor authentication mechanisms that verify user identity before granting access to sensitive cryptographic operations.

A system bus 2095 may provide communication pathways connecting the processing subsystem 2005, memory subsystem 2035, storage subsystem 2050, and client I/O subsystem 2070. Data, control signals, and addresses may flow through the system bus 2095 to enable coordinated operation of all system components during encryption and decryption operations. The system bus 2095 may carry encrypted data between the various subsystems, transport cryptographic keys from storage to processing components, and facilitate the movement of computation results between different processing units. In some cases, the system bus 2095 implements hardware-based security measures such as bus encryption or access control mechanisms to protect sensitive data during inter-component communication.

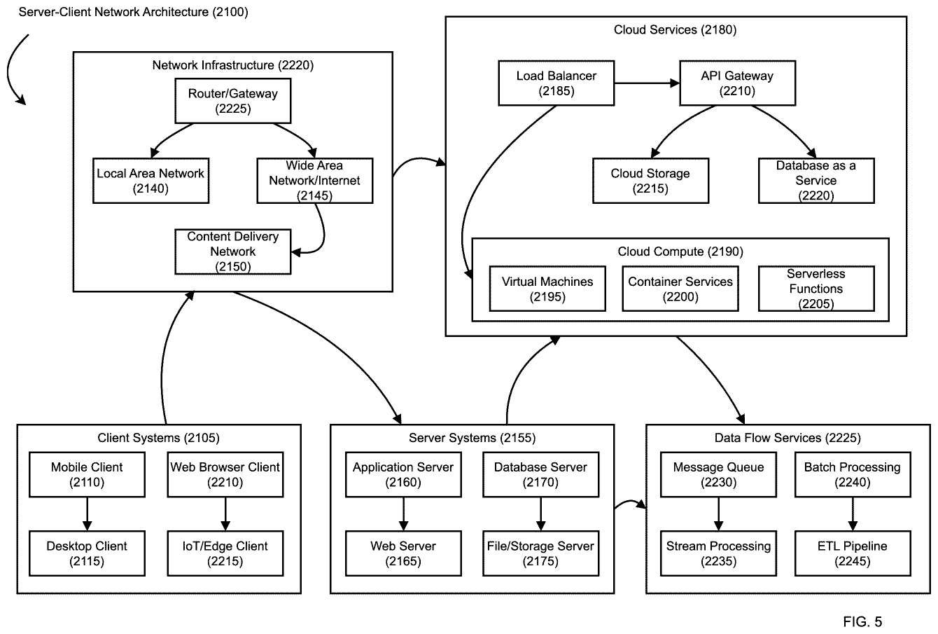

Referring to FIG. 5, a server-client network architecture 2100 may be implemented to support the randomized multi-input functional encryption system across distributed computing environments. The server-client network architecture 2100 may provide a scalable infrastructure for deploying the encryption system 100 across multiple computing nodes and network segments.

The server-client network architecture 2100 may include client systems 2105 that serve as endpoints for accessing the randomized multi-input functional encryption services. The client systems 2105 may comprise a mobile client 2110 and a desktop client 2115. The mobile client 2110 may execute encryption and decryption operations on mobile computing devices, enabling portable access to the functional encryption capabilities. The desktop client 2115 may provide enhanced computational resources for processing complex multi-input functional encryption operations that may require additional processing power or memory capacity.

The network infrastructure may facilitate communication between the various components of the server-client network architecture 2100. A local area network 2140 may connect client systems 2105 within a localized network segment, providing high-bandwidth, low-latency communication for encryption operations. A wide area network 2145 may extend connectivity across geographically distributed locations, enabling remote access to the functional encryption services. A content delivery network 2150 may optimize the distribution of encryption keys, ciphertexts, and other cryptographic materials by caching frequently accessed data at edge locations closer to the client systems 2105.

As further shown in FIG. 5, server systems 2155 may provide backend computational resources for the randomized multi-input functional encryption operations. The server systems 2155 may include an application server 2160 that hosts the core functional encryption algorithms and manages the execution of encryption, key generation, and decryption processes. A web server 2165 may provide web-based interfaces for accessing the functional encryption services through standard HTTP protocols. A database server 2170 may store encrypted data, function keys, and cryptographic parameters in a secure and organized manner. A file storage server 2175 may manage the storage and retrieval of large encrypted datasets and associated cryptographic proofs.

The server-client network architecture 2100 may incorporate cloud services 2180 to provide scalable and flexible deployment options for the functional encryption system. A load balancer 2185 may distribute incoming encryption and decryption requests across multiple server instances to maintain optimal performance and availability. Cloud compute 2190 may provide on-demand computational resources for processing intensive cryptographic operations. The cloud compute 2190 may include virtual machines 2195 that offer isolated computing environments for executing the setup processor 110, encryption processor 120, key generation processor 130, and decryption processor 140 components. Container services 2200 may enable lightweight deployment of the functional encryption components using containerization technologies. Serverless functions 2205 may execute specific cryptographic operations in response to events or requests without maintaining persistent server instances.

With continued reference to FIG. 5, an api gateway 2210 may manage access to the functional encryption services by providing authentication, authorization, and request routing capabilities. The api gateway 2210 may enforce security policies and rate limiting to protect the cryptographic operations from unauthorized access or abuse. Cloud storage 2215 may provide scalable storage solutions for encrypted data, cryptographic keys, and system metadata. Database as a service 2220 may offer managed database solutions for storing and querying encrypted datasets while maintaining the security properties of the functional encryption scheme.

The server-client network architecture 2100 may include data flow services 2225 that manage the processing and transformation of encrypted data streams. A message queue 2230 may facilitate asynchronous communication between the various components of the functional encryption system, enabling reliable delivery of encryption requests, key distribution messages, and decryption results. Stream processing 2235 may handle real-time processing of encrypted data streams, allowing for continuous evaluation of randomized functions on incoming encrypted inputs. Batch processing 2240 may manage large-scale cryptographic operations that process multiple encrypted datasets simultaneously, optimizing resource utilization for bulk encryption and decryption tasks. An etl pipeline 2245 may extract, transform, and load encrypted data between different storage systems while preserving the cryptographic properties and ensuring data integrity throughout the process.

The distributed nature of the server-client network architecture 2100 may enable the randomized multi-input functional encryption system to scale across multiple geographic regions and computing environments. The architecture may support both synchronous and asynchronous cryptographic operations, allowing client systems 2105 to submit encryption requests and receive results through various communication patterns. The cloud services 2180 may provide automatic scaling capabilities that adjust computational resources based on the volume of encryption and decryption requests, ensuring consistent performance under varying workloads.

The data flow services 2225 may coordinate the movement of encrypted data and cryptographic keys throughout the distributed system while maintaining the security guarantees of the randomized multi-input functional encryption scheme. The message queue 2230 may ensure reliable delivery of cryptographic operations even in the presence of network failures or temporary service unavailability. The stream processing 2235 and batch processing 2240 components may optimize the execution of functional encryption operations by grouping related requests and leveraging parallel processing capabilities across the distributed infrastructure.

### Multi-Entity Encryption Scenarios

The randomized multi-input functional encryption system may be configured to operate across multiple entities in distributed computing environments. In such scenarios, a setup processor may generate and transmit multiple sets of encryption keys {EKᵢ}_{i∈[n]} to multiple encryption entities, where each encryption entity operates independently to encrypt different input data.

The setup processor may distribute encryption keys to various encryption entities based on predetermined allocation schemes. Each set of encryption keys {EKᵢ}_{i∈[n]} corresponds to a specific input slot in the multi-input functional encryption scheme, where n represents the arity of the function being evaluated. The encryption keys may include pairs of public keys

$$( p {k}_{i}^{0} , {pk}_{i}^{1} )$$

from an underlying public key encryption scheme, along with obfuscated programs that generate proof values for ciphertext verification.

Each encryption processor at different entities may generate ciphertexts for different inputs using the received encryption keys. The encryption process involves creating dual ciphertexts that encrypt the same message under both public keys in the key pair. For a message x_{j,i} at encryption slot i, an encryption processor may generate ciphertexts

$${c}_{j , i}^{0} = PKE . Enc ( p {k}_{i}^{0} , {x}_{j , i} ; {r}_{j , i}^{0} ) and {c}_{j , i}^{1} = PKE . Enc ( p {k}_{i}^{1} , {x}_{j , i} ; {r}_{j , i}^{1} )$$

using random values

$${r}_{j , i}^{0} and {r}_{j , i}^{1} .$$

The encryption processor may also generate proof values z_{j,i} using the obfuscated programs received from the setup processor. These proof values serve to verify the well-formedness of the ciphertext pairs and prevent malicious encryptors from generating invalid ciphertexts that could compromise the security of the functional evaluation. The complete ciphertext for slot i may be represented as

$$C {T}_{j , i} = ( {c}_{j , i}^{0} , {c}_{j , i}^{1} , {z}_{j , i} ) .$$

In multi-entity scenarios, the key generation processor may generate multiple function keys SK_{ƒ} for different functions ƒ. Each function key corresponds to a specific randomized function that can be evaluated on the encrypted inputs. The key generation process involves sampling pseudorandom function keys K_{ƒ} and creating obfuscated programs that implement the function evaluation logic while maintaining security against both malicious decryptors and encryptors.

The key generation processor may transmit the generated function keys to one or more decryption entities. The distribution of function keys may follow access control policies that determine which decryption entities are authorized to evaluate specific functions on the encrypted data. The transmission process may include secure communication protocols to protect the function keys during transit.

The encryption system may include a key store oracle that maintains persistent secret keys for functions across multiple decryption operations. This key store oracle prevents fresh key generation attacks by ensuring that the same function key is used consistently when the same function is evaluated multiple times. The key store oracle may maintain a register KeyStore that stores pairs (gₖ,sk_{gk}) where gₖ represents a function and sk_{gk} represents the corresponding secret key.

When a decryption entity requests evaluation of a function that has been previously stored, the key store oracle may retrieve the existing secret key rather than generating a new one. This persistent storage mechanism ensures that repeated evaluations of the same function on the same or different ciphertexts produce appropriately correlated results, preventing adversaries from exploiting key freshness to compromise the security of the system.

The key store oracle may implement lazy key generation, where function keys are generated only when first requested and then stored for subsequent use. This approach optimizes computational resources while maintaining the security properties required for protection against malicious encryptors. The stored keys may be associated with unique identifiers that allow the system to efficiently retrieve the appropriate key for each function evaluation request.

In distributed scenarios involving multiple decryption entities, the key store oracle may coordinate key distribution to ensure that all authorized entities receive the same function keys for consistent evaluation results. The oracle may implement synchronization mechanisms to maintain consistency across distributed key stores and prevent race conditions that could lead to different entities using different keys for the same function.

The multi-entity architecture may support concurrent operations where multiple encryption processors generate ciphertexts simultaneously while multiple decryption entities evaluate different functions on the encrypted data. The system may implement load balancing mechanisms to distribute computational workload across available processing resources while maintaining the security and correctness properties of the randomized multi-input functional encryption scheme.

The randomized multi-input functional encryption system may provide adaptive security against both malicious decryptors and malicious encryptors through a comprehensive security model that addresses multiple threat scenarios. In some cases, the security framework operates without requiring adversaries to pre-declare challenge messages, allowing queries to be made in arbitrary order throughout the security experiment.

The adaptive security model may incorporate two distinct indistinguishability-based security experiments that separately address malicious decryptors and malicious encryptors. In some cases, the first security experiment focuses on malicious decryptors by extending traditional indistinguishability security frameworks for deterministic functional encryption to randomized functionalities. The adversary may receive a master public key during setup and adaptively request secret keys for randomized functions within a specified function space. When the adversary submits two challenge messages x₀ and x₁, the challenger may select a random bit b←{0,1} and encrypt x_{b} to generate a challenge ciphertext. The adversary may continue requesting additional secret keys after receiving the challenge ciphertext and attempts to determine the value of b.

The security model may impose an admissibility condition requiring that for any queried function ƒ and challenge messages x₀, x₁, the output distributions ƒ(x₀) and ƒ(xᵢ) are computationally indistinguishable. In some cases, this condition ensures that the adversary cannot distinguish between encryptions of the two challenge messages based solely on the functional outputs.

The second security experiment may address malicious encryptors through a more sophisticated approach that models adversaries attempting to influence functional outputs by generating faulty ciphertexts. The challenger may provide the adversary with access to multiple oracle types, including secret key queries, secret key store queries, and decryption queries. In some cases, the secret key store queries allow the adversary to request that the challenger store secret keys for specified randomized functions in a register KeyReg.

The decryption oracle may operate in two distinct modes based on a random bit b. When b=0, the oracle may decrypt submitted ciphertexts using stored keys in KeyReg. When b=1, the oracle may extract the plaintext using the master secret key, apply stored functions to the plaintext, and return independently sampled random outputs from the resulting distributions. In some cases, the oracle stores these outputs along with the queried ciphertext in an output register OutReg to ensure consistency for repeated queries of the same ciphertext.

The indistinguishability obfuscation scheme may provide computational indistinguishability between obfuscated versions of functionally equivalent circuits. In some cases, for any two circuits C₀ and C₁ that compute the same function, the distributions of their obfuscated versions i [symbol] (λ,C₀) and i [symbol] (λ,C₁) are computationally indistinguishable, where λ represents the security parameter. The obfuscation process may transform circuits into functionally equivalent but unintelligible forms that preserve computational behavior while hiding internal structure.

The system may utilize sub-exponentially secure indistinguishability obfuscation to achieve adaptive security with unbounded message support. In some cases, the security level varies based on the function arity but remains independent of the number of challenge messages. The obfuscation scheme may satisfy (1, [symbol] ) weak extractability, where n represents the function arity, s denotes ciphertext length, and [symbol] represents the obfuscation security parameter.

The proof generation process may incorporate simulation-sound non-interactive zero-knowledge proof systems to ensure ciphertext well-formedness. In some cases, the proof system generates proofs π that attest to the consistency of ciphertext components, verifying that multiple ciphertext elements encrypt the same underlying message. The proof computation may utilize a common reference string crs generated during system setup.

The randomness computation for function evaluation may employ puncturable pseudorandom functions to generate deterministic yet unpredictable randomness values. In some cases, the system samples a puncturable PRF key K_{ƒ} during secret key generation and evaluates the PRF on the input ciphertext tuple to produce randomness

$${r}_{f} = PRF . Eval ( {K}_{f} , {( {c}_{i}^{0} , {c}_{i}^{1} )}_{i ∈ [ n ]} ) .$$

The puncturable property may allow the PRF key to be modified to exclude specific input points maintaining pseudorandomness for all other inputs.

The security proof may utilize a sequence of hybrid arguments that transition between different computational modes. In some cases, the proof introduces exponentially many sub-hybrids indexed by all possible ciphertext vectors that could be input to decryption functions. The hybrid transitions may rely on the security of underlying cryptographic primitives, including the indistinguishability obfuscation scheme, puncturable pseudorandom functions, and public key encryption systems.

The adaptive adversary model may allow adversaries to make function queries, encryption key queries, and challenge message queries in arbitrary order without advance declaration. In some cases, the security reduction handles this adaptivity by deterministically traversing all possible ciphertexts during the proof construction, eliminating the need to predict adversarial query patterns during hardwiring stages.

The system may achieve security against malicious encryptors by ensuring that decryption results approximate independent random samples from intended function output distributions. In some cases, the security model prevents adversaries from crafting ciphertexts that produce biased or correlated outputs when decrypted with the same secret key across multiple queries. The indistinguishability between real and ideal decryption modes may guarantee that adversarial influence on decryption outcomes remains negligible.

The randomized multi-input functional encryption system may implement sub-exponential statistical distance requirements between function output distributions, providing enhanced security guarantees beyond conventional negligible bounds. In some cases, the system may require that the statistical distance between output distributions ƒ(x₀) and ƒ(x₁) for queried functions ƒ and challenge messages x₀, x₁ be sub-exponentially small rather than merely negligibly small. This sub-exponential requirement may strengthen the indistinguishability-based security definition by ensuring that adversaries cannot distinguish between encryptions of different messages even with enhanced computational resources.

The processing subsystem may evaluate statistical distance using the formula

$$Δ ( {D}_{0} , {D}_{1} ) = \frac{1}{2} {\sum }_{y} \vert Pr [ {D}_{0} = y ] - P r [ {D}_{1} = y ] \vert ,$$

where D₀ and D₁ represent the output distributions of a randomized function applied to different inputs. In some cases, the system may enforce that this statistical distance be bounded by 2^{-λ}^{^{e}} for some constant c>0 and security parameter λ, rather than the standard negligible bound of 2^{-ω(log λ)}. The sub-exponential bound may provide stronger security guarantees by limiting the advantage of computationally bounded adversaries operating within sub-exponential time.

The system may implement hybrid proof techniques that utilize exponentially many intermediate steps while maintaining polynomial-time security reductions through sub-exponential security assumptions. In some cases, the security proof may traverse through 2^{2ns} hybrid experiments, where n represents the arity of the function and s denotes the ciphertext length. Each hybrid experiment may correspond to a specific configuration of the obfuscated programs used in the secret key generation process.

The hybrid proof structure may begin with a hybrid where challenge ciphertexts encrypt messages xᵢ⁰ for each input index i∈[n]. The proof may then transition through intermediate hybrids indexed by values w∈[2^{2sm}], where each hybrid modifies the behavior of the obfuscated secret key programs. In some cases, the secret key program may decrypt the first ciphertext in each pair using secret key

$$s {k}_{i}^{0}$$

when the ciphertext tuple

$$( {c}_{1}^{0} , {c}_{1}^{1} , … , {c}_{n}^{0} , {c}_{n}^{1} ) < w ,$$

and may decrypt the second ciphertext using secret key

$$s {k}_{i}^{1}$$

otherwise.

The processing subsystem may implement puncturable pseudorandom functions to enable the hybrid transitions while maintaining security. In some cases, the system may puncture the pseudorandom function key Kᵢ at specific points

$$( {d}_{i}^{0} , {d}_{i}^{1} )$$

corresponding to challenge ciphertext pairs. The punctured key

$${K}_{i} [ {d}_{i}^{0} , {d}_{i}^{1} ]$$

may allow evaluation at all points except the punctured point, enabling the security reduction to replace pseudorandom values with truly random values at specific locations.

The hybrid proof may incorporate injective one-way functions to prevent adversaries from extracting differing inputs between adjacent hybrids. In some cases, the obfuscated program may verify pseudorandom function evaluations by applying an injective one-way function InjOWF to the pseudorandom output and comparing the result to a hardcoded value. The security reduction may rely on the assumption that inverting the injective one-way function is computationally infeasible, even for adversaries operating in sub-exponential time.

The system may handle the exponential number of hybrids by leveraging sub-exponential security assumptions for the underlying cryptographic primitives. In some cases, the indistinguishability obfuscator may satisfy (1,2^{-3ns-λ}) weak extractability, where the advantage of any polynomial-time adversary in distinguishing between obfuscations of functionally equivalent programs is bounded by 2^{-3ns-λ}. The sub-exponential security parameter may be chosen such that λ≥(3ns)^{1/c} for the desired security level.

The puncturable pseudorandom function may provide security 2^{-c}^{_{PRF}}^{λ}^{_{PRF}} with parameter λ_{PRF}≥(2ns+λ)^{i/c}^{_{PRF}}. In some cases, the security reduction may make polynomially many switches between pseudorandom and random values, with each switch contributing at most 2^{-2ns-/λ} to the distinguishing advantage. The cumulative advantage across all hybrids may remain negligible due to the sub-exponential security assumptions.

The processing subsystem may implement the hybrid argument by showing that adjacent hybrids

$${Hybrid}_{2 , w , i}^{A} and {Hybrid}_{2 , w , i + 1}^{A}$$

are indistinguishable for each step i in the transition sequence. In some cases, the system may puncture pseudorandom function keys, modify obfuscated programs to use punctured keys, replace pseudorandom values with random values, and then reverse the puncturing process. Each step may rely on the security of the underlying cryptographic primitives, with the sub-exponential security assumptions ensuring that the cumulative distinguishing advantage remains negligible.

The system may handle the case where functional outputs do not match exactly by leveraging the sub-exponential statistical distance requirement. In some cases, when the output distributions

$$f ( {x}_{1}^{0} , … , {x}_{n}^{0} ) and f ( {x}_{1}^{1} , … , {x}_{n}^{1} )$$

are statistically close with sub-exponential distance, the hybrid proof may still proceed by carefully analyzing the probability that an adversary can distinguish between the two cases. The sub-exponential bound on statistical distance may ensure that the probability of distinguishing remains sub-exponentially small, allowing the security reduction to succeed.

The processing subsystem may implement adaptive security by deterministically traversing all possible ciphertext vectors during the hybrid proof. In some cases, the security reduction may not need to know in advance which challenge ciphertexts the adversary will query, as the hybrid argument covers all possible ciphertext combinations. This approach may enable the system to support adaptive adversaries who can choose challenge messages after seeing the public parameters and making preliminary queries.

The system may maintain polynomial-time security reductions despite the exponential number of hybrids by ensuring that each individual hybrid transition can be reduced to the security of the underlying primitives in polynomial time. In some cases, the reduction algorithm may simulate the hybrid experiment by generating the appropriate obfuscated programs and responding to adversary queries without explicitly enumerating all exponentially many hybrids. The sub-exponential security assumptions may provide sufficient security margin to handle the exponential number of potential adversary strategies while maintaining polynomial-time reductions.

The encryption system 100 operates through coordinated interactions between the setup processor 110, encryption processor 120, key generation processor 130, and decryption processor 140 to achieve secure randomized multi-input functional encryption. The system may implement an adaptively secure randomized multi-input functional encryption (rMIFE) scheme that provides security against both malicious decryptors and malicious encryptors through novel indistinguishability-based security definitions.

During the initial setup phase, the setup processor 110 may coordinate the generation of cryptographic parameters for the multi-input system. For each input index i∈[n], where n represents the arity of the function, the setup processor 110 may generate pairs of public keys

$$( p {k}_{i}^{0} , {pk}_{i}^{1} )$$

) from an underlying public key encryption scheme. The setup processor 110 may also initialize pseudorandom function keys Kᵢ for each input position and create obfuscated programs \tilde{E}ᵢ that handle ciphertext validation and proof generation.

The encryption processor 120 may receive plaintext messages and generate ciphertexts that maintain security properties against malicious encryptors. For a message x_{j,i} intended for input position i in ciphertext j, the encryption processor 120 may generate two ciphertexts:

$${c}_{j , i}^{0} = PKE . Enc ( p {k}_{i}^{0} , {x}_{j , i} ; {r}_{j , i}^{0} ) and {c}_{j , i}^{1} = PKE . Enc ( p {k}_{i}^{1} , {x}_{j , i} ; {r}_{j , i}^{1} )$$

using independent randomness values. The encryption processor 120 may also compute a proof value

$${z}_{j , i} = PRF . Eval ( {K}_{i} , ( {c}_{j , i}^{0} , {c}_{j , i}^{1} ) )$$

that demonstrates the well-formedness of the ciphertext pair.

The key generation process 130 may create function-specific secret keys that enable secure evaluation of randomized functions on encrypted data. When receiving a function ƒ, the key generation processor 130 may sample a pseudorandom function key K_{ƒ} and generate an obfuscated program \tilde{G}_{ƒ} that contains the function ƒ, decryption keys for both ciphertext types, and the pseudorandom function key. The obfuscated program may verify the correctness of proof values using an injective one-way function InjOWF to prevent malicious ciphertexts from influencing the decryption process.

The decryption processor 140 may execute the secure function evaluation by processing collections of ciphertexts using the function-specific secret keys. Upon receiving ciphertexts

$${\{ ( {c}_{j , i}^{0} , {c}_{j , i}^{1} , {z}_{j , i} ) \}}_{i ∈ [ n ]}$$

and a secret key SK_{ƒ}=Ĝ_{ƒ}, the decryption processor 140 may first verify the proof values by checking that

$$InjOWF ( {z}_{j , i} ) = InjOWF ( PRF \cdot Eval ( {K}_{i} , ( {c}_{j , i}^{0} , {c}_{j , i}^{1} ) ) )$$

for each input position. The decryption processor 140 may then decrypt the appropriate ciphertext from each pair based on a predetermined switching pattern and evaluate the pseudorandom function

$$PRF \cdot Eval ( {K}_{f} , ( {c}_{j , 1}^{0} , {c}_{j , 1}^{1} , … , {c}_{j , n}^{0} , {c}_{j , n}^{1} ) )$$

to generate randomness for the function evaluation.

The system may implement security against malicious decryptors through a sequence of hybrid arguments that transition between decrypting the first and second ciphertext in each pair. The security proof may utilize sub-exponentially secure indistinguishability obfuscation and puncturable pseudorandom functions to ensure that no polynomial-time adversary can distinguish between encryptions of different message vectors when the output distributions of queried functions are statistically close.

Security against malicious encryptors may be achieved through a dual-mode decryption oracle that operates in two indistinguishable modes. In the first mode, the decryption processor 140 may decrypt submitted ciphertexts using stored secret keys. In the second mode, the decryption processor 140 may extract plaintexts using the master secret key and return independently sampled random outputs from the function distributions applied to those plaintexts. The indistinguishability between these modes may ensure that adversaries cannot craft ciphertexts to produce biased or correlated outputs.

The system may support adaptive security by handling an unbounded polynomial number of secret key queries and challenge ciphertext queries per encryption slot. The security proof may traverse exponentially many hybrid experiments indexed by all possible ciphertext vectors, but the sub-exponential security parameters may ensure that the cumulative distinguishing advantage remains negligible. The system may require that the statistical distance between output distributions of queried functions on queried input sets be sub-exponentially small to maintain security guarantees.

The mathematical foundation of the system may rely on the hardness of inverting injective one-way functions and the security of puncturable pseudorandom functions. When the obfuscated programs check proof correctness by applying the injective one-way function to pseudorandom function outputs, extracting a differing input may correspond to inverting the one-way function on a random point. The puncturing of pseudorandom function keys at specific ciphertext pairs may enable the security reduction to replace pseudorandom outputs with truly random values without detection by polynomial-time adversaries.

The data flow through the system may maintain consistency through careful coordination of cryptographic operations. The setup processor 110 may distribute encryption keys and master secret keys to appropriate components while ensuring that sensitive keying material remains protected. The encryption processor 120 may generate ciphertexts that are cryptographically bound to their proof values, preventing substitution attacks. The key generation processor 130 may create function keys that are tailored to specific randomized functions while maintaining the ability to verify ciphertext authenticity. The decryption processor 140 may execute the final computation while preserving the randomized nature of the function outputs and preventing information leakage about the underlying plaintexts.

Throughout this disclosure, various terms and phrases are used to describe features of the disclosed technology. It is to be understood that these terms and phrases may encompass a variety of meanings and definitions, as is common in the field of technology and patent law. The definitions of these terms may vary depending on the context in which they are used, the specific embodiment being described, or the interpretation of the technology by those skilled in the art.

In various embodiments, certain variable names, symbols, or labels may be used in the claims to represent various elements, components, or steps of the described methods, systems, and apparatuses. These variable names, symbols, or labels are provided for convenience and clarity in describing the claimed subject matter. However, it should be understood that the use of such variable names, symbols, or labels in the claims does not necessarily limit these elements, components, or steps to being the same specific entities described in the specification or in other parts of the disclosure. The variable names, symbols, or labels used in the claims should be interpreted broadly and may encompass various implementations, variations, or equivalents of the described elements, components, or steps, unless explicitly stated otherwise or clearly limited by the context of the claim. As such, the scope of the claims is not confined to the specific examples or embodiments described in the specification, but rather extends to the full breadth of the inventive concepts disclosed herein.

For instance, terms such as “computing device,” “processor,” “memory,” and “network” may refer to a wide range of devices, components, systems, and configurations known in the art, and their specific definitions may differ based on the implementation or design of the system. Similarly, phrases like “securely storing,” “computing a vector,” and “generating a message” may involve various methods, techniques, and processes that achieve the same or similar outcomes but may be executed in different manners.

It is also to be understood that the use of terms in the singular or plural form is not intended to limit the scope of the claims. For example, the mention of “a computing device” does not preclude the presence of multiple computing devices within a system. Likewise, references to “a network” may include various interconnected networks or a single network comprising multiple segments or layers.

Furthermore, the use of the term “may” in relation to an action or feature indicates that the action or feature is possible, but not necessarily mandatory. This term is used to describe optional or alternative aspects of the disclosed technology that provide flexibility in how the technology may be implemented or utilized.

The definitions provided herein are intended to serve as examples and are not exhaustive. Those skilled in the art may ascribe different meanings to these terms based on the context, the specific technology being described, or the advancements in the field. Therefore, the definitions of the terms and phrases used in this disclosure and the claims are to be interpreted broadly and in a manner consistent with the understanding of those skilled in the relevant art.

The use of the word “a” or “an” when used in conjunction with the claims herein is to be interpreted as including one or more than one of the element it introduces. Similarly, the use of the term “or” is intended to be inclusive, such that the phrase “A or B” is intended to include A, B, or both A and B, unless explicitly stated otherwise.

Reference throughout the specification to “one embodiment,” “another embodiment,” “an embodiment,” and so forth, means that a particular feature, structure, or characteristic described in connection with the embodiment is included in at least one embodiment of the present disclosure, and may not necessarily be present in all embodiments. Furthermore, the particular features, structures, or characteristics may be combined in any suitable manner in one or more embodiments without limitation.

The use of the terms “first,” “second,” and the like does not imply any order or sequence, but are used to distinguish one element from another, and the terms “top,” “bottom,” “front,” “back,” “leading,” “trailing,” and the like are used for descriptive purposes and are not necessarily to be construed as limiting.

As used herein, the term “processor” refers to any computing entity capable of executing instructions to perform a specific set of operations, whether implemented in hardware, firmware, software, or any combination thereof. This definition includes a broad range of processing technologies and architectures. The term encompasses general-purpose processors such as Central Processing Units (CPUs), specialized processors such as Graphics Processing Units (GPUs), as well as highly specialized hardware accelerators such as Neural Processing Units (NPUs) for artificial intelligence applications and Tensor Processing Units (TPUs) for machine learning workloads.

The term also encompasses reconfigurable computing architectures such as Field-Programmable Gate Arrays (FPGAs) for applications requiring specialized processing configurations, Application-Specific Integrated Circuits (ASICs), Digital Signal Processors (DSPs), Systolic Array Processors, and emerging computing paradigms such as Quantum Processors that leverage principles of quantum mechanics. System on Chip (SoC) designs, heterogeneous computing systems, Edge Computing Processors for distributed network applications, cloud-based and distributed processors, multi-core and parallel processors, and Neuromorphic processors that draw inspiration from biological neural architectures are all encompassed within this definition.

The term “processor” also encompasses the associated memory hierarchies, including primary memory (such as RAM), secondary storage (such as hard drives and SSDs), and cache memory, which work in conjunction with the processor to store and retrieve data necessary for executing instructions. In this patent application, any reference to a “processor” should be interpreted broadly to include any type of processing unit capable of performing the described functions, regardless of its specific implementation, architecture, or physical form.

As used herein, the term “messages” may refer to any form of data or information that can be processed, transmitted, or stored in a digital format. Messages may include arbitrary-length plaintext messages, pre-hashed messages, concatenated messages, binary data, network protocol messages, database records, and time-stamped messages. Messages may be composed of characters, symbols, or binary data and may represent various forms of content such as text, numbers, multimedia, executable code, or any other data that can be digitally encoded. Messages may be used as input for cryptographic functions, such as keyed hash functions, where they are transformed into a fixed-size hash value influenced by a secret cryptographic key.

The term “messages” encompasses a wide range of data types and structures, from simple text strings to complex structured data, and may include metadata, headers, footers, or other information that facilitates the processing, transmission, or interpretation of the content. Messages may be generated by users, systems, or processes and may be intended for various purposes, including communication, authentication, verification, logging, or any other function that involves the use of digital data.

Messages may also include data formats specific to artificial intelligence and machine learning applications, such as tensors, feature vectors, embeddings, model parameters, activation maps, training examples, and inference requests. In distributed and edge computing contexts, the term “messages” further extends to include event streams, state updates, service requests, synchronization messages, and smart contract transactions used in blockchain platforms.

As used herein, the terms “store,” “storing,” “storage,” or variants thereof refer to any means, methods, systems, or processes for recording, retaining, or preserving data in a retrievable format. This terminology encompasses a broad spectrum of technologies and mechanisms that may be employed to maintain information for future access or reference.

The term “storing” or “storage” as used in this specification may encompass both persistent and transient data retention. In some cases, the storage may be entirely ephemeral, lasting only for the duration of a specific operation or process. The use of these terms does not imply any particular time period for data retention or any level of permanence. Storage and storing may be as brief as a few microseconds or indefinitely long, depending on the specific implementation and requirements of the system.

The term includes traditional electronic storage technologies such as magnetic storage (including hard disk drives, magnetic tape, and floppy disks), optical storage (including optical discs, holographic storage, and optical tape), and solid-state storage (including solid-state drives, flash memory, static random-access memory, dynamic random-access memory, and read-only memory). It also encompasses emerging storage technologies such as DNA storage, molecular storage, quantum storage, and photonic storage.

Storage terminology may refer to various architectural organizations and hierarchies of data repositories. This includes primary storage (main memory, cache memory) designed for rapid access during processing operations; secondary storage providing non-volatile retention of larger data volumes; and tertiary storage for archival purposes. The terminology extends to distributed storage architectures such as network-attached storage (NAS), storage area networks (SAN), direct-attached storage (DAS), and object storage systems. It also includes cloud-based storage configurations, including public, private, and hybrid cloud storage implementations; edge storage systems located at network peripheries; and fog storage systems distributed between centralized and edge locations.

The definition encompasses storage virtualization technologies that abstract physical storage resources and present them as logical storage units, including virtual disks, software-defined storage, and storage hypervisors. It also includes storage orchestration systems that manage data placement, replication, and migration across distributed infrastructures.

The terminology extends to various data organization and management paradigms. This includes file systems that organize data into files and directories; block storage systems that manage data as fixed-sized blocks; object storage systems that handle data as discrete objects with metadata; and content-addressable storage systems that retrieve data based on content rather than location. It also includes specialized storage structures such as databases, data lakes, data warehouses, and knowledge repositories.

Storage terminology encompasses various operational characteristics and capabilities of storage systems. This includes persistent storage that maintains data integrity across power cycles; volatile storage that requires continuous power to retain data; and non-volatile storage that preserves data without power. It also includes immutable storage that prevents modification of stored data; append-only storage that allows additions but not modifications; and version-controlled storage that maintains historical states of data. The term further encompasses encrypted storage that protects data confidentiality; redundant storage that duplicates data to prevent loss; and resilient storage that maintains availability despite component failures.

In specialized computing contexts, storage terminology may refer to domain-specific storage mechanisms. For blockchain and distributed ledger technologies, this includes on-chain storage within the blockchain itself and off-chain storage that maintains references to externally stored data. For neural networks and artificial intelligence systems, it includes weight storage for maintaining learned parameters and activation storage for intermediate computational results. For quantum computing systems, it refers to quantum state storage that preserves quantum information, while for edge computing, it includes transient storage for temporary data processing at network boundaries.

The term “storage” also encompasses the protocols, interfaces, and access methods used to interact with stored data. This includes file access protocols (such as NFS, SMB, and HDFS), block access protocols (such as iSCSI, Fibre Channel, and ATA), and object access protocols (such as S3, Swift, and CDMI). It also includes direct memory access mechanisms, memory-mapped file interfaces, and storage controller interfaces.

The term “database” should be construed to mean a blockchain, distributed ledger technology, key-value store, document-oriented database, graph database, time-series database, in-memory database, columnar database, object-oriented database, hierarchical database, network database, or any other structured data storage system capable of storing and retrieving information. This may include traditional relational database management systems (RDBMS), NoSQL databases, NewSQL databases, or hybrid database systems that combine multiple database paradigms. The database may be centralized, distributed, or decentralized, and may employ various data models, indexing strategies, and query languages to organize and access the stored information. It may also incorporate features such as ACID (Atomicity, Consistency, Isolation, Durability) compliance, eventual consistency, sharding, replication, or partitioning to ensure data integrity, availability, and scalability. The database may be hosted on-premises, in the cloud, or in a hybrid environment, and may support various access methods including direct queries, API calls, or event-driven architectures.

The term “database” further encompasses specialized data storage and management systems designed for particular domains or use cases. This includes blockchain and distributed ledger technologies used for secure, decentralized transaction records, edge databases optimized for resource-constrained environments, vector databases for high-dimensional data, time-series databases for temporal data management, knowledge graphs for representing interconnected information, federated databases for integrating autonomous systems, and emerging paradigms such as quantum databases that leverage quantum computing principles.

The terms “connected,” “coupled,” or any variant thereof, mean any direct or indirect connection or coupling between two or more elements, and may encompass the presence of one or more intermediate elements between the two elements that are connected or coupled to each other.

In the context of modern computing architectures and network topologies, these terms may also refer to various connection modalities. This includes physical connections through wired or wireless interfaces, logical connections operating independently of the physical layer, API connections allowing software components to communicate, and microservice connections in distributed architectures. The terminology extends to edge-to-cloud connections for distributed processing environments, blockchain connections for distributed ledger systems, quantum connections for secure communication, and neural network connections for artificial intelligence systems.

As used herein, the term “display” or “displaying” refers to any means, method, apparatus, or process for visually presenting or otherwise conveying information to a user. This terminology encompasses a broad spectrum of technologies and presentation modalities that may be employed to render content perceivable by a user. The term includes traditional display technologies such as cathode ray tubes (CRTs), liquid crystal displays (LCDs), light-emitting diode (LED) displays, organic light-emitting diode (OLED) displays, micro-LED displays, and electronic paper displays. It also encompasses specialized display types such as transparent displays, flexible displays, foldable displays, stretchable displays, and holographic displays.

The term “display” may also refer to projection systems, including traditional projectors, laser projectors, pico projectors, and holographic projection systems. It further includes immersive display technologies such as head-mounted displays (HMDs), virtual reality (VR) headsets, augmented reality (AR) glasses, mixed reality (MR) systems, and smart contact lenses. The terminology extends to ambient display methods that integrate visual information into the environment, such as smart mirrors, interactive surfaces, projection mapping systems, and volumetric displays.

The definition also encompasses non-visual display modalities that may complement or substitute for visual displays. This includes auditory displays such as speech output systems, sonification interfaces, and spatial audio; haptic displays that communicate through tactile feedback, vibration patterns, or force feedback; and other sensory output mechanisms such as olfactory displays and thermotactile interfaces. Multimodal displays that combine multiple sensory channels for information presentation are also included within this terminology.

The term “display” further encompasses the software and computational components involved in rendering information. This includes rendering engines, graphics processing pipelines, display servers, and compositing systems. It also includes specialized display rendering techniques such as rasterization, ray tracing, vector graphics, procedural generation, and neural rendering. The term extends to user interface paradigms such as graphical user interfaces (GUIs), natural user interfaces (NUIs), voice user interfaces (VUIs), brain-computer interfaces (BCIs), and ambient intelligence systems.

In the context of accessibility, the term “display” includes assistive technologies and alternative display methods designed to accommodate diverse user needs. This encompasses screen readers, braille displays, audio descriptions, high-contrast modes, color-shifted presentations, and other adaptive display mechanisms. The terminology also includes display personalization techniques such as adaptive interfaces, contextual displays, and user-specific rendering optimizations.

The description of the embodiments of the present disclosure is intended to be illustrative, and not to limit the scope of the claims. Many alternatives, modifications, and variations will be apparent to those skilled in the art. A number of implementations have been described. Nevertheless, it will be understood that various modifications may be made without departing from the spirit and scope of the disclosure. Accordingly, other implementations are within the scope of the following claims.

1. A method for randomized multi-input functional encryption, comprising:
(a) at a setup processor:
(i) generating, for each input i in [n] where n is a number of inputs:
(a) a component Kᵢ for use in generating a proof, wherein Kᵢ could be a pseudorandom function (PRF) key;
(b) public-private key pairs
$$( {pk}_{i}^{0} , {sk}_{i}^{0} ) and ( {pk}_{i}^{1} , {sk}_{i}^{1} ) ;$$
(c) an obfuscated program \tilde{E}ᵢ using
$${pk}_{i}^{0} , {pk}_{i}^{1}$$
and Kᵢ, which program is configured for taking as input two different ciphertexts, verifying that the two ciphertexts are encryptions of an identical message, and outputting a proof πᵢ that the two ciphertexts are encryptions of an identical message;
(d) an encryption key
$${EK}_{i} = ( {pk}_{i}^{0} , {pk}_{i}^{1} , {\tilde{E}}_{i} ) ;$$
(ii) generating a master secret key
$$MSK = {\{ {sk}_{i}^{0} , {sk}_{i}^{1} , {K}_{i} \}}_{i ∈ [ n ]} ;$$
(iii) transmitting at least one of the encryption keys {EKᵢ}_{i∈[n]} to at least one encryption processor;
(iv) transmitting the master secret key MSK to a key generation processor;
(b) at the at least one encryption processor, for each input xᵢ:
(i) computing a ciphertext
$${c}_{i}^{0}$$
of xᵢ using
$${pk}_{i}^{0}$$
and a ciphertext
$${c}_{i}^{1}$$
of xᵢ using
$${pk}_{i}^{1} ;$$
(ii) using \tilde{E}ᵢ to compute a proof πᵢ
$${c}_{i}^{0} and {c}_{i}^{1}$$
encrypt the same message;
(iii) generating a ciphertext
$${CT}_{i} = ( {c}_{i}^{0} , {c}_{i}^{1} , {π}_{i} ) ;$$
(c) at a key generation processor:
(i) receiving the master secret key MSK from the setup processor, and a randomized function ƒ from a decryption processor;
(ii) sampling a PRF key K_{ƒ} used for generating randomness for evaluating the randomized functionalities ƒ on inputs x₁, . . . , xₙ;
(iii) generating an obfuscated program \tilde{G}_{ƒ} using MSK and K_{ƒ}, which is configured for taking as input ciphertexts
$$\{ {CT}_{i} \} = {\{ ( {c}_{i}^{0} , {c}_{i}^{1} , {π}_{i} ) \}}_{i ∈ [ n ]} ,$$
verifying the proof πᵢ for each ciphertext CTᵢ, and outputting ƒ(x₁, . . . , xₙ) computed using randomness generated from K_{ƒ};
(iv) transmitting a function key \tilde{G}_{ƒ} as SK_{ƒ} to the decryption processor;
(d) at the decryption processor:
(i) receiving the function key SK_{ƒ} from the key generation processor;
(ii) receiving ciphertexts {CTᵢ}_{i∈[n]} from the encryption processor;
(iii) calculating a decryption result as SK_{ƒ}({CTᵢ}_{i∈[n]}) which is
$${\tilde{G}}_{f} ( {\{ {c}_{i}^{0} , {c}_{i}^{1} , {π}_{i} \}}_{i ∈ [ n ]} ) ;$$
and
(iv) electronically storing the decryption result.

2. The method of claim 1 where
$${pk}_{i}^{0} = {sk}_{i}^{0} and {pk}_{i}^{1} = {sk}_{i}^{1}$$
for all i∈[n].

3. The method of claim 1, wherein the setup processor, encryption processor, key generation processor, and decryption processor are in electronic communication with each other through a secure network.

4. The method of claim 1, further comprising:
(a) at the setup processor, generating and transmitting multiple sets of encryption keys {EKᵢ}_{i∈[n]} to multiple encryption entities;
(b) at each encryption processor, generating ciphertexts for different inputs using the received encryption keys.

5. The method of claim 1, further comprising:
(a) at the key generation processor, generating multiple function keys SK_{ƒ} for different functions ƒ;
(b) transmitting the generated function keys to one or more decryption entities.

6. The method of claim 1, wherein the obfuscated program is obtained by an indistinguishability obfuscation scheme i [symbol] which satisfies the property that for any two equivalent circuits C₀ and C₁, the distributions i [symbol] (λ,C₀) and i [symbol] (λ,C₁) are computationally indistinguishable, where λ is a security parameter.

7. The method of claim 1, wherein the proof πᵢ is computed as
$$PRF ( {K}_{i} , ( {c}_{i}^{0} , {c}_{i}^{1} ) ) ,$$
and the randomness for computing the function ƒ is computed as
$$P R F ( {K}_{f} , {( {c}_{i}^{0} , {c}_{i}^{1} )}_{i ∈ [ n ]} ) .$$

8. A system for randomized multi-input functional encryption, comprising:
(a) a setup processor configured to:
(i) generate, for each input i in [n] where n is a number of inputs:
(a) a component Kᵢ for use in generating a proof, wherein Kᵢ could be a pseudorandom function (PRF) key;
(b) public-private key pairs
$$( p {k}_{i}^{0} , {sk}_{i}^{0} ) and ( {pk}_{i}^{1} , {sk}_{i}^{1} ) ;$$
(c) an obfuscated program \tilde{E}ᵢ using
$$p {k}_{i}^{0} , p {k}_{i}^{1}$$
and Kᵢ, which program is configured for taking as input two different ciphertexts, verifying that the two ciphertexts are encryptions of an identical message, and outputting a proof πᵢ that the two ciphertexts are encryptions of an identical message;
(d) an encryption key
$${EK}_{i} = ( p {k}_{i}^{0} , {pk}_{i}^{1} , {\tilde{E}}_{i} ) ;$$
(ii) generate a master secret key
$$MSK = {\{ s {k}_{i}^{0} , {sk}_{i}^{1} , {K}_{i} \}}_{i ∈ [ n ]} ;$$
(iii) transmit at least one of the encryption keys {EKᵢ}_{i∈[n]} to at least one encryption processor;
(iv) transmit the master secret key MSK to a key generation processor;
(b) at least one encryption processor configured to, for each input xᵢ:
(i) compute a ciphertext
$${c}_{i}^{0}$$
of xᵢ using
$$p {k}_{i}^{0}$$
and a ciphertext
$${c}_{i}^{1}$$
of xᵢ using
$$p {k}_{i}^{1} ;$$
(ii) use \tilde{E}ᵢ to compute a proof πᵢ that
$${c}_{i}^{0} and {c}_{i}^{1}$$
encrypt the same message;
(iii) generate a ciphertext
$$C {T}_{i} = ( {c}_{i}^{0} , {c}_{i}^{1} , {π}_{i} ) ;$$
(c) a key generation processor configured to:
(i) receive the master secret key MSK from the setup processor, and a randomized function ƒ from a decryption processor;
(ii) sample a PRF key K_{ƒ} used for generating randomness for evaluating the randomized functionalities ƒ on inputs x₁, . . . , xₙ;
(iii) generate an obfuscated program \tilde{G}_{ƒ} using MSK and K_{ƒ}, which is configured for taking as input ciphertexts
$$\{ C {T}_{i} \} = {\{ ( {c}_{i}^{0} , {c}_{i}^{1} , {π}_{i} ) \}}_{i ∈ [ n ]} ,$$
verifying the proof πᵢ for each ciphertext CTᵢ, and outputting ƒ(x₁, . . . , xₙ) compute using randomness generated from K_{ƒ};
(iv) transmit a function key \tilde{G}_{ƒ} as SK_{ƒ} to the decryption processor;
(d) a decryption processor configured to:
(i) receive the function key SK_{ƒ} from the key generation processor;
(ii) receive ciphertexts {CTᵢ}_{i∈[n]} from the encryption processor;
(iii) calculate a decryption result as SK_{ƒ}({CTᵢ}_{i∈[n]}) which is
$${\tilde{G}}_{f} ( {\{ {c}_{i}^{0} , {c}_{i}^{1} , {π}_{i} \}}_{i ∈ [ n ]} ) ;$$
and
(iv) electronically store the decryption result.

9. The system of claim 8, wherein
$$p {k}_{i}^{0} = s {k}_{i}^{0} and {pk}_{i}^{1} = s {k}_{i}^{1}$$
for all i∈[n].

10. The system of claim 8, wherein the setup processor, encryption processor, key generation processor, and decryption processor are in electronic communication with each other through a secure network.

11. The system of claim 8, wherein:
(a) the setup processor is further configured to generate and transmit multiple sets of encryption keys {EKᵢ}_{i∈[n]} to multiple encryption entities;
(b) each encryption processor is configured to generate ciphertexts for different inputs using the received encryption keys.

12. The system of claim 8, wherein:
(a) the key generation processor is further configured to generate multiple function keys SK_{ƒ} for different functions ƒ;
(b) the key generation processor is further configured to transmit the generated function keys to one or more decryption entities.

13. The system of claim 8, wherein the obfuscated program is obtained by an indistinguishability obfuscation scheme i [symbol] which satisfies the property that for any two equivalent circuits C₀ and C₁, the distributions i [symbol] (λ,C₀) and i [symbol] (λ,C₁) are computationally indistinguishable, where λ is a security parameter.

14. The system of claim 8, wherein the proof πᵢ is computed as
$$P R F ( {K}_{i} , ( {c}_{i}^{0} , {c}_{i}^{1} ) ) ,$$
and the randomness for computing the function ƒ is computed as
$$P R F ( {K}_{f} , {( {c}_{i}^{0} , {c}_{i}^{1} )}_{i ∈ [ n ]} ) .$$

15. A non-transitory computer-readable medium storing instructions that, when executed by one or more processors, cause the one or more processors to perform a method for randomized multi-input functional encryption, the method comprising:
(a) at a setup processor:
(i) generating, for each input i in [n] where n is a number of inputs:
(a) a component Kᵢ for use in generating a proof, wherein Kᵢ could be a pseudorandom function (PRF) key;
(b) public-private key pairs
$$( p {k}_{i}^{0} , s {k}_{i}^{0} ) and ( p {k}_{i}^{1} , s {k}_{i}^{1} ) ;$$
(c) an obfuscated program \tilde{E}zᵢ using
$$p {k}_{i}^{0} , p {k}_{i}^{1}$$
and Kᵢ, which program is configured for taking as input two different ciphertexts, verifying that the two ciphertexts are encryptions of an identical message, and outputting a proof πᵢ that the two ciphertexts are encryptions of an identical message;
(d) an encryption key
$$E {K}_{i} = ( p {k}_{i}^{0} , p {k}_{i}^{1} , {\tilde{E}}_{i} ) ;$$
(ii) generating a master secret key
$$M S K = {\{ s {k}_{i}^{0} , s {k}_{i}^{1} , {K}_{i} \}}_{i ∈ [ n ]} ;$$
(iii) transmitting at least one of the encryption keys {EKᵢ}_{i∈[n]} to at least one encryption processor;
(iv) transmitting the master secret key MSK to a key generation processor;
(b) at the at least one encryption processor, for each input xᵢ:
(i) computing a ciphertext
$${c}_{i}^{0}$$
of xᵢ using
$$p {k}_{i}^{0}$$
and a ciphertext
$${c}_{i}^{1}$$
of xᵢ using
$$p {k}_{i}^{1} ;$$
(ii) using \tilde{E}ᵢ to compute a proof πᵢ that
$${c}_{i}^{0} and {c}_{i}^{1}$$
encrypt the same message;
(iii) generating a ciphertext
$$C {T}_{i} = ( {c}_{i}^{0} , {c}_{i}^{1} , {π}_{i} ) ;$$
(c) at a key generation processor:
(i) receiving the master secret key MSK from the setup processor, and a randomized function ƒ from a decryption processor;
(ii) sampling a PRF key K_{ƒ} used for generating randomness for evaluating the randomized functionalities ƒ on inputs x₁, . . . , xₙ;
(iii) generating an obfuscated program \tilde{G}_{ƒ} using MSK and K_{ƒ}, which is configured for taking as input ciphertexts
$$\{ C {T}_{i} \} = \{ ( {c}_{i}^{0} , {c}_{i}^{1} , {π}_{i} ) \} ,$$
verifying the proof πᵢ for each ciphertext CTᵢ, and outputting ƒ(xᵢ, . . . , xₙ) computed using randomness generated from K_{ƒ};
(iv) transmitting a function key \tilde{G}_{ƒ} as SK_{ƒ} to the decryption processor;
(d) at the decryption processor:
(i) receiving the function key SK_{ƒ} from the key generation processor;
(ii) receiving ciphertexts {CT₂}_{i∈[n]} from the encryption processor;
(iii) calculating a decryption result as SK_{ƒ}({CTᵢ}_{i∈[n]}) which is
$${\tilde{G}}_{f} ( {\{ {c}_{i}^{0} , {c}_{i}^{1} , {π}_{i} \}}_{i ∈ [ n ]} ) ;$$
and
(iv) electronically storing the decryption result.

16. The non-transitory computer-readable medium of claim 15, wherein
$$p {k}_{i}^{0} = s {k}_{i}^{0} and p {k}_{i}^{1} = s {k}_{i}^{1}$$
for all i∈[n].

17. The non-transitory computer-readable medium of claim 15, wherein the setup processor, encryption processor, key generation processor, and decryption processor are in electronic communication with each other through a secure network.

18. The non-transitory computer-readable medium of claim 15, wherein the method further comprises:
(a) at the setup processor, generating and transmitting multiple sets of encryption keys {EKᵢ}_{i∈[n]} to multiple encryption entities;
(b) at each encryption processor, generating ciphertexts for different inputs using the received encryption keys.

19. The non-transitory computer-readable medium of claim 15, wherein the method further comprises:
(a) at the key generation processor, generating multiple function keys SK_{ƒ} for different functions ƒ;
(b) transmitting the generated function keys to one or more decryption entities.

20. The non-transitory computer-readable medium of claim 15, wherein the obfuscated program is obtained by an indistinguishability obfuscation scheme i [symbol] which satisfies the property that for any two equivalent circuits C₀ and C₁, the distributions i [symbol] (λ,C₀) and i [symbol] (λ,C₁) are computationally indistinguishable, where λ is a security parameter.
